(19) United States
(12) Patent Application Publication
(10) Pub. No.: US 2026/0050935 A1
(43) Pub. Date: Feb. 19, 2026

(54) METHODS AND APPARATUS FOR DETECTING ASSET MISUSE, LOSS, OR PIRACY IN A SUPPLY CHAIN USING NEURAL NETWORKS

(71) Applicant: LocatorX, Inc., Kissimmee, FL (US)

(72) Inventor: Jeff Kase, Bar Harbor, ME (US)

(73) Assignee: LocatorX, Inc., Kissimmee, FL (US)

(21) Appl. No.: 19/273,382

(22) Filed: Jul. 18, 2025

Related U.S. Application Data
(60) Provisional application No. 63/684,322, filed on Aug. 16, 2024.

(51) Int. Cl. G06Q 30/018; G06Q 10/0635; G06Q 30/01

(52) U.S. Cl. CPC G06Q 30/0185; G06Q 10/0635; G06Q 30/01

(57) ABSTRACT

A system and method are disclosed for tracking and verifying authenticity, loss, fraud, or unauthorized use of assets within a supply chain. The method includes scanning a multimodal tag (e.g., QR code and NFC tag) associated with an asset to generate scan data comprising a hash code, asset identifier, and verification URL. The scan data is transmitted to an application server of a parent organization, where a controller retrieves associated location and organization identifiers. The controller determines authorization status, compares the hash code with reference values in a verification database, and performs authenticity checks to classify the asset as genuine, lost, duplicated, or pirated. The system integrates with a CRM platform to register new child organizations using data synchronization objects comprising payloads, callout instructions, and error handling. AI-based analysis may detect route deviations, fraudulent insertions, or asset misuse patterns based on route history and scanning behavior.

### CROSS REFERENCE TO RELATED APPLICATIONS

This application claims the benefit of U.S. Provisional Application No. 63/684,322, filed Aug. 16, 2024, and entitled APPARATUS AND METHODS FOR TRACKING ASSETS VIA A NEURAL NETWORK, the entire disclosure of which is incorporated herein by reference.

### FIELD OF THE INVENTION

The present invention relates generally to systems and methods for digital asset tracking and verification. More particularly, the invention pertains to a framework for detecting asset authenticity, loss, fraud, or unauthorized use within a supply chain network through real-time scanning of multimodal tags, hash-based authentication, location and organization validation, and synchronized integration with enterprise management platforms such as Customer Relationship Management (CRM) systems. The invention further relates to data synchronization mechanisms that allow dynamic registration and monitoring of sub-organizations and scanning locations, and to artificial intelligence-based evaluation for detecting deviations, asset misuse patterns, and unauthorized insertions of counterfeit items into legitimate logistics and distribution workflows.

### BACKGROUND OF THE INVENTION

Asset tracking systems are commonly used across a wide variety of industries to monitor the location, status, and movement of physical objects such as goods, inventory, equipment, or other tangible items. These systems are often critical in logistics, manufacturing, warehousing, and field operations, where real-time visibility and verification of assets are important for achieving operational efficiency, maintaining security, and meeting regulatory or contractual compliance requirements. However, despite their widespread adoption, several challenges hinder the effectiveness of current asset tracking systems.

Conventional asset tracking methods typically rely on isolated systems and technologies, such as barcode scanning, GPS-based tracking devices, or RFID tags. These tracking systems are often separate from enterprise management software such as Customer Relationship Management (CRM) platforms or Enterprise Resource Planning (ERP) tools. As a result, organizations face significant challenges in maintaining consistent and synchronized records across systems. For example, a new delivery hub, warehouse, or organizational unit created in a CRM system often needs to be manually re-entered or manually mirrored in the tracking system. This leads to data inconsistencies, operational delays, human error, and increased administrative overhead.

Furthermore, traditional tagging mechanisms lack robust, multi-layered validation. Single-mode identification technologies such as QR codes or NFC chips are vulnerable to duplication, tampering, or unauthorized replication, limiting their effectiveness in preventing counterfeiting or unauthorized tracking access. There remains a need for a secure, multi-factor tagging method that can not only identify an asset but also validate its authenticity during handoffs, transitions, or remote verification events.

Commonly used traditional asset tracking methods do not provide real-time data which leads to delays in identifying where an asset is at any given time and/or the condition of the asset at a point in time. In some cases, tracking technologies (like GPS) may not work effectively in certain environments, such as indoor locations, underground, or in areas with gaps in satellite visibility. In other scenarios, users or organizations employ manual data entry and tracking which introduces human errors, such as incorrect location information, mislabeling, or failure to update the system when assets move. This can lead to inaccuracies in inventory and tracking systems.

In addition, global supply chains are increasingly complex and globalized, and may involve numerous parties, including, for example, one or more of: suppliers, manufacturers, logistics providers, and retailers, each using proprietary tracking systems and processes that do not communicate with each other causing fragmentation. Such fragmentation can make it challenging to track assets consistently across the entire supply chain.

In response to these challenges, there is growing demand for a real-time, cloud-native infrastructure that automates the detection and synchronization of data between CRM platforms and external tracking applications. However, current systems lack the capability to automatically detect updates to organizational entities (e.g., creation of a new facility, route, or asset), assemble a structured and transferable data packet (“payload”), and synchronize that packet across platforms using programmable interfaces that support retry logic, error handling, and event-driven workflows.

In certain industries, high-value assets are vulnerable to theft or loss, and prevalent tracking systems do not include mechanisms to detect and prevent incidents of an asset leaving a correct path of delivery (e.g., in case of unauthorized movements or route deviations). Alternatively, assets can be misplaced or lost in transit due to poor tracking procedures or miscommunication between parties involved in a shipment process, which may lead to lost assets, costly delays, and/or inefficiencies. There is a need for a system that detects anomalies such as an asset straying from its planned delivery path, with real-time alerts and verification checks along the way.

Some supply chains or organizations still rely on outdated tracking technologies, such as manual logs or basic barcode systems, which may not provide the necessary accuracy or real-time visibility needed for modern supply chain management. As companies grow and their supply chains become more complex, existing tracking systems are difficult to scale effectively, leading to gaps in asset tracking.

Moreover, unexpected events such as natural disasters, geopolitical tensions, or pandemics can also disrupt supply chains, making it difficult to track assets as they may be rerouted, delayed, or lost. In such situations, real-time tracking and flexibility become even more critical, yet also more difficult to achieve without modernized infrastructure.

In view of these limitations, there exists a need for an improved system and method that provides secure, event-driven synchronization between CRM systems and asset tracking platforms. There is also a need for a multi-modal tagging and validation framework that enables cryptographic verification using embedded QR codes, NFC components, and externally readable identifiers, with data backed by cloud-based infrastructure. Such a system would enable real-time asset visibility, integrity validation, and seamless data integration across platforms and organizational boundaries.

### SUMMARY OF THE DISCLOSURE

Accordingly, the present invention provides systems, methods, and apparatus for tracking assets by integrating Customer Relationship Management (CRM) platforms with external product application servers through automated data synchronization and multi-modal asset validation mechanisms. The invention may use neural networks to address limitations in traditional asset tracking systems by enabling event-driven, cloud-native synchronization of asset-related data, while providing secure, multi-factor verification of physical assets using a combination of Certified Quick Response (CQR) codes, Near Field Communication (NFC) tags, and optional external identifier devices.

As used in the present invention, a neural network may include a computational model mimicking a structure and function of the human brain. A neural network may be a subset of machine learning systems, capable of deep learning, which uses interconnected layers of artificial neurons to process and learn from data. Neural networks may be used to identify complex patterns, make predictions, and adapt based on examples, rather than only following explicitly programmed rules.

In some embodiments, a CRM application may be configured to maintain hierarchical business data, such as organizational structures, facilities, routes, and trackable assets. Upon creation or modification of such entities, a trigger event is detected that causes a payload object to be constructed. The payload object includes key data fields extracted from the CRM object, including a unique CRM identifier. This identifier is mapped into an external ID field to facilitate interoperability with external systems. The payload, along with synchronization metadata, callout instructions (such as API endpoint and method), and error-handling logic, is then packaged into a Data Synchronization Object (DSO). The DSO is queued and subsequently executed to transmit the data to a product application server, thereby mirroring the CRM object in an external system.

The invention further provides mechanisms for verifying physical assets via multi-modal tags affixed to the assets. Each tag comprises at least two of: a Certified Quick Response (CQR) label, an embedded NFC chip, and an optional external ID device such as an RFID tag or a digital identifier. Each modality stores or encodes a cryptographic hash value, such as a qr_hash or nfc_hash, which is generated using a unique identifier (e.g., UUID) and optionally includes time-sensitive elements or digital signatures.

When the asset is scanned using a mobile device or reader, the system retrieves the hash value from the tag and compares it with a reference value stored in a validation database on the product application server. A match between the scanned and stored values confirms the authenticity of the asset. The system may also return contextual metadata, such as the last known location, organizational ownership, route assignment, or delivery status. In some embodiments, if the validation fails or if an asset deviates from an assigned route, a warning message is returned and logged, allowing for administrative intervention.

In another aspect, the invention supports route tracking and visualization by generating dynamic route maps that illustrate both the planned route and the actual movement of an asset. Deviations from the planned path are evaluated against predefined tolerance thresholds and displayed within an administrative interface. Each scan event along the route is geotagged and timestamped, creating a historical movement profile of the asset.

In yet another aspect, the invention provides a modular development stack for CRM customization and deployment, including Scratch Orgs, version-controlled source projects, integrated development environments (IDEs) such as Visual Studio Code, and command-line interface (CLI) tools. The stack facilitates rapid deployment, automated testing, and controlled promotion to CRM production environments. Trigger handlers and programmatically defined flows manage the generation and queuing of Data Synchronization Objects in response to CRM record events.

The invention may also provide a user-facing administrative dashboard that enables users to view and manage organizational structures, assigned assets, active routes, scan history, and validation logs. The dashboard may include tagging interfaces, route map views, validation result screens, and configuration panels.

In some implementations, the system includes a CRM platform that acts as the origin of truth for organizational and asset metadata. The CRM instance may be a cloud-based multi-tenant application such as Salesforce, configured to include custom objects such as Organization_c, Facility_c, Route_c, RoutePlan_c, Trackable Asset_c, and Tag_c. Each object may include uniquely identifying fields, metadata attributes, and relationships to other objects (e.g., a Facility_c may belong to an Organization_c, a Route_c may consist of multiple Facility_c stops, etc.).

Upon the creation or modification of a CRM object, a trigger event is fired. A dedicated trigger handler or flow process extracts the required data fields from the CRM object and constructs a payload object. This payload includes key information about the CRM object, such as the CRM-generated record ID, external ID mappings, name, status, address, ownership hierarchy, timestamps, and other relevant metadata.

This payload is then encapsulated into a Data Synchronization Object (DSO), which includes one or more of: (i) the payload; (ii) synchronization metadata; (iii) callout configuration (such as target server URL, HTTP method type, headers, and authentication tokens); and (iv) error-handling logic. The DSO is placed into a queue and asynchronously executed either immediately or in batches. Execution of the DSO results in a RESTful or API-based callout from the CRM application to the product application server, thereby creating or updating a corresponding record in the external system. This enables continuous mirroring of asset-related data between the CRM and the tracking infrastructure.

In some embodiments, the external product application server is also cloud-hosted and maintains a database of mirrored asset metadata. This server also hosts validation logic and route-tracking services. Each physical asset that is tracked within the system may be associated with a multimodal tag affixed to its surface. The multimodal tag may include a Certified Quick Response (CQR) code, an embedded NFC chip, and optionally, an external ID mechanism such as an RFID tag, barcode sticker, or smart label with stored UUIDs.

Each tagging component (QR/NFC/RFID) stores a unique identifier encoded as a hash value (e.g., qr_hash, nfc_hash) that is derived using a cryptographic algorithm applied to a base UUID, optionally salted with time-based or device-specific elements. These hash values are pre-recorded into the product application server's database upon tag creation or initialization, and linked to the associated CRM object and tracking metadata.

When the physical asset is scanned in the field—either through a mobile device, NFC reader, or dedicated terminal—the scanned tag data is transmitted to the product application server via an API call. The server extracts the hash value from the incoming request, looks up the stored hash records, and compares them for authenticity. Upon successful match, the system validates the asset and may return metadata about the object such as its current status, route assignment, last known scan location, and ownership hierarchy. In case of mismatch or hash collision, the system may return a failure response, log the discrepancy, and trigger alert workflows for further investigation.

The system further includes a visualization layer that provides a real-time administrative interface. This interface may present route maps (e.g., FIG. 3), scan histories, validation logs, asset status panels, and configuration screens. In some implementations, route mapping interfaces may compare the planned versus actual route taken by the asset, with tolerance zones that allow minor deviations without raising alerts. Each scan may be geotagged and timestamped, contributing to a track record of asset movement and enabling real-time auditability.

In some embodiments, a system may be configured to track an asset across a supply chain in order to detect one or more events associated with the authenticity, fraud, loss, or unauthorized use of the asset. The system may comprise a scanner device installed at one or more scanning locations or operated by scanning organizations, which may include warehouses, distributors, transport hubs, customs facilities, or retail endpoints. Each asset may be physically tagged with a multimodal tag, such as a combination of a QR code and an NFC chip, each encoding a hash code, a unique asset identifier, and a Uniform Resource Locator (URL) pointing to a verification endpoint hosted by an application server operated or maintained by a parent organization. The multimodal design of the tag allows compatibility with multiple types of scanners across the ecosystem and redundancy for verification.

When the asset reaches a scanning point during transit or at the destination, the scanner device may scan the multimodal tag, extracting data including but not limited to: the QR or NFC hash code (e.g., QR_hash or NFC_hash), the unique asset ID, and the verification URL. The scanner device may be handheld or fixed, depending on the facility. The scan data may be transmitted in real time to the URL endpoint, invoking a secure call to the application server associated with the parent organization of the asset. This communication may be authenticated using digital tokens or API keys associated with the scanner or the scanning organization.

Upon receiving the scan data, the application server may activate a controller, which may comprise one or more processors operating under instructions stored in a memory, and may optionally include or interface with an AI engine. The controller may parse the incoming request and retrieve metadata associated with the scanner, such as its physical location coordinates (latitude/longitude), geofence ID, IP-based geo-location, or its registered organizational identifier. This metadata may be retrieved from a registry associated with registered scanners or known scanning entities.

The controller may then perform a comparison between the retrieved scanner metadata and the organizational hierarchy stored on the application server, including a list of registered or authorized sub-organizations and scanning locations under the parent organization. If the scanning organization or its location is not present in the authorized registry, the controller may classify the scan origin as unauthorized, and log this event for downstream analytics.

Next, the controller may initiate a verification of the asset itself. The hash code obtained from the scan may be used as a lookup key to compare against one or more reference hash values stored in a secure verification database hosted on the application server. These reference hashes may have been previously generated and registered by the parent organization at the time of asset manufacture or release. If the incoming hash matches an existing record, the asset may be tentatively deemed authentic. If the hash is absent or collides with multiple conflicting entries, the asset may be flagged for further scrutiny.

Once both the scanner organization and asset hash are verified, the controller may perform an authenticity check. This check may involve a plurality of logic branches, including: (a) verifying whether the asset is being scanned at an expected location based on route metadata, (b) verifying whether the organizational context is permissible for the asset, and (c) whether the scan frequency, time interval, or location variance suggests misuse, duplication, or diversion. In some implementations, AI or neural network models may support this logic by analyzing behavioral patterns of previous asset journeys, expected scan locations, and known fraudulent behaviors.

Based on these checks, the controller may categorize the asset event. If the asset hash is valid and the scanning location is within an authorized geofence or organizational unit, the asset may be confirmed as authentic and within its expected supply path. If the asset is scanned at a non-registered or unauthorized organization, it may be flagged as possibly diverted or lost, with loss location approximated based on last known scan points. If a hash match is found at multiple unrelated scanning locations simultaneously or within an unfeasibly short time window, the asset may be classified as fraudulently duplicated. If the hash is not found in the database, or contains known patterns associated with counterfeit tags, it may be identified as a pirated or unauthorized clone introduced into the ecosystem.

Upon final classification, the application server may trigger downstream actions, such as generating alerts to the parent organization, logging a fraud event, generating a compliance report, or initiating a traceback to identify breach or duplication points. These actions may be configured via business rules and may differ based on severity level, asset type, or regulatory requirements.

### BRIEF DESCRIPTION OF THE DRAWINGS

The accompanying drawings, which are incorporated into and constitute a part of this specification, illustrate several embodiments of the present invention. Together with the description, these drawings serve to illustrate some aspects of the present invention.

FIG. 1 is a schematic diagram of components included in an asset tracking system, according to some embodiments of the present disclosure.

FIG. 1A illustrates a schematic diagram of an exemplary use of the present disclosure.

FIG. 1B is a diagram illustrating an exemplary asset labeled with a multimodal tag, according to some embodiments of the present disclosure.

FIG. 1C illustrates an exemplary system and method for validating an asset using a gateway device to scan a multi-modal tag affixed to the asset, according to some embodiments of the present disclosure.

FIGS. 1D-1E illustrate exemplary components of a tag, and how a POST request is generated and transmitted from a mobile device to a server for asset validation, according to some embodiments of the present disclosure.

FIG. 1F illustrates an exemplary gateway device executing an asset verification application presenting multiple selectable options for initiating different types of tag-based and user-authenticated verification workflows.

FIG. 1G is a flowchart illustrating an exemplary asset verification process using a multimodal tag scanned by a gateway device, in accordance with some embodiments of the present disclosure.

FIG. 1H illustrates an exemplary verification table generated by a server, in accordance with some embodiments of the present disclosure.

FIG. 2 illustrates a schematic diagram showing components for tracking an object according to some embodiments of the present disclosure.

FIG. 3 illustrates an exemplary user interface including a route map, according to some embodiments of the present disclosure.

FIG. 3A is a schematic illustration of a defined route with destination points and deviations, showing an asset scanning process for verifying item delivery at designated locations.

FIG. 4 illustrates method steps that may be practiced according to some embodiments of the present disclosure.

FIG. 4A illustrates a system-level block diagram showing creation and synchronization of a new child organization record, according to some embodiments of the present disclosure.

FIG. 4B illustrates an exemplary diagram depicting a hierarchical relationship between a main organization and a plurality of sub-organizations, in accordance with some embodiments of the present disclosure.

FIG. 5 illustrates an example of tag-based asset validation, in which identical tags affixed to different assets are scanned by multiple users using mobile devices, in accordance with some embodiments of the present disclosure.

FIG. 6 illustrates an example of asset verification in which a mobile device prompts for biometric authentication from a user during or after scanning a tag affixed to an asset, thereby enabling a secondary layer of user-specific validation.

FIG. 7 illustrates an example of a periodic asset verification prompt generated on a user device, reminding the user to rescan a previously validated asset to ensure continued monitoring and authorized use.

FIG. 8 illustrates an example of pairing two or more devices with each other using a mobile device, wherein the pairing is based on multimodal verification of tags associated with each device, in accordance with some embodiments of the present disclosure.

FIG. 9 illustrates an exemplary system and method for validating an asset through scans performed by multiple users using separate mobile devices, in accordance with some embodiments of the present disclosure.

FIG. 10 illustrates an exemplary system and method for verifying an asset that is location-bound, in accordance with some embodiments of the present disclosure.

FIGS. 11A-11B illustrate exemplary verification tables stored and maintained by a server, showing validation outcomes based on user identity, location, and time of scan, in accordance with various embodiments of the present disclosure.

FIG. 12 illustrates an exemplary system for verifying asset authenticity and detecting unauthorized usage, theft, or loss of assets based on location and organizational authorization, in accordance with some embodiments of the present disclosure.

FIG. 12A illustrates an exemplary process performed at the application server for detecting asset fraud, loss, or misuse based on asset tracking data and neural network analysis.

FIG. 12B illustrates an exemplary block diagram of an application server, in accordance with some embodiments of the present disclosure.

FIGS. 13A-13B illustrate exemplary method steps that may be executed in some embodiments of the present invention.

### DETAILED DESCRIPTION

The present invention provides systems, methods, and apparatuses for tracking assets and detecting events such as authenticity, fraud, loss, or unauthorized usage of the asset within a supply chain. The disclosed system utilizes multimodal tagging, decentralized scanning technologies, route mapping, and AI-driven analysis, forming a comprehensive framework for supply chain integrity and asset verification. In some embodiments, each asset may be affixed with a multimodal tag that includes both a QR code and an NFC chip, each encoded with a cryptographic hash and an asset identifier, and optionally embedded with a URL pointing to a verification service hosted by the parent organization.

When the asset is scanned-using devices such as handheld barcode readers, smartphone cameras, or fixed point-of-sale (POS) systems—at a designated scanning location or by a scanning organization, the scan data is captured and transmitted to an application server associated with the parent organization. The scan data may comprise a hash code derived from the tag, an asset identifier string, and the verification URL used to invoke backend processing. For example, a retail partner scanning an incoming asset during warehouse intake may trigger the backend process by scanning the tag, which automatically sends a request to a URL such as https://verify.manufacturer.com/validate.

At the backend, the controller of the application server receives the scan data and retrieves metadata related to the scanning location or organization. The location data may include GPS coordinates, Wi-Fi or cellular triangulation data, IP-derived locations, or predefined geofence identifiers. Organizational identifiers may include authenticated scanner device IDs or digital certificates associated with registered partners. The controller checks whether this metadata corresponds to any entry in the registry of known or authorized sub-organizations of the parent entity.

The controller then uses the hash code from the scanned tag to query a secure verification database hosted by the parent organization. This database contains a mapping of all issued asset identifiers, their corresponding cryptographic hashes, issuance dates, and current chain-of-custody status. If the hash matches an entry, the asset is flagged as authentic. If not, the controller may initiate additional fraud checks to evaluate if the asset has been duplicated, modified, or is a pirated insertion.

In one example, an asset scanned at a registered retail store is verified as authentic with a match on hash and scanning location. In another example, a genuine asset with a valid hash is scanned at a logistics center that is not registered as a known node in the supply chain, which leads the controller to flag the asset as potentially lost or diverted. In yet another scenario, a counterfeit asset with an invalid or non-existent hash is scanned at a legitimate distribution center, causing the controller to issue an alert indicating the introduction of a pirated asset into the official supply chain.

The application server may also store predefined route paths associated with asset delivery. A route path may include one or more checkpoint locations, such as loading docks, customs checkpoints, or third-party logistics handoffs, where the asset is expected to be scanned. Each checkpoint may be associated with timestamp expectations and location metadata. As the asset progresses through the supply chain, each scan is logged and compared against the expected route. If the asset bypasses or skips a checkpoint, or if delays exceed predefined thresholds, the controller flags a potential deviation. This information may be used to detect tampering, unauthorized rerouting, or inefficiencies.

In addition, the system supports real-time alerting. When an asset scan fails one or more authenticity checks, alerts may be generated and dispatched to relevant entities such as the parent organization and affected sub-organizations. Alerts may include context such as the scan location, timestamp, failed hash, associated route ID, and prior scans, enabling rapid tracing and investigation.

To further enhance fraud detection, the controller may include an artificial intelligence (AI) engine trained on historical scan patterns, known fraud attempts, and expected asset flow. The AI engine may detect statistical anomalies such as unusual scan frequencies, geographic deviations, time-based inconsistencies, or patterns indicative of duplication or piracy. For example, if two assets with the same hash are scanned in different continents within minutes, the AI may flag the hash as duplicated and remove its validity in future transactions.

Additionally, the application server may generate visual dashboards that plot asset movement on a geographic interface, comparing real-time scan events with expected route maps. These dashboards assist stakeholders in viewing the health of their supply chain, identifying bottlenecks, and reacting to alerts related to unauthorized events.

In other embodiments, the system may detect lost assets by identifying prolonged inactivity. If a delivery truck is expected to scan the asset every four hours across three known checkpoints and no scans are received in over twelve hours, the system flags the asset as potentially lost. Similarly, discrepancies between dispatch data (e.g., five items shipped) and receipt scans (e.g., only three items received) may trigger a loss or theft alert.

This invention also contemplates the hierarchical registration of organizations. Sub-organizations may be manually registered by the parent organization, or dynamically registered based on predefined policies—for example, allowing temporary partners to be registered upon successful scanning of a known asset from the parent. Each organization and location may have associated metadata that assists in policy enforcement and authenticity validation.

In scenarios involving counterfeit asset detection, the system leverages both direct hash mismatches and indirect behavioral analysis. For example, if a product is scanned with a hash that exists but was previously assigned to a different geographic region or retail tier, the AI may detect a possible hash collision indicating counterfeit replication. Alternatively, if the same hash is used across multiple partners not connected to each other, the controller may deactivate the hash and investigate upstream sources.

In some embodiments, a multimodal tag affixed to an asset may contain a hash code, a URL, and optionally an asset ID or other metadata. Upon scanning the tag using a gateway device, such as a smartphone or tablet running a verification application, the device extracts data from the tag and composes a POST request directed to a remote verification server. The POST request may include a verification URL, the hash code extracted from the tag, and additional data such as user identity tokens, GPS coordinates, and time-based one-time passwords (TOTP) for enhanced security.

The server receives the POST request and validates the received hash code against stored records. In some configurations, the hash code itself may be encoded with the asset ID and verification URL. The server may evaluate the authenticity of the tag, the correctness of the associated user identity, the validity of the user's current location, and any embedded time-based or behavioral constraints to determine the outcome of the verification.

In certain embodiments, the system supports various scan modes, including auto-detection of tag type, manual scan of Certified QR, NFC, or external ID tags, and two-factor verification mechanisms. Two-factor verification may involve scanning multiple tag types (e.g., QR and NFC), or a combination of one tag scan along with user authentication, such as biometrics, user ID, or geolocation checks.

The gateway device may locally store authorized hash code pairs to support offline validation or repeat verifications. In such embodiments, if a scan matches a stored hash code from a previously verified session, temporary access may be granted even in the absence of live server communication. Alternatively, the gateway device may receive TOTP codes from the server for session-based authorization.

The server may maintain structured verification tables that log each scan attempt and its parameters, including asset ID, hash comparison outcomes, user identity, location status, and final system-determined asset status. The asset status may include labels such as “Genuine,” “Counterfeited,” “Asset Moved,” or “Stolen” based on rule-based evaluations.

In advanced embodiments, an AI engine operating on the server may analyze usage patterns, scan timings, and geographic movement to detect anomalies. For example, if the same user is recorded scanning the same asset from distant locations within an implausible time frame, the server may flag the attempt and deny access, suspecting counterfeit activity or misuse.

Organizations may configure assets as either location-bound or freely movable. For location-bound assets, the system restricts access to predefined geofenced zones. For movable assets, the system uses logic to evaluate plausibility of asset movements over time and geography.

In case of failed verifications, anomalies, or suspected security breaches, the system may escalate alerts to authorized personnel, such as administrators or organizational stakeholders. These alerts may include incident details and may trigger automated lockdowns or audit requirements.

The invention further provides comprehensive audit logging, policy enforcement, and administrative tooling for managing large fleets of assets in industries such as logistics, healthcare, government, education, and field service. By combining multiple verification dimensions-tag authenticity, user identity, location, time, and behavior—the system delivers a robust, scalable, and tamper-resistant solution for verifying and managing physical assets.

In some embodiments, a system is provided for verifying an asset using a multimodal tag that is scanned by a gateway device and authenticated by a server. The process begins with the gateway device receiving scan data from a multimodal tag affixed to or associated with the asset. The multimodal tag may include a Certified QR (CQR) code, an NFC tag, a barcode, or any other electronically readable identifier, and may store one or more data elements such as a hash code, an asset identifier, and a verification Uniform Resource Locator (URL). The scan data may be captured through the gateway device's camera, NFC reader, or barcode scanner, and is processed in real time by a verification application running on the gateway device.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

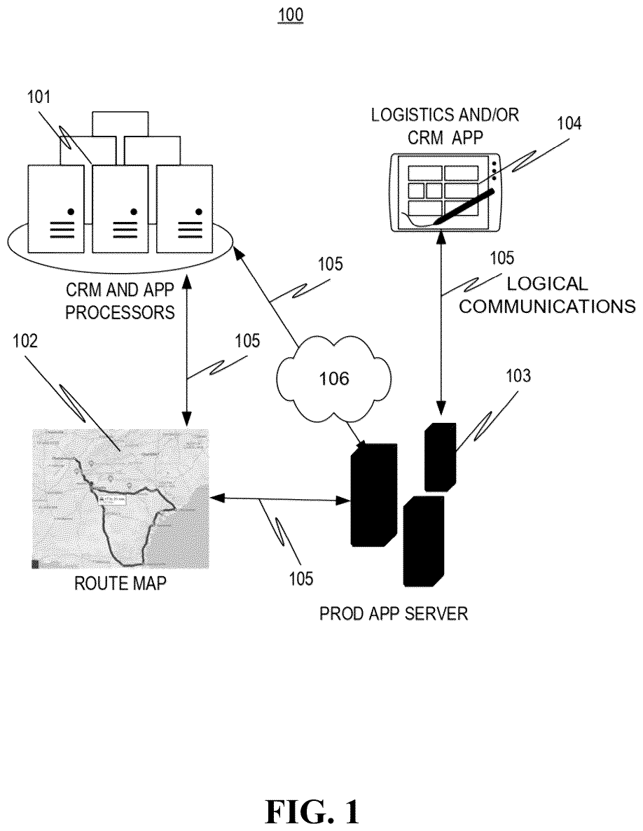

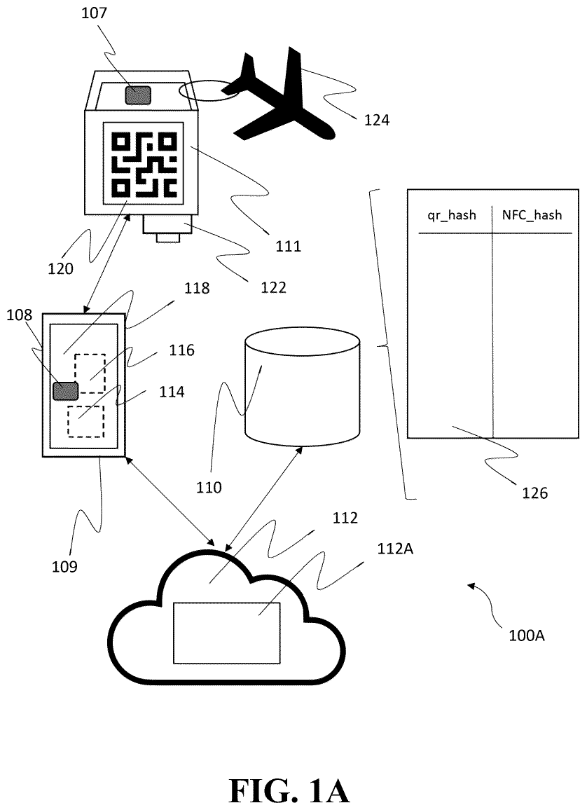

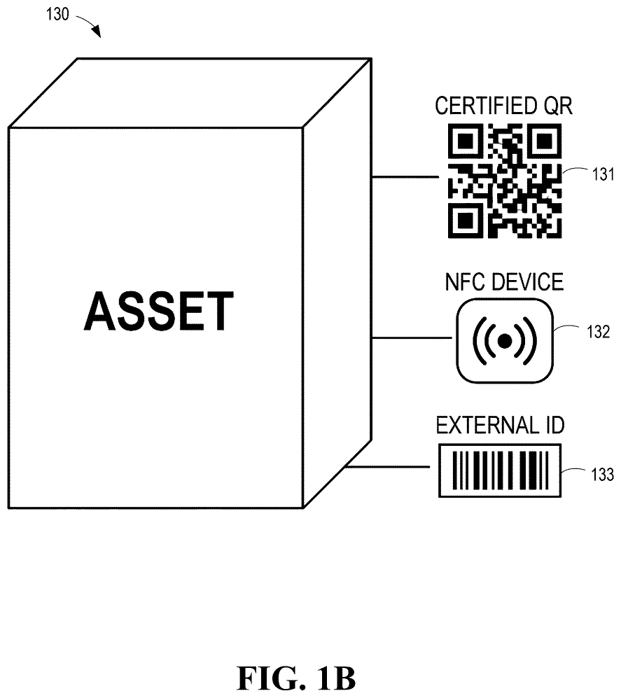

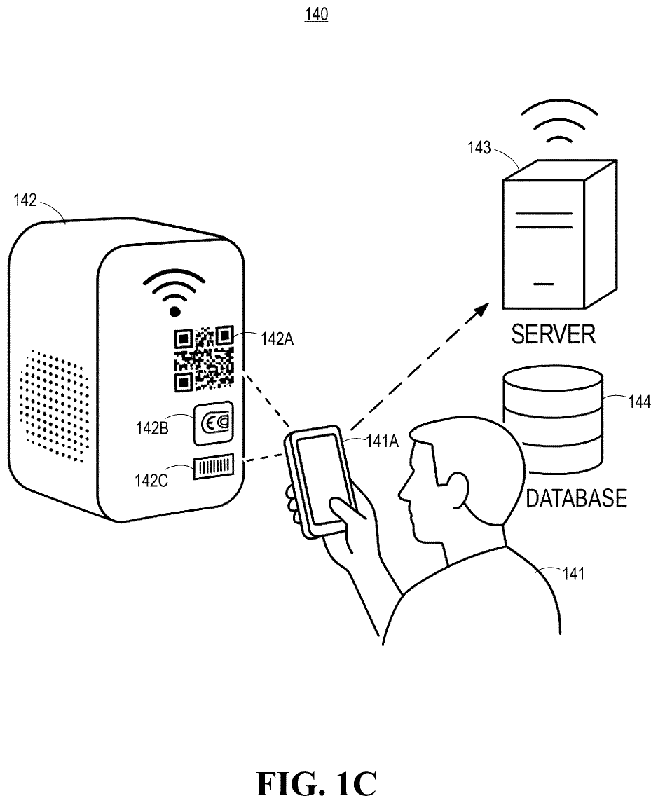

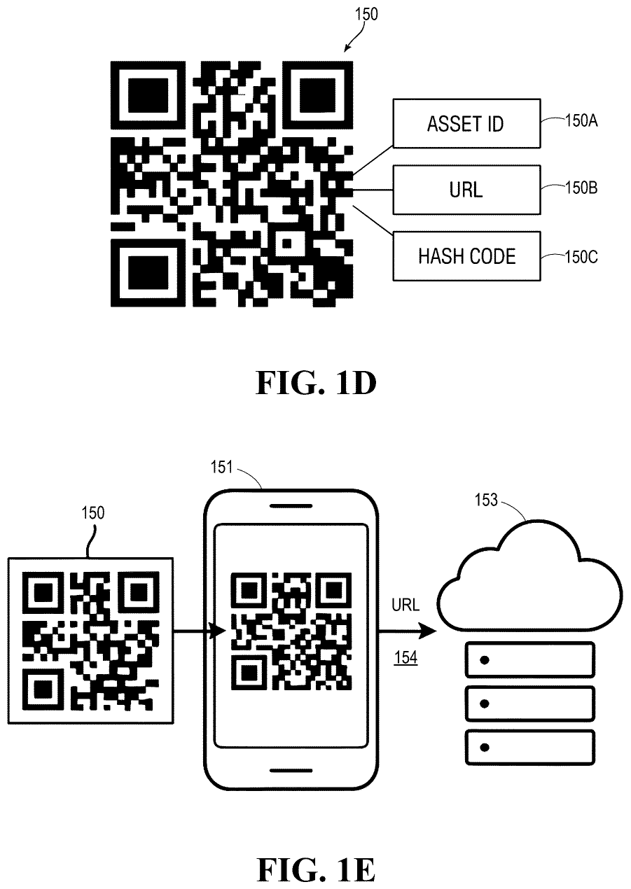

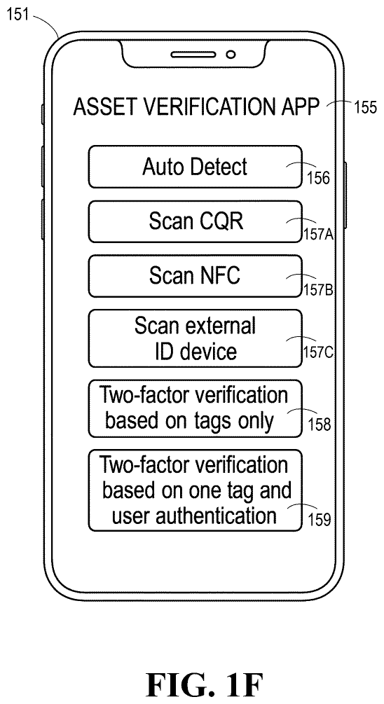

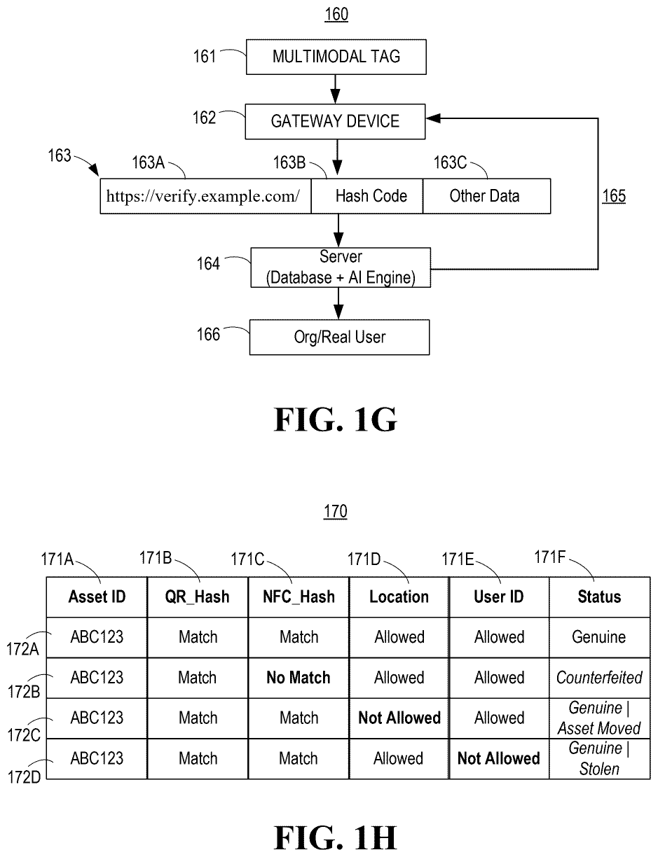

Referring now to FIG. 1, a diagram illustrates an asset tracking system 100 in which systems and/or methods described herein may be implemented.

As shown in FIG. 1, the asset tracking system 100 may include one or more elements 102-104, that are in logical communication via digital communications mediums 105, as described in more detail herein. The asset tracking system 100 may include one or more of: application processors 101 (e.g., customer relations management system processors); a route map device 102; product application servers 103; and a logistics application 104; which may be in logical communication via one or more digital communications mediums 105 (e.g., wireless or hardwired communications mediums). Devices accessing the asset tracking system 100 and/or elements of the asset tracking system 100 may interconnect via wired connections and/or wireless connections.

The processors 101 and/or servers 103 may be deployed in a cloud computing platform 106, which may be a public cloud, a private cloud, or a hybrid cloud. A processor (101) and/or server (103) may be implemented as a physical machine, a virtual machine, or a combination thereof. The cloud computing platform 106 may include computing hardware, a resource management component, a host operating system (OS), and/or one or more virtual computing systems.

The resource management component may perform virtualization (e.g., abstraction) of the computing hardware to create the one or more virtual computing systems. Using virtualization, the resource management component enables a single computing device (e.g., a computer, a server, and/or the like) to operate like multiple computing devices, such as by creating multiple isolated virtual computing systems from the computing hardware of the single computing device. In this way, the computing hardware can operate more efficiently, with lower power consumption, higher reliability, higher availability, higher utilization, greater flexibility, and lower cost than using separate computing devices.

The computing hardware includes hardware and corresponding resources from one or more computing devices. For example, the computing hardware may include hardware from a single computing device (e.g., a single server) or from multiple computing devices (e.g., multiple servers), such as multiple computing devices in one or more data centers. The computing hardware may include one or more processors, one or more memories, one or more storage devices, and/or one or more networking components. Examples of a processor, a memory, a storage, and a networking component (e.g., a communication component) are described elsewhere herein.

The resource management component includes a virtualization application (e.g., executing on hardware, such as the computing hardware) capable of virtualizing the computing hardware to start, stop, and/or manage the one or more virtual computing systems. For example, the resource management component may include a hypervisor (e.g., a bare-metal or Type 4 hypervisor, a hosted or Type 2 hypervisor, and/or the like) or a virtual machine monitor, such as when the virtual computing systems are virtual machines. Additionally, or alternatively, the resource management component may include a container manager, such as when the virtual computing systems are containers. In some implementations, the resource management component executes within and/or in coordination with a host operating system.

A virtual computing system includes a virtual environment that enables cloud-based execution of operations and/or processes described herein using computing hardware. As shown, the virtual computing system may include a virtual machine, a container, a hybrid environment that includes a virtual machine and a container, and/or the like. A virtual computing system may execute one or more applications using a file system that includes binary files, software libraries, and/or other resources required to execute applications on a guest operating system (e.g., within the virtual computing system) or the host operating system.

The network includes one or more wired and/or wireless networks. For example, the network may include a cellular network, a Public Land Mobile Network (PLMN), a Local Area Network (LAN), a Wide Area Network (WAN), a private network, the Internet, and/or the like, and/or a combination of these or other types of networks. The network enables communication among the devices of the asset tracking system 100.

FIG. 1A is a diagram of an object validation system 100A in which systems and/or methods described herein may be implemented. As shown in FIG. 1A, the system 100A may include one or more elements 107-124, as described in more detail below. The system 100A may include a server (e.g., endpoint) 112A, a gateway 109, a multimodal tag 111, and a database 110. Devices and/or elements of the system 100A may interconnect via wired connections and/or wireless connections. The system 100A may also include a hash table 126 that stores one or more hash pairs for verification.

The server 112A may be deployed in a cloud computing platform 112, which may be a public cloud, a private cloud, or a hybrid cloud. The server 112A itself may be implemented as a physical machine, a virtual machine, or a combination thereof. The cloud computing platform 112 may include computing hardware, a resource management component, a host operating system (OS), and/or one or more virtual computing systems.

The resource management component may perform virtualization (e.g., abstraction) of the computing hardware to create the one or more virtual computing systems. Using virtualization, the resource management component enables a single computing device (e.g., a computer, a server, and/or the like) to operate like multiple computing devices, such as by creating multiple isolated virtual computing systems from the computing hardware of the single computing device. In this way, the computing hardware can operate more efficiently, with lower power consumption, higher reliability, higher availability, higher utilization, greater flexibility, and lower cost than using separate computing devices.

The computing hardware includes hardware and corresponding resources from one or more computing devices. For example, the computing hardware may include hardware from a single computing device (e.g., a single server) or from multiple computing devices (e.g., multiple servers), such as multiple computing devices in one or more data centers. The computing hardware may include one or more processors, one or more memories, one or more storages, and/or one or more networking components. Examples of a processor, a memory, a storage, and a networking component (e.g., a communication component) are described elsewhere herein.

The resource management component includes a virtualization application (e.g., executing on hardware, such as the computing hardware) capable of virtualizing the computing hardware to start, stop, and/or manage the one or more virtual computing systems. For example, the resource management component may include a hypervisor (e.g., a bare-metal or Type 4 hypervisor, a hosted or Type 2 hypervisor, and/or the like) or a virtual machine monitor, such as when the virtual computing systems are virtual machines. Additionally, or alternatively, the resource management component may include a container manager, such as when the virtual computing systems are containers. In some implementations, the resource management component executes within and/or in coordination with a host operating system.

A virtual computing system includes a virtual environment that enables cloud-based execution of operations and/or processes described herein using computing hardware. As shown, the virtual computing system may include a virtual machine, a container, a hybrid environment that includes a virtual machine and a container, and/or the like. A virtual computing system may execute one or more applications using a file system that includes binary files, software libraries, and/or other resources required to execute applications on a guest operating system (e.g., within the virtual computing system) or the host operating system.

The network includes one or more wired and/or wireless networks. For example, the network may include a cellular network, a Public Land Mobile Network (PLMN), a Local Area Network (LAN), a Wide Area Network (WAN), a private network, the Internet, and/or the like, and/or a combination of these or other types of networks. The network enables communication among the devices of the system 100A.

The gateway 109 (may also be referred to as a scanner device) may be part of a mobile, handheld device (i.e., mobile device), such as a smart phone, a tablet, a wearable computing device (e.g., a smart-watch, a pair of virtual reality or augmented reality glasses), or portable microcomputer and the like. The gateway may include a processor 114, a memory 116, and a display 118. The gateway 109 may also contain an NFC reader device 108 and a camera or image scanner to scan QR codes.

That is, in an embodiment, the gateway includes one or more devices capable of receiving, generating, storing, processing, and/or providing information, as described elsewhere herein. The gateway may include a communication device and/or a computing device. For example, the gateway may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The multimodal tag 111 is attached to an object 124 (e.g., a physical item, an asset, product, or part) that is being tracked, and includes a wireless communication device, such as, by way of non-limiting example, a Near Field Communication (NFC) device 107 that further includes a certified QR (CQR) code label 120 and an external identification (ID) device 122. The multimodal tag 111 may provide two or more independently verifiable data elements. Other wireless communication devices are also within the scope of other inventions, such as, for example, a Bluetooth, BLE, ultrawideband, random pattern of printed particles, such as nanoparticle inks, or other nonvisible wireless communication modality.

The NFC device 107 is typically a passive device that is embedded in an antenna, and is part of an NFC system, which also includes an NFC reader device (e.g., 108 i.e., NFC chip or NFC chipset) and an NFC communication chip. That is, NFC Devices 107 may include RFID transponders that operate at 13.56 MHz. They are tiny chips (integrated circuits) connected to an antenna. The chip has a unique ID and a part of rewritable memory. The antenna allows the chip to interact with an NFC reader device 108. In recent years, NFC Devices 107 have been developed to the point where one may write information onto the available memory of an NFC Device 107. This information can be easily read (and executed) by an NFC reader device 108.

The NFC Device 107 may respond to commands from the NFC reader device 108, and may store strings of data. In an embodiment, the NFC Device 107 may include a memory of about 144 bytes that is adapted to store one of an identification of the object 124, is of an ISO Format of ISO15693, and is one of an NFC-V or a TYPE-5 NFC. Also, the stored data may include an object ID number and an NFC hash.

The NFC reader device 108 is a silicon component or integrated circuit (IC) that facilitates short-range, wireless communication between devices. It is the active part of the NFC system that processes information, can read/write data, and sends commands to the NFC Device 107. When connected to the NFC Device 107, the NFC chip enables secure interactions within close proximity (within about 10-20 cm), and may retrieve the string information stored on the NFC Device 107. NFC chips allow devices to exchange data wirelessly when they are near each other. In an embodiment, the NFC chip may be embedded in the gateway (e.g., in a hand-held mobile device).

The NFC communication chip coordinates communication between the NFC reader device 108 and the NFC Device 107.

The NFC Device 107 allows for a low-cost digital representation of the object's digital fingerprint. Unlike CQR codes alone, which can be easily copied via a scanner or a camera and reprinted, NFC Devices 107 may be much more secure. Unlike Bluetooth or other communication methods, NFC does not require a search and pair procedure, which allow for a much faster connection without requiring manual configuration or special software. In an embodiment, the NFC Device 107 may support the ISO 15693 standard, which defines an ability to restrict read and write access and assign passwords for access.

Also, the NFC Device 107 may have capacity to store more than label information about the tag 111, but may also store NFC data required to decrypt the NFC reader device 108 data.

The CQR code label 120 is a specialized 2-dimensional (2D) barcode that can be printed on paper and coupled with the NFC Device 107. In an embodiment, the CQR code label 120 may be directly printed on the NFC Device 107. When scanned by a mobile device, the CQR code label 120 provides string information (e.g., a URL) in the form of a qr_hash that allows for access to additional information related to the object 124, including validation data, or a full document provided on a website. The CQR code label 120 enhances document security and may verify the authenticity of the user.

Along with the combined, simultaneous use of the CQR code label 120 and the NFC Device 107, the system 100A may function as an intelligent QR (iQR) and provide for two independent validation and verification mechanisms, which results in greater security.

The external ID device 122 may be an additional 2D or 3-dimensional (3D) barcode apart from the above-described CQR code label 120 that is coupled to the NFC Device 107. In an embodiment the external ID device 122 may be an RFID that stores from 64-bit to 2 kilobyte of data or an ultra high-frequency tag. Alternatively, the external ID device 122 may further include a battery to power the external ID device 122. In this case, more than 100 A kilobyte of information may be stored within the external ID device 122.

Similar to the case with CQR code label 120, when scanned by a mobile device, the external ID (122) may also provide string information (e.g., a URL) in the form of an external ID unique (at the object level) within the organization that is performing the scan that allows for access to additional information related to the object 124, including validation data, or a full document provided on a website. The external ID (122) may further enhance document security and may verify the authenticity of the user.

That is, the external ID device 122 provides for an alternative two-factor validation route from the CQR code label validation, when used with the NFC Device 107. However, when used in conjunction with the CQR label 120 and the NFC Device 107, a more secure three-factor verification process may be achieved.

The database 110 may be adapted to store information (e.g., object information) 126 about the object 124. The information 126 may be arranged to include two cryptographic data columns that are generated during a Principal Component Analysis (PCA) process. These two columns may include a qr_hash column accessible by a scan of the CQR code label 120, and an nfc_hash column separate from the qr_hash column that may be accessed upon proximate contact (or tap) between the NFC Device 107 and the NFC reader device 108. The creation of the two independent columns allows for two independent validation and verification mechanisms, which, when combined simultaneously, allow for greater security and prevention from counterfeiting of the validation devices.

In an embodiment, the nfc_hash column may store a unique password for each object 124, along with temporal data including the last cycle count on the NFC reader device 108 or the NFC Device 107 (i.e., how many read/writes).

Referring now to FIG. 1B, an exemplary asset 130 is labeled with a multimodal tag, according to some embodiments of the present disclosure. The asset 130 may be a physical object, item, article, component, piece of equipment, or other tangible structure intended to be verified, tracked, or monitored for security, authenticity, inventory management, usage validation, or compliance control. The asset 130 may be movable or stationary in nature, and may be selected from a wide variety of domains including, but not limited to, consumer electronics, industrial machinery, retail goods, pharmaceuticals, aerospace components, defense equipment, and medical devices. In one example, the asset 130 may comprise a portable medical scanner, an industrial valve, a packaged consumer product, or an electronic control unit. In another example, the asset 130 may be a fixed infrastructure element, such as a hospital bed, warehouse conveyor, or mounted telecommunications switch, requiring local tagging for traceability and restricted operational use.

The multimodal tag associated with the asset 130 may comprise one or more components designed to uniquely identify and validate the authenticity of the asset 130 during scanning or inspection. As shown in FIG. 1B, the multimodal tag may include a Certified QR (CQR) label 131, a Near Field Communication (NFC) device 132, and an external identification (ID) device 133. Each of these elements may be physically or digitally associated with the asset 130 and may operate independently or in combination with one another to provide different modalities of validation. The components of the multimodal tag may be mounted on the outer surface of the asset 130, embedded within its housing, attached as part of a label, molded into the asset's exterior, or affixed through adhesives, brackets, or mechanical fasteners, depending on the form factor, material, and function of the asset 130.

The Certified QR label 131 may be a two-dimensional barcode that is optically scannable using a gateway, for example, a smartphone, tablet, camera-enabled terminal, or dedicated QR reader. The CQR label 131 may encode digitally signed data, such as a Uniform Resource Locator (URL), a unique asset identifier, and a cryptographic hash that can be resolved via a validation server. In some embodiments, the data encoded in the CQR label 131 may be pre-generated by a central registration authority and may include additional elements such as manufacturing batch code, warranty identifier, model number, encryption key reference, or expiration date metadata. Upon scanning, the gateway device may extract the information from the CQR label 131 and initiate a remote validation request via a secure network, sending the extracted data to a backend server that verifies the authenticity of the code by comparing it to a corresponding database record. The CQR label 131 may be printed using tamper-evident ink, heat-fused into a polycarbonate label, laser-etched onto a metallic surface, or engraved onto the body of the asset 130, based on durability requirements. In some embodiments, a luxury wristwatch may have the CQR label 131 printed on the backplate, whereas in another embodiment, a handheld testing instrument may include the CQR label 131 under a protective glass layer near its display interface.

The NFC device 132 shown in FIG. 1B may comprise a wireless communication element that operates in accordance with ISO/IEC 14443, ISO/IEC 15693, or other NFC-compatible standards. The NFC device 132 may include an antenna, a memory chip, and passive or semi-passive circuitry that allows data to be transmitted wirelessly upon proximity-based activation by an NFC reader. The NFC device 132 may store various data fields, such as a Universally Unique Identifier (UUID), a dynamic or static authentication hash, encrypted asset metadata, digital certificates, or updateable event logs. In certain implementations, the NFC device 132 may support password-protected memory access, write-once fields, or hash-based challenge response authentication to prevent cloning or unauthorized replication. The NFC device 132 may be embedded within the asset 130, laminated into its internal shell, or adhered externally as a tag covered by a waterproof or impact-resistant housing. For example, an NFC device 132 may be molded inside the plastic enclosure of a smart thermostat, or inserted under the vinyl surface of an automotive part. The proximity-based nature of the NFC device 132 allows for short-range verification that is difficult to spoof from a distance, making it a valuable authentication layer.

The external ID device 133 may be a supplementary identification feature that provides an additional or alternate scannable format. The external ID device 133 may include a barcode, matrix code, iQR, alphanumeric serial number, colorimetric label, holographic strip, watermark-encoded image, or nanoparticle ink pattern. In the example shown, the external ID device 133 is represented as a one-dimensional barcode label. The external ID device 133 may store a locally unique identifier assigned to the asset 130 within a facility, organization, or logistics network, and may also include coded manufacturing or tracking metadata. In some embodiments, the external ID device 133 may be a passive RFID tag with long-range readability, a 3D printed pattern that exhibits a specific light-reflection signature, or a visual code that is read by specialized optical scanners in controlled environments. This component may be used in cases where fast scanning of a high volume of assets is required, or where compatibility with legacy equipment or commercial logistics systems is desired. The external ID device 133 may be attached to the asset 130 using adhesives, clipped to a mounting bracket, or printed directly onto product packaging or casing. In one example, a warehouse storage bin may include the external ID device 133 on its outer wall, while in another example, a telecommunications module may have the external ID device 133 etched into a removable service plate.

The combination of the CQR label 131, the NFC device 132, and the external ID device 133 provides multiple layers of independent validation mechanisms for asset 130. These can be used independently or collectively in a multimodal authentication protocol to assess asset authenticity, determine access eligibility, verify chain-of-custody, or record audit trails. For example, in a high-security environment such as an airport or a pharmaceutical distribution center, both the CQR label 131 and the NFC device 132 may be scanned together, and cross-validation may be performed between the values retrieved from each. This approach allows detection of tag tampering or partial replication attempts. Additionally, systems can be configured to request user credentials or biometric verification alongside the tag scan to confirm authorized user interaction. In another embodiment, the location of the scan may be logged with the multimodal tag's data, and compared with a known authorized use zone. If a medical diagnostic machine labeled with a tag like that shown in FIG. 1B is scanned at a location not registered to any authorized clinic, the system may trigger an alert or lock asset functionality until administrative review.

In some embodiments, the server-side system receiving the scan data from any of the tag components (CQR label 131, NFC device 132, or external ID device 133) may generate a real-time validation report. Such a report may include timestamp of the scan, asset ID, matched hash result, scan origin (e.g., gateway device ID or user profile), and a validity status. The scan history for each asset 130 may be stored in a secure database, with each validation logged as a separate event. Over time, this builds a comprehensive traceability record for each asset 130 across its lifecycle. The multimodal tag shown in FIG. 1B therefore supports a range of applications including supply chain traceability, anti-counterfeiting protection, secure user access, maintenance logging, and regulatory compliance across diverse industries.

Referring now to FIG. 1C, an exemplary system and method (140) are illustrated for validating an asset 142 using a gateway device 141A to scan a multimodal tag comprising multiple components 142A, 142B, and 142C affixed to or integrated with the asset 142, according to some embodiments of the present disclosure. The user 141 is shown operating the gateway device 141A, which may be implemented as a mobile computing device such as a smartphone, tablet, wearable smart device, or handheld scanner. The gateway device 141A may be equipped with one or more sensors, including a camera, a Near Field Communication (NFC) reader, a barcode scanner, GPS module, and a wireless transceiver configured for communication with a cloud server 143 over a secure communication channel, such as HTTPS, WebSocket, or MQTT. The gateway device 141A may execute a mobile or embedded application configured to scan and interpret multimodal tags attached to physical assets, initiate authentication requests, receive validation responses, and render the asset status to the user 141.

In the example shown in FIG. 1C, the asset 142 may be any physical product or equipment tagged for the purpose of validation, authentication, or access control. The asset 142 may be movable or stationary in nature, and may range from high-value consumer goods, such as electronics, watches, or fashion items, to industrial tools, leased equipment, or medical devices. The asset 142 is tagged with a multimodal identification structure comprising a Certified QR (CQR) code 142A, an NFC device 142B, and an external identification (ID) element 142C. The CQR code 142A may contain encoded information such as a Uniform Resource Locator (URL), a unique asset identifier, and a cryptographic hash. The NFC device 142B may store a Universally Unique Identifier (UUID) and a hash value associated with the asset 142, and may be readable via short-range wireless communication. The external ID element 142C may comprise a barcode, alphanumeric label, RFID tag, or other visible identifier that can be scanned using compatible equipment. Each of the tag components 142A-142C may independently or collectively enable the validation of the asset 142.

In operation, the user 141 scans one or more components of the multimodal tag using the gateway device 141A. The gateway device 141A may automatically detect available scan modes or prompt the user 141 to manually select a scanning method. Upon scanning, the gateway device 141A may extract encoded information and generate a validation request comprising data such as the asset identifier, one or more hash values, user credentials or authentication tokens, device metadata, and geolocation coordinates (geolocation value). This validation request may be transmitted wirelessly to the cloud server 143 for analysis. In some embodiments, the scanning application on the gateway device 141A may locally validate digital signatures associated with the scanned data, but final authentication may be carried out on the cloud server 143 to compare hash values and assess scanning context.

In some embodiments, the gateway device 141A may itself determine which component of the multimodal tag (142A-142C) has been scanned based on signal type, data structure, or input method. For example, if the gateway device 141A receives scanned data via an optical camera and the data conforms to a Quick Response (QR) code format, the scanning application may classify the input as originating from the Certified QR code 142A. Alternatively, if the scanned data is received wirelessly through an NFC interface and contains a UUID and associated hash pattern, the gateway device 141A may classify the input as originating from the NFC device 142B. Likewise, if the input is received through a barcode scanner or linear code reader, the application may categorize the source as the external ID element 142C. This classification may be automatically recorded along with the scanned payload and used to annotate the validation request sent to the cloud server 143. In some implementations, this allows the gateway device 141A to apply different rules or pre-processing steps based on the identified scan source, such as adjusting decoding logic, hash algorithm selection, or formatting of the outbound payload. Additionally, this feature may enable auditing of tag component usage, supporting analytics such as frequency of use per modality, failure rates associated with a specific tag type, or detection of tag substitution if an expected modality is consistently missing or replaced.

The cloud server 143, as shown in FIG. 1C, may be a distributed computing system or a dedicated backend server operated and controlled by an organization, such as the original manufacturer, licensor, or authorized seller of the asset 142. The cloud server 143 may maintain a connection to a database 144 (verification database), which stores reference records including known asset identifiers, corresponding QR hash values, NFC hash values, external ID records, product specifications, geographic usage zones, and historical scan events. Upon receiving the scan data from the gateway device 141A, the cloud server 143 may compare the received hash codes and asset identifiers with the records stored in the database 144 to determine whether the asset 142 is authentic. Additionally, the cloud server 143 may verify whether the user 141 or gateway device 141A is authorized to access the asset 142, based on pre-defined usage rules or credentials.

In some embodiments, the cloud server 143 may be configured to analyze geolocation data associated with the scan event and compare it with expected or permitted asset locations stored in the database 144. For example, if the asset 142 is intended for use within a specific geographic boundary, such as a hospital, manufacturing site, or retail outlet, and the scan occurs outside that boundary, the system may log the event as a potential deviation or unauthorized movement. The organization operating the cloud server 143 may define such geofencing parameters and use the scan history to detect unusual movement patterns. For example, if an industrial pump tagged with the multimodal tag 142A-142C is found to be scanned across different countries within an implausible time frame, the cloud server 143 may flag the asset 142 as potentially cloned, counterfeited, or stolen.

The scanning history stored in the database 144 may also be used to generate audit trails for compliance and monitoring. Each scan entry may include data such as scan time, scanning user identity, gateway device metadata, matched hash values, validation result, and asset status. In another example, if a consumer scans the asset 142 before purchasing it at a retail outlet, the system may record the scan as a validation event and associate the purchase location with the asset record. If the same asset (e.g., same tag) is scanned again in another territory shortly thereafter, such as in an unauthorized resale zone or through an unapproved distributor, the system may flag the duplication and notify the manufacturer. Thus, the organization operating the cloud server 143 may use the collected scan data to detect parallel imports, track unauthorized distribution channels, identify counterfeit insertions in supply chains, and investigate warranty fraud.

In other embodiments, the cloud server 143 may offer real-time feedback to the user 141 via the gateway device 141A, presenting a validation result indicating whether the asset 142 is verified, counterfeit, relocated, expired, or otherwise non-compliant. The system 140 may be integrated with additional enterprise services such as inventory control systems, service dispatch platforms, compliance enforcement engines, and consumer engagement tools. For example, upon successful validation of the asset 142, the system may offer the user 141 access to product manuals, maintenance history, warranty status, or a digital ownership certificate. This interoperability allows manufacturers and asset custodians to build trusted networks of physical asset validation and to maintain full visibility over product authenticity and usage across distributed environments.

Referring now to FIGS. 1D-1E, the figures illustrate exemplary components of a tag and how a POST request is generated and transmitted from a mobile device to a server for asset validation, according to some embodiments of the present disclosure. FIG. 1D depicts a tag 150, which for illustrative purposes is represented as a two-dimensional barcode (e.g., a QR code), but in actual implementation may take various forms including a Certified QR (CQR) code, a Near Field Communication (NFC) tag, a barcode, a matrix code, an external ID device, or any other encoded information carrier capable of being scanned by a gateway device. The tag 150 may be printed on, embedded into, or affixed to a physical asset, object, or product. In some embodiments, the tag 150 may be generated and encoded by a centralized registration authority or authorized organization responsible for asset authentication. The tag 150 may encode one or more data elements including but not limited to an asset identifier 150A, a Uniform Resource Locator (URL) 150B, and a hash code 150C. The asset identifier 150A may be a unique alphanumeric or hexadecimal value that corresponds to a registered asset in a remote or local database, such as “XYZ12345678” or “A45D3F8B2C.” The URL 150B may link to a verification endpoint hosted by a validation server or organization and may include query parameters such as the asset identifier or timestamp. For example, the URL 150B may be structured as “https://verify.example.com/check?id=XYZ12345678.” The hash code 150C may be a cryptographic digest (e.g., SHA-256 or SHA-512) computed over one or more asset-specific elements, including but not limited to the asset identifier, manufacturer code, timestamp, or location stamp, and may serve to validate the integrity and authenticity of the tag data.

In some embodiments, one or both of the asset identifier 150A and the URL 150B may be embedded within the hash code 150C either in whole or in part, thereby concealing the underlying identifiers from the plain data string within the tag 150. This method allows for obfuscation and tamper resistance, where an unauthorized party reading the tag 150 is unable to reverse-engineer the asset identifier or endpoint URL directly from the encoded pattern. Instead, only the hash code 150C is made visible, and upon scanning, the gateway device performs a secure request to a remote server that decodes or validates the embedded structure. In some embodiments, the hash code 150C may be computed using a combination of a fixed input (e.g., asset ID, manufacturing lot number) and a dynamic input (e.g., generation timestamp, serial sequence, or random salt). This technique provides enhanced protection against replication or cloning of tags, particularly in high-value product authentication scenarios such as pharmaceutical packaging, luxury goods, government-labeled instruments, or distributed high-security equipment. Additionally, the use of a hash-based approach allows for validation without exposing internal mapping structures or asset registration logic to the public domain, preserving backend security and integrity.

FIG. 1E depicts a gateway device or scanner device 151 scanning the tag 150 and triggering the transmission of a URL 154 to a cloud server 153 for verification. The gateway device 151 may be any scanning-capable user device such as a smartphone, tablet, dedicated handheld scanner, wearable device, or augmented reality headset. The gateway device 151 may run a validation software application or web-based interface configured to scan, decode, and process the tag 150. Upon successfully scanning the tag 150 using optical sensors, NFC readers, or barcode scanners, the gateway device 151 may extract encoded data and generate a validation request to be transmitted to the cloud server 153 over a network, such as the Internet, an intranet, a mobile data network, or a proprietary wireless mesh. In some embodiments, the extracted URL 150B from the tag 150 may be invoked directly as a GET or POST request to the endpoint specified within the tag, thereby forming URL 154. In another embodiment, the extracted hash code 150C may be used to construct a structured JSON payload or API call to a designated endpoint of the cloud server 153, which then parses the input, locates the corresponding asset record, and returns the validation outcome to the gateway device 151. The cloud server 153 may be a remote validation platform, organizational asset tracking engine, manufacturer-controlled database, or third-party verification service. In some embodiments, the request may include metadata such as the scanning user's credentials, geolocation data of the scan event, a timestamp, and device-specific identifiers. The cloud server 153 may analyze the validity of the hash, cross-reference it with asset registration entries, check usage permissions, and compare scan context with known constraints (e.g., authorized usage locations, allowed user roles, or access periods).

In certain implementations, upon successful validation, the cloud server 153 may return to the gateway device 151 a detailed asset profile, including product information, certification records, maintenance history, owner data, and validation confidence score. The gateway device 151 may render a validation result in real time to the scanning user, such as “Asset Verified,” “Hash Mismatch,” “Asset Relocated,” or “Access Restricted.” In other embodiments, the scanning and validation flow may be integrated with broader enterprise systems such as ERP (Enterprise Resource Planning), CRM (Customer Relationship Management), or SCM (Supply Chain Management) modules, where each successful scan logs into an audit trail or inventory management system. For example, a logistics technician scanning a tag 150 on a pallet of goods may automatically trigger inventory updates or delivery confirmations. In another example, a consumer scanning a tag 150 on a retail product may trigger the download of warranty details or promotional content. Thus, FIGS. 1D-1E illustrate a flexible, extensible, and secure framework for tag-based asset validation and lifecycle traceability using hybrid encoding, cryptographic verification, and remote backend integration.

Referring now to FIG. 1F, the exemplary gateway or scanner device 151 is configured to execute an asset verification application 155, the asset verification application 155 presenting multiple selectable options for initiating different types of tag-based and user-authenticated verification workflows, in accordance with some embodiments of the present disclosure. The gateway device 151 may be implemented as a smartphone, handheld scanner, tablet, or wearable computing device capable of communicating with physical tags and backend servers.

As illustrated, the asset verification application 155 displays a plurality of selectable options, including Auto Detect 156, Scan CQR 157A, Scan NFC 157B, Scan external ID device 157C, Two-factor verification based on tags only 158, and Two-factor verification based on one tag and user authentication 159. These options are configured to enable various workflows that support one or more verification layers, improving asset security, traceability, and fraud prevention.

The Auto Detect option 156 enables the gateway device 151 to initiate a passive scan for any detectable tag in the surrounding area. The tag may be a visible QR-based tag, a near-field NFC component, or an embedded external ID tag detectable via camera, RFID, or another optical scanner. Once a tag is detected, the asset verification application 155 automatically determines the type of tag by analyzing the data format and invokes the corresponding backend validation process.

For example, if the tag scanned through Auto Detect 156 is a Certified QR (CQR) code embedded with a URL and hash, the asset verification application 155 may extract the embedded data and send a POST request to a verification server. The POST request may contain the asset ID, tag hash, timestamp, and optionally device metadata for validation.

Alternatively, if the tag detected is an NFC tag, the gateway device 151 may retrieve stored identifiers and embedded hash values via wireless communication protocols. This data is then packaged into a POST request and transmitted to the server without requiring manual tag-type selection by the user.

The Auto Detect functionality 156 simplifies the scanning process and is particularly useful in environments where multiple tag types coexist. For example, a maintenance technician operating in a warehouse may encounter various tagged equipment, and Auto Detect 156 enables seamless verification of each asset without manual mode-switching.

The Scan CQR option 157A allows the user to initiate a manual scan of a Certified QR tag affixed to an asset. This mode may be ideal when the tag type is known in advance, such as during asset onboarding, inspection, or regular validation cycles.

Upon selecting Scan CQR 157A, the asset verification application 155 activates the gateway device 151's camera, optical scanner, or imaging module to capture the QR code. The decoded data may include asset identifiers, digital signatures, and URLs pointing to verification endpoints. This data is processed and sent to the server for validation.

The Scan NFC option 157B permits scanning of embedded or attached near-field communication tags. When selected, the asset verification application 155 engages the device's NFC module and begins a polling cycle for tags within range. The tags may contain static or dynamically generated identifiers, hash values, and tag-specific metadata.

The NFC scan mode 157B is especially effective in environments requiring contactless interaction. For example, in sterile hospital environments or areas with heavy machinery, NFC scanning allows personnel to validate assets without requiring line-of-sight or physical contact.

The Scan external ID device option 157C enables scanning of tags other than QR or NFC, such as barcodes, proprietary ID patterns, RFID chips, or even optically recognized device engravings. The system can be configured to recognize custom encoding formats.

When option 157C is selected, the asset verification application 155 prompts the user to use an auxiliary scanning peripheral or the onboard camera to capture the external ID tag. Once scanned, the asset verification application 155 translates the encoded values and sends them to the server for validation.

Option 158 presents a two-factor verification mode that uses multiple tag types for asset validation. Under this mode, the user must scan two distinct tags associated with the asset to complete the verification process.

For example, a user may first scan a CQR tag 157A and then be required to scan an NFC tag 157B within a defined time interval. Only if both scans are completed within the acceptable time window will the system generate a successful verification response.

The two-factor tag verification mode 158 strengthens security by cross-validating two independent identifiers. This reduces the risk of spoofing or asset tag cloning. Even if a visible tag such as a CQR is compromised, validation fails if the accompanying NFC tag scan is not completed within the prescribed timeframe.

In some embodiments, the time interval between tag scans may be set to 60 seconds, 90 seconds, or other configurable thresholds. If the second tag is not scanned in time, the system may prompt the user to restart the verification sequence.

This timed two-tag process is useful in enterprise environments such as data centers, where high-value equipment may require verification using both a surface-printed code and an embedded radio tag.

The system may also be configured to accept combinations of tag types for two-factor verification. For example, combinations may include CQR+NFC, NFC+external ID, or CQR+external ID. Each pairing provides distinct authentication strength and use-case suitability.

In some embodiments, mobile payment terminals in a retail store may be tagged with both a printed CQR and an internal NFC chip. Employees must scan both tags during end-of-day inventory reconciliation. In another scenario, rental equipment such as audio gear may require two-tag scans before checkout. A customer scans the visual tag and presents a digital access badge containing the secondary NFC tag.

The two-tag verification flow reduces reliance on single-mode tag validation and may also help identify tampering, where one tag has been removed, swapped, or relocated. Option 159 introduces a hybrid verification mode, combining one tag scan with user authentication data. Under this model, the user must successfully scan one tag (e.g., CQR, NFC, or external ID) and also provide supporting authentication such as a user ID, biometric confirmation, or location data.

In embodiments where assets are restricted to specific users, the user ID requirement enforces role-based access. For example, only supervisors or technicians assigned to a given device pool may receive access approval when submitting their credentials along with a valid tag scan. In some cases, location data is used as the second factor. This is particularly relevant for assets restricted to geofenced areas such as secured warehouses, hospitals, or classrooms. If the tag is scanned outside the authorized location, access is denied regardless of tag validity.

This hybrid verification model supports varied authentication layers. For example, a contractor scanning a tag may be required to validate their identity using a fingerprint prompt and a pre-registered username in the application.

In another embodiment, two users may co-scan the asset. One scans the tag and another presents a secure user token, allowing controlled transfer of asset access between parties. The hybrid model can also prevent theft and misuse. For example, if a user scans a tag on a stolen asset outside its registered zone, the backend server may detect unauthorized use based on location mismatch or unrecognized user ID.

In further embodiments, facial recognition, secure passcodes, or Bluetooth-based proximity authentication may be integrated into option 159 to complement the tag scan. This approach is valuable in situations where asset control is tied to personnel accountability. Government-issued equipment, military devices, and sensitive medical kits may all benefit from user-tag hybrid authentication.

Moreover, the system may support delayed tag validation, where a tag scan is accepted only if user credentials are submitted within a defined time period. This provides temporal coherence between the two authentication elements.

The hybrid flow also allows flexible policy tuning. Organizations may permit tag-only scans during business hours and enforce full hybrid authentication during off-hours or in high-risk zones. The gateway device 151 may store partial verification attempts and send them for review if the secondary authentication fails or times out. These logs enable audit and risk scoring.

The asset verification application 155 may display contextual messages for each option. For example, for option 159, the message may state: “Scan completed. Please authenticate to proceed.” In all cases, verification outcomes from each of these workflows are packaged into POST requests and submitted to the server (143), including metadata such as timestamp, location, user ID, device signature, and tag hash.

In some embodiments, the gateway device 151 may be configured to store one or more previously authorized hash values corresponding to multimodal tags such as Certified QR (CQR) codes and NFC tag data. For example, upon successful verification of an asset via a server-based POST request, the gateway device 151 may cache a corresponding pair of hash values derived from the scanned multimodal tag (e.g., a CQR hash and an NFC hash), in association with the verified asset ID and optionally with user identifiers or location metadata. These locally stored hash values may be retained within a secure cache, memory store, or encrypted application container within the gateway device 151.

When subsequent scans of the same asset are performed by the user using the same gateway device 151, the device may extract the hash from the scanned tag data and compare it with the previously stored hash pair. If a match is found between the extracted hash and one of the locally stored hash pairs, the gateway device 151 may temporarily authorize access to the asset, permit continued interaction, or pre-approve the POST request pending further contextual checks. This embodiment may be particularly useful in offline or low-connectivity environments, where full round-trip validation with the remote server may be delayed or unavailable. In such implementations, the gateway device 151 acts as a trusted intermediary for short-term or repeated validation scenarios.

In some embodiments, local hash pair caching may be scoped to a specific user profile authenticated on the gateway device 151, such that stored hash data is only applicable to the user who originally performed the verification. In other configurations, the cached hash data may be tied to asset-specific trust policies—for example, allowing temporary reuse of a validated hash pair for a specified window of time (e.g., 30 minutes, 2 hours) or number of interactions before requiring full re-verification.

In an alternate embodiment, when a verification POST request is generated from the gateway device 151 to the server, the server may compute a time-based one-time password (TOTP), or equivalent time-synchronized cryptographic code (time-based authentication code), based on a shared secret or asset-specific key. The server may transmit this TOTP code as part of the response to the asset verification application 155 executing on the gateway device 151. The asset verification application 155 may then store this TOTP code along with a time-to-live (TTL) parameter or expiration timestamp.

Thereafter, the gateway device 151 may use the received TOTP code to authorize subsequent interactions with the asset during the TOTP validity window. For example, if the user attempts to re-access the asset or perform a configuration action, the asset verification application 155 may present the stored TOTP to the server as proof of recent verified interaction. The server may then compare the submitted TOTP against a locally generated reference TOTP based on the same shared seed and time value to validate its authenticity.

In some embodiments, the TOTP may also be displayed visually to the user within the asset verification application 155, allowing the user to manually input the code on a separate terminal, administrative device, or paired hardware system. This manual entry mode may be used in scenarios where distributed asset interfaces do not support direct scanning or NFC interactions but still require proof of recent authorized validation.

Additionally, the TOTP framework may support asymmetric trust propagation. For example, an administrator device may generate and distribute temporary TOTP codes to user devices for temporary asset access rights. These TOTP codes may expire after a predefined time or after single use, thereby reducing risk of long-term credential misuse.

In a further embodiment, a TOTP code may be embedded within a secondary tag temporarily linked to the asset (e.g., a disposable QR tag or portable NFC device containing the TOTP code). The asset verification application 155 may be configured to read this secondary TOTP tag and associate it with the original asset during verification, thereby allowing secure handover of the asset between users in controlled settings.

These local caching and time-based authentication techniques provide flexible and secure mechanisms for extending the trust lifecycle of previously validated assets, especially in edge environments, mobile scenarios, and shared-asset contexts. By reducing repeated reliance on centralized validation while maintaining secure verification, these embodiments enhance efficiency without compromising system integrity.

In some embodiments, the asset verification application 155, as illustrated in FIG. 1F, may be configured to support the registration of a sub-organization under a main or parent organizational structure. The asset verification application 155 may be implemented on a user device or administrative portal and may provide an interactive interface for onboarding a sub-organization entity, such as a retailer, franchisee, field service vendor, warehouse, or distributor. Upon scanning one or more genuine assets using a defined mobile or web-based CRM application, the asset verification application 155 may trigger a registration flow whereby metadata associated with the asset (e.g., asset ID, origin identifier, product batch, timestamps) is cross-referenced with stored records of the main organization to establish a relationship. The application may auto-populate proposed sub-organization details (e.g., tentative name, physical location, GPS coordinates, user-provided identifiers) and submit the compiled payload to the application server 103 for review and processing. In some embodiments, approval of the sub-organization registration may occur automatically if the scanned assets are verified as genuine through QR_hash or NFC_hash match. Alternatively, a manual review and approval may be triggered at the main organization 420 for high-security registrations, particularly in cases where a potential sub-organization is operating in a high-risk geography or is flagged for prior anomalies. The asset verification application 155 thus enables a seamless and policy-compliant extension of organizational hierarchy through asset-linked digital authentication.

Referring now to FIG. 1G, a flowchart illustrates an exemplary asset verification process 160 using a multimodal tag 161 scanned by a gateway device 162, which extracts verification data and transmits a POST request 163 to a server 164 for authentication. This exemplary asset verification process 160 is applicable to physical asset tagging systems where assets are marked with scannable tags containing encoded identifiers, hashes, or verification metadata. The multimodal tag 161 may be a Certified QR (CQR), NFC, barcode, or other optical or wireless tag.

In some embodiments, the multimodal tag 161 may store one or more data elements, including a hash code, asset identifier, and verification URL. The gateway device 162 may retrieve any or all of these values upon scanning. For example, in one implementation, the multimodal tag 161 may store a raw hash code derived from a concatenated string comprising the asset ID and URL. In such a case, the hash code itself may embed the asset ID as a prefix, followed by encoded content and checksum bits, such as:
“ABC123a7f8e33dlc9efbexamplehashchecksum.”

Alternatively, in some embodiments, the multimodal tag 161 may provide only the hash code, while the verification URL may be pre-configured and stored locally within the verification application running on the gateway device 162. Upon recognizing the tag format, the gateway device 162 automatically attaches the predefined URL to the outgoing POST request 163.

The gateway device 162 may comprise a mobile phone, tablet, wearable scanner, or any network-enabled device equipped with an optical camera or NFC module. Upon scanning the multimodal tag 161, the gateway device 162 extracts and parses the encoded information to assemble a verification POST request 163.

As shown in FIG. 1G, the POST request 163 may contain a URL 163A, a hash code 163B, and optionally other data 163C. The URL 163A may be a verification endpoint such as “https://verify.example.com,” which is configured to receive asset validation requests. The hash code 163B represents the unique digital fingerprint of the asset tag, containing or referencing one or more unique identifiers.

The additional data 163C may include an authentication token derived from the gateway device 162 or its active user session. In some embodiments, the authentication token may be a username or user ID linked to a verified account logged into the device. In other embodiments, the authentication token may be a one-time code, such as a Time-Based One-Time Password (TOTP), generated or received via a secure channel.

In embodiments utilizing TOTP, the server 164 and gateway device 162 may operate using a shared seed or secret, allowing each to independently compute a synchronized one-time code valid within a narrow time window (e.g., 30 seconds). When the user initiates a scan, the gateway device 162 computes or receives the TOTP, appends it to field 163C, and transmits it alongside the hash and URL.

In an alternative embodiment, the TOTP may be generated by the server 164 and sent proactively to the gateway device 162 based on predefined authorization conditions. The application executing on the gateway device may store this code temporarily and attach it to POST requests involving sensitive asset classes.

After the POST request 163 is transmitted, the server 164 receives and parses the data, validating the hash code 163B against a database of registered assets. The server may cross-reference the hash with known hash values, comparing not only for exact match but also examining the expected asset ID or embedded metadata.

If the request contains a URL 163A that does not correspond with the known structure or hostnames authorized for a particular asset class, the server 164 may reject the request or log it as suspicious.

When additional data 163C is included, the server 164 may validate the provided authentication token or TOTP against pre-authorized user profiles. If the code has expired, is malformed, or has already been used, the server may deny access.

Upon completing validation, the server 164 transmits a response 165 back to the gateway device 162. This response 165 may indicate the status of the verification attempt, including whether the asset was found, whether the hash code matched, whether the request was submitted from a trusted user or device, and whether access is allowed. The verification result 165 may be encoded as a success or failure message, or may contain structured metadata including access permissions, user role, usage count, device compatibility, asset version, asset manual, warranty information, manufacturer information, and geographic constraints.

In the event that the POST request 163 is determined to be invalid, the server 164 may take additional action. For example, if the hash code 163B matches an asset ID but the associated location or user context is inconsistent with prior usage, the server may classify the attempt as a potential counterfeiting event.

In response to a suspected misuse or security anomaly, the server 164 may transmit an alert or escalation signal to a registered organizational or real user entity 166. This may include sending an email, push notification, or dashboard update to administrators responsible for the asset.

The real user 166 may be the owning organization, a designated administrator, or an AI-enabled monitoring system configured to take automated action. Actions may include temporarily locking the asset, revoking access tokens, or initiating deeper forensic analysis.

In certain embodiments, the server 164 may log the POST request 163 along with metadata including timestamp, IP address, gateway device identifier, GPS location, and software version. These logs may be used to build asset usage history, user activity profiles, or for post-incident analysis. In another embodiment, the POST request 163 may include location coordinates collected by the gateway device 162 during scan. This information may be compared against expected location data to determine whether the asset is being used in its authorized zone.

If the asset has a designated geofence, and the request falls outside that range, the server may reject verification even if hash and URL are valid. This is useful for preventing relocation or theft-based spoofing. The system may also detect repeated failed attempts involving the same hash code from different users or devices. If the same hash is being reused across devices or in suspicious timing sequences, the server may blacklist the hash and notify the organization 166.

In some implementations, the POST request 163 may include a session identifier linking the scan to a broader transaction, audit trail, or chain-of-custody log. This enables verification to be part of broader digital workflow.

The process flow in FIG. 1G may be executed synchronously or asynchronously. In synchronous mode, the gateway device 162 awaits a live response from the server before granting or denying access. In asynchronous mode, the scan may be logged locally and validated later when connectivity is restored.

The gateway device 162 may be preloaded with templates for constructing the POST request 163, facilitating uniform formatting and reducing the risk of malformed requests.

An exemplary asset verification process 160 may be compatible with environments where tags degrade over time. The server may maintain historical hash values or expired keys to support backward compatibility or staged replacements. In some embodiments, the hash code 163B may be combined with a session nonce or salt at the time of POST request formation, improving resistance against replay attacks or code duplication. The server 164 may support AI-based validation, where timing, location, user behavior, and device characteristics are fed into a scoring model. The model may return a confidence score that determines whether to approve the verification.

For high-value or sensitive assets, the system may require dual validation-first matching the hash, then authenticating the user or device via a second factor. The gateway device 162 may be configured with fallback mechanisms in case server 164 is temporarily unavailable. For example, a set of pre-approved hash codes may be cached for short-term offline use. The multimodal tag 161 may be printed, engraved, embedded in packaging, or integrated into a tamper-proof housing. Upon being scanned, it may trigger both visual and digital verification steps.

The POST request 163 may support encryption using TLS or application-level payload signing. This protects against interception or manipulation of hash, URL, or authentication data. The organizational user 166 may configure rules for accepting or rejecting verification attempts. For example, assets used in healthcare may reject any scan not originating from whitelisted locations.

Periodic reports may be generated from accumulated scan logs, providing analytics such as most frequently scanned assets, most active users, and anomalies detected. In some embodiments, the gateway device 162 may optionally store the last successful POST request 163 and response 165. This allows continued usage during temporary disconnections while maintaining traceability. In scenarios involving shared assets, the server 164 may maintain a list of authorized user IDs allowed to interact with a given asset. The POST request 163 containing the user token will be checked against this list. The hash code 163B may also include metadata tags such as asset version, firmware, or model number, allowing the server 164 to reject obsolete or mismatched scans.

Referring now to FIG. 1H, an exemplary verification table 170 generated by the server 164 is illustrated, in accordance with some embodiments of the present disclosure. The exemplary verification table 170 presents multiple fields corresponding to asset validation parameters processed during scan events and verification POST requests. These parameters include an Asset ID field 171A, QR Hash comparison field 171B, NFC Hash comparison field 171C, Location permission field 171D, User ID authorization field 171E, and final Status determination field 171F.

The Asset ID field 171A identifies the unique identifier assigned to the physical asset being scanned and verified. In this example, all rows (172A-172D) reflect the same asset ID “ABC123,” indicating that multiple scan attempts were logged for the same physical item across varying conditions.

The QR Hash field 171B logs the result of comparing the hash extracted from the QR code (or CQR code) during the scan with a reference hash stored in the server's database. A “Match” in this field indicates successful recognition and integrity of the QR code.

The NFC Hash field 171C operates similarly, but for the NFC component of the multimodal tag. This field represents whether the NFC tag's hash also aligns with the stored reference. A “No Match” value may suggest tampering, tag replacement, or counterfeiting.

A Location permission field 171D indicates whether the scan was performed from a geographically authorized area. “Allowed” denotes that the GPS coordinates or Wi-Fi fingerprint fell within an expected zone; “Not Allowed” indicates otherwise, suggesting relocation or misuse.

The User ID authorization field 171E reflects whether the user performing the scan was recognized and permitted to verify the asset. This value may be derived from an authenticated session, token-based login, or manual credential entry.

The Final status determination field 171F is the final determination made by the server, based on evaluating the above conditions. It may denote “Genuine,” “Counterfeited,” “Stolen,” or a compound status such as “Genuine|Asset Moved.”

Row 172A shows a validation event for asset ABC123 where all verification parameters returned a positive result. Both QR and NFC hashes matched (171B, 171C), the scan was performed from an allowed location (171D), and the user ID was recognized as authorized (171E). The resulting status (171F) is “Genuine,” reflecting a fully trusted scan event (genuine asset). This scenario may represent a technician validating an in-place industrial sensor using an enterprise application on a registered mobile device. The asset has not been moved, tampered with, or accessed by unauthorized users.

Row 172B reflects a scan where the QR hash matches (171B), but the NFC hash fails to match the reference (171C). The location is allowed (171D), and the user is authorized (171E). However, the overall status (171F) is marked as “Counterfeited.” This configuration may occur if a QR tag was copied or cloned and placed on a counterfeit or stolen asset that lacks the original NFC component. The system detects the hash discrepancy and flags the event as suspicious. This example highlights the security advantages of multimodal verification-requiring both visible and embedded tags to align to deem an asset genuine.

Row 172C shows both hash values as matching (171B, 171C) and a recognized user ID (171E), but the scan was performed from a location that is not authorized (171D=“Not Allowed”). The final status in this case is “Genuine|Asset Moved.”

This indicates that while the asset appears genuine, it has been relocated from its permitted site. Such a situation may occur when a medical kit tagged for hospital use is taken off-premises. This alerts administrators to potential unauthorized transport. The system may also log relocation history for audit or compliance purposes, especially in government, defense, or rental sectors.

Row 172D reflects a scan where both QR and NFC hashes match (171B, 171C), the scan location is allowed (171D), but the user ID is not recognized (171E=“Not Allowed”). The final status returned is “Genuine|Stolen.”

This outcome indicates that while the asset itself remains physically intact and in its authorized location, it was scanned by an unauthorized party, possibly indicating theft, impersonation, or unauthorized handover. The server (164) may escalate such a status to security personnel or asset owners (166) through real-time notifications, application alerts, or incident reporting channels.

Each field in this table is derived from verification logic running in the server backend. For example, hash matching involves deterministic comparison functions using SHA-based or HMAC algorithms with stored seed values.

Location determination is typically based on real-time GPS data, Wi-Fi triangulation, or cell tower signals reported by the gateway device. The result is matched against geofenced coordinates associated with the asset. User ID authorization may be implemented using an access control list, organizational directory, or authentication token validation process. Users not present in the allowlist may be flagged.

The final status determination field 171F is determined by the system's rule engine, which evaluates combinations of parameters and assigns verdicts using defined conditions. In some embodiments, the server may assign weights to the various fields. For example, a matching hash may carry higher weight than a matching location, allowing graded or probabilistic trust scoring.

The exemplary verification table 170 may also support extended statuses such as “Flagged for Review,” “Duplicate Scan,” or “Delayed Scan,” based on contextual factors like frequency, scan history, or behavioral anomalies. In advanced configurations, the exemplary verification table 170 may support integration with machine learning models that learn from historical data to identify patterns of misuse or error.

Such a model may learn that certain user-device combinations frequently yield “Not Allowed” results and prompt for stricter multi-factor checks. Each row in the exemplary verification table 170 may be linked to additional metadata not shown here, such as timestamp, asset category, environmental data, or device identifiers used during the scan. The exemplary verification table 170 may be periodically exported for reporting or reviewed in real-time using a dashboard used by administrative or security personnel.

The server 164 may support audit queries such as: “Show all assets with mismatched NFC hashes this month,” using indexed views over the exemplary verification table 170. The data structure depicted in FIG. 1H may also serve as input to inventory control systems, maintenance logging, or compliance documentation. For example, a device listed as “Genuine|Asset Moved” may automatically generate a location change approval request for supervisory review.

The QR and NFC hash match fields 171B and 171C are particularly important in environments where tag cloning is a concern, such as in consumer electronics, pharmaceuticals, or luxury goods. User ID authorization field 171E supports traceability by linking scan actions to personnel, enabling attribution and behavior tracking. The combination of location, hash integrity, and identity authentication allows the exemplary verification table 170 to support a triangulated approach to asset verification.

In some embodiments, scanning a tag in a valid location with mismatched hashes may yield “Counterfeited” status, while valid hashes scanned from the wrong region yield “Asset Moved.” In high-risk deployments, an asset marked “Genuine|Stolen” may immediately lock access to dependent systems, such as disabling connected machinery or remote APIs.

FIG. 1H may represent a snapshot in time or an ongoing stream of verification records processed in real time. It supports both passive monitoring and active intervention models, where failed scans may prompt alerts, requests for photo proof, or escalation workflows. The exemplary verification table 170 may also feed analytics modules that report daily scan volumes, regional asset status trends, or user compliance metrics. The layout of the exemplary verification table 170 is extensible, allowing additional fields such as “Session ID,” “User Role,” or “Device Type” to be added as needed.

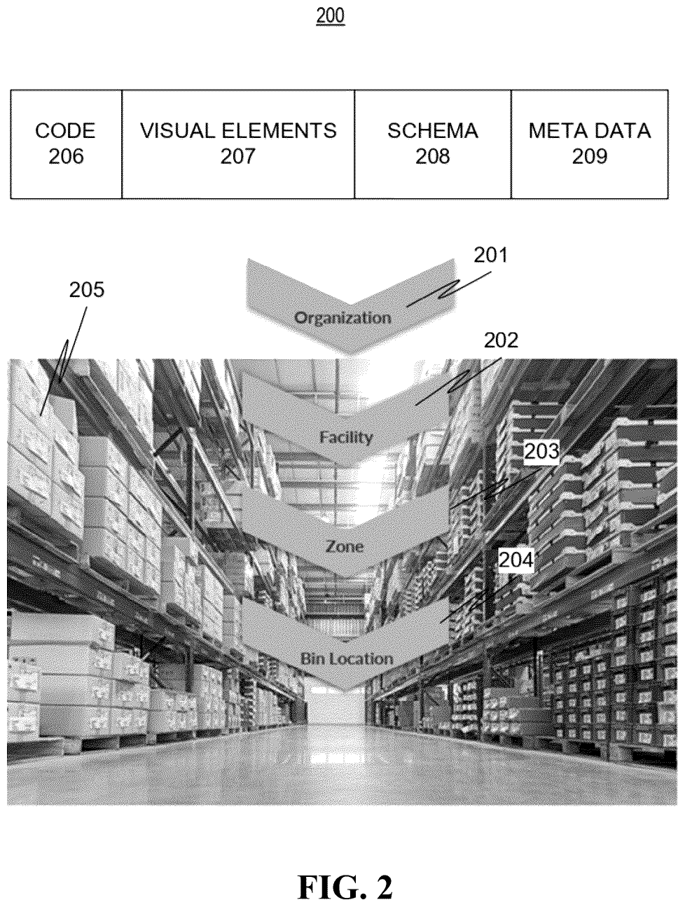

Referring now to FIG. 2, in general, the present disclosure provides an automated asset tracking system 200 including a physical asset 205 positioned within a multi-tiered hierarchical structure defined by four digital container levels-Organization 201, Facility 202, Zone 203, and Bin Location 204, and supported by a coordinated system of programmatic code 206, visual elements 207, schemas 208, and metadata 209. The drawing represents both a real-world warehousing scenario and its corresponding digital architecture as maintained within the CRM instance and mirrored to one or more external product application servers.

The coordination of code 206, visual elements 207, schemas 208, and metadata 209 takes place in an ecosystem in an “instance”, which is the space defined for each customer. The various elements of the application are developed on connected computers that interact with a dev instance (typically a scratch org) where the files are synchronized.

Asset 205 represents a physical item placed within a warehouse or logistics environment, and may comprise a single packaged good (e.g., a boxed retail product, a medical device, a secured envelope), or a bundled or grouped package (e.g., a palletized stack of goods, a container with multiple SKUs, a shipping crate). In some embodiments, asset 205 is equipped with one or more machine-readable identifiers, such as a Certified QR code (CQR), Near Field Communication (NFC) tag, or an embedded RFID chip. The identifier may store a cryptographically hashed value derived from a unique UUID associated with the asset, such that the hash may be verified against a known reference in the product application server upon scan or interaction.

The asset 205 is physically and logically situated within a digital hierarchy, beginning at Bin Location 204, progressing through Zone 203 and Facility 202, and ultimately assigned to an Organization 201. Each level is defined through distinct CRM object types, and allows for modular, location-aware record management.

Organization 201 represents the top-level entity in the hierarchy. Each Organization_c object in the CRM instance corresponds to a logical business entity, division, or operational unit, such as “Western Distribution Group” or “Europe Fulfillment Division.” Organization objects serve as the root container for all subordinate facilities, routes, assets, and events. Each organization record includes an ExternalId_c field used for synchronization with the product application server. The parent-child relationships among organization records are stored using a parentOrgId field or equivalent reference pointer. A top-level organization object is typically the only organization without a parent and is used to define inherited default parameters, such as routing rules, event templates, and synchronization endpoints.

Facility 202 defines a specific operational site within the organization, such as a physical warehouse, depot, or transit hub. Facility_c objects are related to their parent Organization_c via a lookup or master-detail field. Each facility record may include geolocation fields (latitude, longitude), address strings, operating hours, zone maps, storage capability flags, environmental control indicators (e.g., refrigeration enabled), and permissible asset types. Facilities may be monitored for geofence events such as asset entry/exit or unauthorized removal. Each facility may mirror a facility record in the product application server, with the ExternalId_c of the CRM record used to store the UUID of the external system's representation.

Zone 203 may represent a sub-area within a facility. A zone may be defined according to storage function (e.g., “Hazmat Zone”), environmental condition (e.g., “Cold Chain”), or process stage (e.g., “Packing Area,” “Inbound Dock”). A zone may be modeled within the CRM either as a custom object (e.g., Zone_c) or as a field array within the Facility_c object. Each zone may be uniquely identified and mapped to specific validation policies. For example, when a high-value asset is assigned to a zone labeled “Restricted Access,” automated checks can restrict scans or associate alerts with unauthorized zone movements.

Bin Location 204 may represent the smallest addressable unit of physical placement within the hierarchy. Each bin location may correspond to a shelf, bin, compartment, tote, or coordinate pair (e.g., Rack A, Row 3, Slot 7). The system may track bin-level placements through scan events, mobile user inputs, or automated readers. In some embodiments, bin locations are dynamically linked to asset records, and any change in bin assignment triggers a trigger handler in the CRM to update linked route plans or asset history. Bin locations may also be involved in audit trails and inventory reconciliations.

Above the physical schema, the automated asset tracking system 200 includes four key supporting components—Code 206, visual elements 207, schema 208, and metadata 209—which collectively define the architecture of the CRM-integrated asset tracking system.

Code 206 refers to the executable logic, scripts, and trigger routines responsible for object behavior, data flow, and system interconnectivity. Code may be written in one or more programming languages, such as Apex for CRM logic, JavaScript for UI interaction, and declarative configuration for no-code functionality. In preferred embodiments, Code 206 comprises Apex classes for trigger handlers, utility functions, and test coverage. For example, when a new Organization_c is created, an Apex trigger handler extracts key fields, builds a payload object, and invokes a DataSynchronization mechanism to mirror the record into the external system. Code 206 may also include batch jobs, queueable classes, schedulable tasks, and REST API callout handlers.

Visual elements 207 include the user interface (UI) components that allow CRM users to interact with, visualize, and manage the objects within the system. These may include standard CRM page layouts, Lightning Web Components (LWC), custom buttons, forms, dashboards, and iframe-embedded React applications. For example, the RouteMap component is a React-based visualization embedded within a custom LWC, allowing users to view the live position of tracked assets along assigned routes. Visual elements 207 support tagging workflows, asset validation screens, and administrative route plan configuration panels.

Schema 208 defines the structural object model used by the system, including both standard CRM objects (e.g., Account, Contact) and custom objects specific to this asset tracking system (e.g., Organization_c, Facility_c, Route_c, TrackableAsset_c, Tag_c). The schema includes field definitions, object relationships, indexing strategies, and access controls. Each custom object may include fields for external IDs, mirroring flags, object state, and associated metadata. Schema 208 supports dynamic field mapping and modular deployment via unlocked packages or namespaced managed packages, providing consistent structure across development, staging, and production environments.

Metadata 209 includes declarative configuration and auxiliary data that governs the behavior of code and schema in different runtime contexts. This may include field-level security settings, permission sets, validation rules, workflow configurations, and dynamic field visibility logic. In some embodiments, Metadata 209 also governs synchronization parameters, such as which fields are included in payloads, endpoint URLs, retry logic, and field mappings between CRM and product application server schemas. Metadata may be included in package manifest files and version-controlled repositories to enable reproducible deployments.

The automated asset tracking system 200 therefore combines a robust physical schema (205-204) with a tightly integrated logical and technical framework (206-209), enabling seamless mirroring, tracking, validation, and route analysis across CRM and external systems. This layered architecture allows for modular growth, enterprise-level scalability, and secure, real-time asset visibility across distributed operations.

Referring again to FIG. 1 and FIG. 2, in some embodiments, each package may have a namespace, which is inherently prefixed to all database objects and fields. This allows for packages to avoid object and field collisions with similar custom objects and fields running on the same instance. An application server (e.g., 103) supports one or both of the logistics application and the CRM application (104) in a variety of ways, all using the standard REST API model. Functionalities that may be accomplished include:
a) Object data from the CRM application (104) is mirrored into the application server (103).
b) The CRM application (104) may query the application server (103) for asset history and other data changes.
c) Devices (trackers and tags) are created in the application server (103) and are retrieved on a periodic schedule to be ingested into the CRM application 104 (via polling).

Logistics Pro mobile and LPC Logistics applications may interact with the application server (103).
a) Associate/Dissociate actions and others are supported as usual.
b) CRM-specific versions are required to select the correct application server (103).

CRM RouteMap may be a React application that displays the location of assets, routes, and route plans.
a) The CRM application embeds React components as an iframe in a custom LWC component.
b) The path parameters select the use case (asset, route, or route plan), and include the specific ID (asset ID, route ID or route plan ID), as well as the organization ID.

### CRM Custom Objects

Currently, the CRM application defines the following Custom Objects:

### Organization_c

a) Each instance maintains a hierarchy of Organizations that are mirrored in the product application server. The most important is the single Top Level Org, which is the only one without a parent. Like all mirrored objects, it has an ExternalId_c column where the product application object identifier is stored.

### Facility_c

a) Facilities are defined for tracking geofence events. These objects are mirrored in product application and are related to an organization.

### RoutePlan_c

a) Route Plans define a route from point A to point B. They are mirrored in product application and related to an organization.

### Route_c

a) A Route is an instance of a Route Plan, defining the start date/time and end date/time and mileage. Process automation (in product application) can be configured per route. They are mirrored in product application and related to a Route Plan

### RouteStop_c

a) Route Stops are intermediate locations where stops occur. They are mirrored in product application and related to a Route.

### TrackableAsset_c

a) Trackable Assets (TAs) are the mirrored objects of the product application Assets. They have an assetMode of either Device or Asset. Device TAs are referred to as Tags in the UI but may be displayed alongside Assets.

### IntegrationLog_c

a) The Integration Log is quite useful for debugging since it catalogues errors in syncing with the product application server.

### EventConfig_c

a) Event Configs capture each parameter set for events defined in the process automation flow. They are not mirrored in the product application server, but the collection of event configs for an organization or route are collected and sent to the product application server using the Processing Config triggers.

### ProcessingConfig_c

a) Processing Configs are maintained in the CRM application for interacting with the product application server's event configuration sets. They are NOT mirrored in the product application server, but do contain an external ID, which may be point to an organization or route in the product application world. When an event or a parameter is changed, the event configs are collected and sent to a ProcessingConfig endpoint in the product application server. They are linked to an organization or route.

The tight coupling of the CRM objects and the product application server may maintain proper mirroring. Credentials for connecting to the product application server are established in the setup process. Each package (“LocatorX for CRM” is the Prod version, “LocatorX Test” is the Dev version) is affiliated with a product application server (CRM Prod or CRM Dev). Since objects may be manipulated in CRM explicitly, implicitly, or manually, Triggers (the CRM implementation of process automation) are used to capture and process mutations to the product application server. These Triggers are defined for each of the custom objects, typically for create and update events. One or more Trigger Handlers process the event mutations.

A typical flow from the CRM application (104) to the product application server (103) when creating an object, using an Organization object as an example:

The user creates a new child Organization in the CRM application (104).
a) This triggers an organization create event, which is handled by a trigger handler.

The Trigger handler creates an Organization payload object using pertinent fields from the object, including the CRM ID of the object.
a) Note that CRM uses strings for their IDs and product application uses UUIDs.
b) The CRM object ID is put into the external ID of the payload.

The payload, the callout info (URL, path, HTTP method), sync method and error handler are packaged into a DataSynchronization object, which is queued for execution.
a) The components assembled are based on the trigger event type.

The execution of the DS object may combine with others of the same event type and are processed in a thread.
a) If a callout is included, the payload is sent to the product application server endpoint for processing.
b) In the case of an organization create event, the organization is created in the product application server, which generates a new product application external ID.

c) On the product application side, the external ID is assigned from the CRM external ID.

d) If there is a parent ID, it is applied in order to maintain the hierarchy.

c) The response of the application server call is returned to Salesforce (SF), which may include an error.

Error handling shows a banner message in SF, if an error exists.

If there is no error, the response is packaged into a payload object.

If a synchronization is part of the DS object, the sync is applied (setting the appropriate fields in the CRM object, such as the externalID).

A similar flow occurs when an update occurs, with the exception of the creation of the object.

A different flow may be used for the ingestion of devices since the ingestions are initiated on the product application server side. Every hour (configurable) the CRM instance makes a call to the product application server (103) looking for “new” devices for that organization. The time_created field and the organization of the device in the system are critical fields. Tracking this ingestion can be done using the Apex History.

Event configuration allows the CRM user to configure which events are of interest to be sent to the CRM application, as well as events that will be used to be promoted to cases. There is an instance-defined set of events, as well as off route params. Those default param sets are applied to each new organization, where they can be modified per organization. The current state of the org event configs is applied to the route as they are created.

### Product Application Process Automation

Delivery of asset event data to the CRM core application may start with a Process Automation (PA) layer and the route-based PA configurations. The LocatorX Setup initiates the authentication tokens and endpoint info that allows the product application to send data to the CRM application.

### Asset Tracking Process Automation

Delivery of asset event data to the CRM core application may start with a PA layer and a route-based PA configuration. A Setup routine may initiate authentication tokens and endpoint info that allows the Asset Tracking application to send data to the CRM application.

### CRM Route Map

In some embodiments, the system provides a route visualization interface within the CRM platform, referred to as the CRM Route Map. The CRM Route Map is configured to display dynamic, geospatial representations of asset movement along defined routes. Each route may be derived from a RoutePlan_c object, instantiated via one or more Route_c records, and rendered using location and scan data received from the product application server (103). The CRM Route Map may embed a React-based map component within a Lightning Web Component (LWC), which receives route parameters, asset identifiers, and organization IDs as query path inputs.

The Route Map interface may display the planned path of travel, actual route taken based on event data, origin and destination markers, and intermediate RouteStop_c points. Each stop may be represented visually with distinct icons and may include tooltips showing timestamps, asset validation results, or deviation alerts. If an asset deviates beyond an allowed tolerance zone defined in the RoutePlan_c or EventConfig_c objects, the map may highlight the deviation and optionally display warning indicators.

The CRM Route Map enables users to monitor asset progress in real time, audit delivery status, verify scan compliance, and initiate route-based interventions if necessary. The interface may be used in administrative panels or embedded in case management workflows. In some embodiments, the map supports historical route playback, enabling investigators or compliance personnel to retrace an asset's path through geotagged scan events.

Integration with the PA layer allows the route map to automatically update as new events are ingested into the CRM system. Additionally, user interactions with the map (e.g., clicking on a stop, filtering by asset ID, or exporting route data) may trigger downstream workflows or reports, contributing to a complete and traceable route lifecycle for each tracked asset.

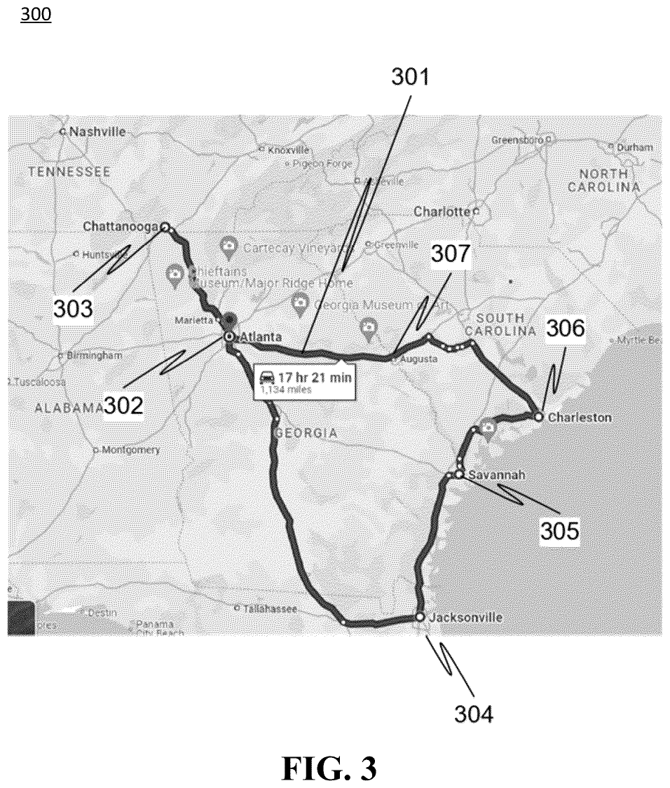

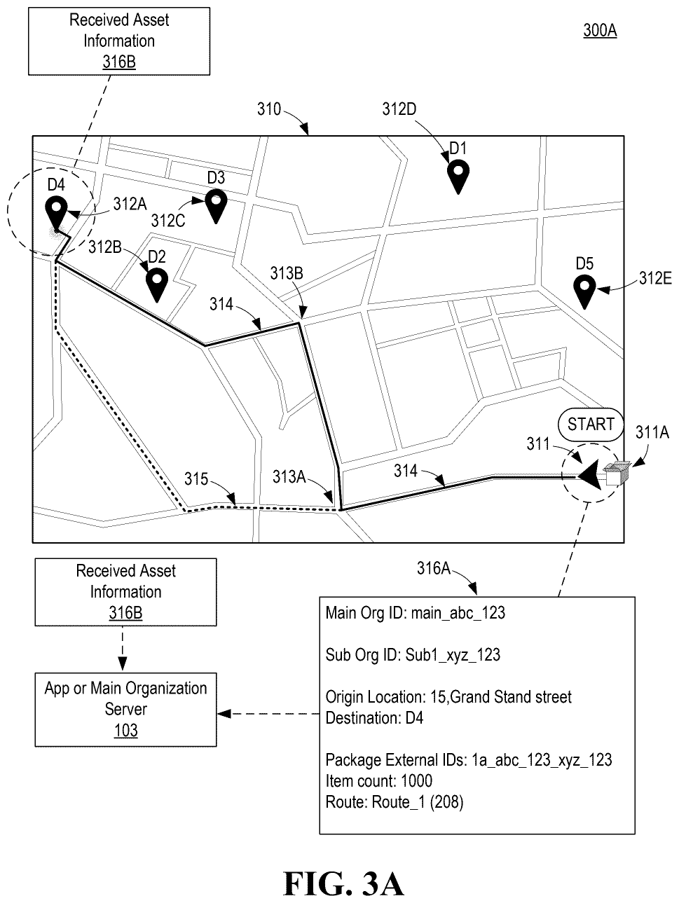

Referring now to FIG. 3, an embodiment of a user-interactive interface 300 is shown for monitoring, visualizing, and auditing the real-time or historical movement of one or more assets, (such as asset 205 shown in FIG. 2), across a predefined route 301. The interface 300 may be implemented as part of a React-based or Lightning Web Component (LWC) embedded within a CRM dashboard, and may be displayed in connection with one or more Route_c or RoutePlan_c records retrieved from the CRM instance. In some embodiments, interface 300 is rendered dynamically using location scan events ingested from the product application server and plotted against a digital map via an embedded mapping service such as Google Maps or Mapbox.

Route 301 represents a planned or optimized delivery or logistics path generated using a RoutePlan_c object. It includes a defined origination point 302 and a sequence of destination points 303, 304, 305, 306, and 307. In some embodiments the destination points 303, 304, 305, 306, and 307 may also be a plurality of registered locations, organizations, or checkpoints along the route 301. Each of these points may correspond to a distinct Facility_c, RouteStop_c, or geofence-enabled location. For example, origination point 302 may represent a central warehouse or fulfillment center located in Atlanta, Georgia, while destination point 304 may correspond to a customer delivery hub located in Jacksonville, Florida. Each stop is associated with predefined expected arrival times, duration of stay, handling instructions, and asset validation criteria.

In some embodiments, a driver or courier carrying one or more tagged assets 205 follows the planned route 301 from the origination point (e.g., 302) through each stop. Scan events, recorded using mobile devices or fixed scanners at each stop, are transmitted to the product application server and mirrored to the CRM system. These events include timestamp, location coordinates, tag ID, and validation results (e.g., QR/NFC/RFID hash match outcomes).

Variation from the planned route 301 may be permitted within a specified tolerance threshold, which may be preconfigured in the RoutePlan_c record or set dynamically per asset or per zone. For example, the system may define a maximum acceptable route deviation of ±5 km from the planned geospatial corridor, or a timing tolerance of ±20 minutes per stop. If an asset deviates outside of this permitted corridor, the system may visually highlight the deviation on the map using alert markers or route color changes. In some embodiments, off-route deviations automatically trigger EventConfig_c actions, such as raising a case, logging a warning, or notifying a route supervisor.

Each destination point (303 through 307) may be labeled using real-time status icons representing the result of the last scan event for that stop. For example, destination 305 (Savannah, GA) may be shown with a green checkmark if the asset scan was successfully validated and recorded within the time window. Destination 306 (Charleston, SC) may display a red exclamation icon if the scan was missed, failed validation, or occurred outside the tolerance threshold.

The interface 300 may also include interactive features such as zooming, filtering by asset ID, replaying route history in chronological order, or selecting a specific route segment to view detailed scan logs. In some embodiments, hovering or clicking on a stop reveals a pop-up or side panel showing detailed metadata: exact scan time, scanned hash, validating device ID, driver information, or photo capture (if available).

Real-time movement of assets may also be tracked using GPS data from tagged devices or from courier mobile applications. These updates are overlaid on the planned route 301 to provide a visual indication of current location, route adherence, or expected time of arrival at the next stop. In cases of multiple assets sharing a route, interface 300 may support grouping, filtering, or toggling visibility of specific tracked items.

Additionally, route 301 may be dynamically recalculated based on traffic, weather, or priority overrides. Such dynamic updates may be initiated through the CRM or external route optimization systems and reflected in the Route_c object, with the new path and stops updated in the route map 301 accordingly.

Interface 300 thus provides a centralized, interactive visual tool for CRM users-such as logistics coordinators, customer service agents, or compliance auditors-to monitor asset journeys, validate delivery compliance, and respond to deviations or exceptions in near real-time. This map-driven visualization tightly integrates with the route, asset, and event configurations defined across the Organization_c and Facility_c schema hierarchy described in connection with FIG. 2.

In some embodiments, a general-purpose React application may support map visualization of assets, routes, and route plans. The visualization of assets, routes and route plans may be built around an automated map platform, such as for example with the Google Maps API, with a call to the Asset Tracking application server for the required data. Each React application instance may be tied to an Asset Tracking application server (Asset Tracking Dev, Asset Tracking Staging, Asset Tracking Prod, CRM Dev, or CRM Prod).

The integration between the CRM application and the route map 301 may be based on a custom LWC component. A visual element (HTML) used to generate the user interactive interface 300 may be based upon an iframe, with a target uniform locator resource (“URL”) that points to the appropriate route map URL (with path params). The “record ID” is passed into the LWC component via the JavaScript linkage. This reference can be an asset, route, or route plan ID. The discrimination is made by having separate LWC components for each object type.

Display of the user interactive interface 300 and interaction of the user interface 300 that includes a route map 301 may be provided by the React application, which gets updates from the Asset Tracking application server. Since the objects are mirrored in both CRM and Asset Tracking systems, the route map can operate without further interaction with CRM.

A Dev Instance in the context of software development, especially in environments like CRM or cloud computing platforms, refers to a development environment or server specifically set up for development purposes. It is a place where developers can write, test, and debug their code without affecting the production environment or other stages of deployment like staging or QA (Quality Assurance).

A resource management component may perform virtualization (e.g., abstraction) of the computing hardware to create the one or more virtual computing systems. Using virtualization, the resource management component enables a single computing device (e.g., a computer, a server, and/or the like) to operate like multiple computing devices, such as by creating multiple isolated virtual computing systems from the computing hardware of the single computing device. In this way, the computing hardware can operate more efficiently, with lower power consumption, higher reliability, higher availability, higher utilization, greater flexibility, and lower cost than using separate computing devices.

The computing hardware includes hardware and corresponding resources from one or more computing devices. For example, the computing hardware may include hardware from a single computing device (e.g., a single server) or from multiple computing devices (e.g., multiple servers), such as multiple computing devices in one or more data centers. The computing hardware may include one or more processors, one or more memories, one or more storages, and/or one or more networking components. Examples of a processor, a memory, a storage, and a networking component (e.g., a communication component) are described elsewhere herein.

The resource management component includes a virtualization application (e.g., executing on hardware, such as the computing hardware) capable of virtualizing the computing hardware to start, stop, and/or manage the one or more virtual computing systems. For example, the resource management component may include a hypervisor (e.g., a bare-metal or Type 4 hypervisor, a hosted or Type 2 hypervisor, and/or the like) or a virtual machine monitor, such as when the virtual computing systems are virtual machines. Additionally, or alternatively, the resource management component may include a container manager, such as when the virtual computing systems are containers. In some implementations, the resource management component executes within and/or in coordination with a host operating system.

A virtual computing system includes a virtual environment that enables cloud-based execution of operations and/or processes described herein using computing hardware. As shown, the virtual computing system may include a virtual machine, a container, a hybrid environment that includes a virtual machine and a container, and/or the like. A virtual computing system may execute one or more applications using a file system that includes binary files, software libraries, and/or other resources required to execute applications on a guest operating system (e.g., within the virtual computing system) or the host operating system.

The network includes one or more wired and/or wireless networks. For example, the network may include a cellular network, a Public Land Mobile Network (PLMN), a Local Area Network (LAN), a Wide Area Network (WAN), a private network, the Internet, and/or the like, and/or a combination of these or other types of networks. The network enables communication among the devices of the system 100A.

Referring again to FIG. 1A, the gateway 109 may be part of a mobile, handheld device (i.e., mobile device), such as a smart phone, a tablet, a wearable computing device (e.g., a smartwatch, a pair of virtual reality or augmented reality glasses), or portable microcomputer and the like. The gateway 109 may include a processor 114, a memory 116, and a display 118.

That is, in an embodiment, the gateway 109 includes one or more devices capable of receiving, generating, storing, processing, and/or providing information, as described elsewhere herein. The gateway 109 may include a communication device and/or a computing device. For example, the gateway 109 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The multimodal tag 111 is attached to an object 124 (e.g., a physical item, an asset, product, or part) that is being tracked, and includes a wireless communication device, such as, by way of non-limiting example, a Near Field Communication (NFC) device 107 that further includes a certified QR (CQR) code label 120 and an external identification (ID) device 122. Other wireless communication devices are also within the scope of other inventions, such as, for example, a Bluetooth, BLE, ultrawideband, random pattern of printed particles, such as nanoparticle inks, or other nonvisible wireless communication modality.

The NFC device is typically a passive device that is embedded in an antenna, and is part of an NFC system, which also includes an NFC reader device 108 (i.e., NFC chip or NFC chipset) and an NFC communication chip. That is, NFC Devices 107 may include RFID transponders that operate at 13.56 MHz. They are tiny chips (integrated circuits) connected to an antenna. The chip has a unique ID and a part of rewritable memory. The antenna allows the chip to interact with an NFC reader device 108. In recent years, NFC Devices 107 have developed to the point where one may write information onto the available memory of an NFC Device 107. This information can be easily read (and executed) by an NFC reader device 108.

The NFC Device 107 may respond to commands from the NFC reader device 108 and may store strings of data. In an embodiment, the NFC Device 107 may include a memory of about 144 bytes that is adapted to store one of an identification of the object, is of an ISO Format of ISO15693, and is one of an NFC-V or a TYPE-5 NFC. Also, the stored data may include an object ID number and an NFC hash.

The NFC reader is a silicon component or integrated circuit (IC) that facilitates short-range, wireless communication between devices. It is the active part of the NFC system that processes information, can read/write data, and sends commands to the NFC Device 107. When connected to the NFC Device 107, the NFC chip enables secure interactions within close proximity (within about 10-20 cm) and may retrieve the string information stored on the NFC Device 107. NFC chips allow devices to exchange data wirelessly when they are near each other. In an embodiment, the NFC chip may be embedded in the gateway 109 (e.g., in a hand-held mobile device).

The NFC communication chip coordinates communication between the NFC reader device 108 and the NFC Device 107.

The NFC Device 107 allows for a low-cost digital representation of the object's digital fingerprint. Unlike CQR codes alone, which can be easily copied via a scanner or a camera and reprinted, NFC Devices 107 may be much more secure. Unlike Bluetooth or other communication methods, NFC does not require a search and pair procedure, which allow for a much faster connection without requiring manual configuration or special software. In an embodiment, the NFC Device 107 may support the ISO 15693 standard, which defines an ability to restrict read and write access and assign passwords for access.

Also, the NFC Device 107 may have capacity to store more than label information about the tag but may also store NFC data required to decrypt the NFC reader device 108 data.

The CQR code label 120 is a specialized 2-dimensional (2D) barcode that can be printed on paper and coupled with the NFC Device 107. In an embodiment, the CQR code label may be directly printed on the NFC Device 107. When scanned by a mobile device, the CQR label provides string information (e.g., a URL) in the form of a qr_hash that allows for access to additional information related to the object, including validation data, or a full document provided on a website. The CQR label enhances document security and may verify the authenticity of the user.

Along with the combined, simultaneous use of the CQR label and the NFC Device 107, the system 100A may function as an intelligent QR (iQR) and provide for two independent validation and verification mechanisms, which results in greater security.

The external ID device 122 may be an additional 2D or 3-dimensional (3D) barcode apart from the above-described CQR label that is coupled to the NFC Device 107. In an embodiment the external ID device may be an RFID that stores from 64-bit to 2 kilobyte of data or an ultra-high-frequency tag. Alternatively, the external ID device may further include a battery to power the external ID device. In this case, more than 100 kilobytes of information may be stored within the external ID device.

Similar to the case with CQR label, when scanned by a mobile device, the external ID may also provide string information (e.g., a URL) in the form of an external ID unique (at the object level) within the organization that is performing the scan that allows for access to additional information related to the object, including validation data, or a full document provided on a website. The external ID may further enhance document security and may verify the authenticity of the user.

That is, the external ID device provides for an alternative two-factor validation route from the CQR label validation, when used with the NFC Device 107. However, when used in conjunction with the CQR label and the NFC Device 107, a more secure three-factor verification process may be achieved.

The database 110 may be adapted to store information (e.g., object information) 126 about the object. The information 126 may be arranged to include two cryptographic data columns that are generated during a Principal Component Analysis (PCA) process. These two columns may include a qr_hash column accessible by a scan of the CQR label, and an nfc_hash column separate from the qr_hash column that may be accessed upon proximate contact (or tap) between the NFC Device 107 and the NFC reader device 108. The creation of the two independent columns allows for two independent validation and verification mechanisms, which, when combined simultaneously, allow for greater security and prevention from counterfeiting of the validation devices.

In an embodiment, the nfc_hash column may store a unique password for each object, along with temporal data including the last cycle count on the NFC reader device 108 or the NFC Device 107 (i.e., how many read/writes).

Referring now to FIG. 3A, an exemplary user interface 300A is depicted, which illustrates a graphical representation of a route map 310 designed to facilitate and document the movement of a package 311A from an origin location 311 through a defined or variable delivery route. In various embodiments, the user interface 300A may be presented via a logistics management platform, CRM interface, or a dedicated route visualization module, and may be implemented as part of a real-time monitoring dashboard accessed by logistics managers, auditors, or verification agents. The route map 310 includes predefined geographic paths, dynamic indicators, and iconographic representations of stops, scans, and asset metadata.

At the outset, the origin location 311 represents the dispatch point for the package 311A. This origin location 311 may refer to a physical facility, such as a central distribution warehouse, corporate headquarters, regional sub-organization, or storage unit affiliated with a main organization. In some embodiments, this origin may correspond to a CRM record of type Organization_c or Facility_c, stored in a CRM instance and mirrored into an external application server (e.g., 103). The visual depiction of the origin 311 in FIG. 3A is accompanied by the representation of the outbound package 311A, which may be comprised of one or more assets, bundled and secured for delivery via a preferred logistics method such as van, truck, drone, or courier personnel.

The package 311A dispatched from the origin 311 is shown to follow a defined route path 314, which connects a plurality of designated waypoints 312A through 312E, each representing a delivery point, customer location, or partner hub. These designation points 312A-312E may correspond to planned delivery stops, where the transported asset(s) are either scanned, verified, handed off, or further routed. In some embodiments, each designation point 312A-312E corresponds to a unique facility record, also mirrored into the application server 103 with an ExternalID_c for synchronization. As shown, the designated destination for the package 311A in this example is destination D4, labeled as 312A.

The package 311A is associated with dispatch details 316A that originate from the CRM or logistics application upon the creation of the shipment object or transport record. Dispatch details 316A may include the main organization ID (e.g., “main_abc_123”), a sub-organization ID representing a unit responsible for preparing the package (e.g., “sub1_xyz_123”), the origin location (“15, Grand Stand Street”), and a destination (e.g., D4). Additionally, the dispatch details 316A may include a unique identifier or a set of external IDs for the package (e.g., “1a_abc_123_xyz_123”), an item count (e.g., 1000), and an assigned route label such as “Route_1 (208)”. In further embodiments, the dispatch information 316A may be extended to include dispatch timestamp, courier ID, expected arrival windows, geofencing thresholds, hash signatures of each tagged item, and predefined validation checkpoints.

The route path 314 depicted in FIG. 3A visually traces the preferred and pre-approved trajectory from the origin 311 to the final designation 312A. This route path 314 is comprised of one or more way segments and may include registered checkpoints 313A and 313B, shown as intermediate validation nodes. These checkpoints may represent ports, security gates, weighbridges, regulatory scanning locations, or distribution drop points where the package 311A is expected to be scanned to log progress. Such checkpoints serve as passive or active validators that mark the continuity and integrity of the route being followed.

Scanning events that occur at checkpoints 313A and 313B may be logged using multimodal readers capable of detecting and verifying QR codes, NFC tags, or other embedded identifiers on the package 311A. Upon scan, the information retrieved from the package 311A—such as tag ID, QR_hash, NFC_hash, timestamp, and scan location—is transmitted to the application server 103. The server 103 then processes this information to evaluate whether the scanned data aligns with the expected route path 314. If the scan location aligns with the planned path and occurs within the expected time window, the application server 103 records a successful validation event.

In some embodiments, the application server 103 evaluates each scanning event to verify adherence to the planned route path 314. The determination of whether the package 311A has followed the designated path may be derived based on scan metadata, including the identity of the scanner, its physical or GPS coordinates, the sequence of scans recorded, and the cumulative travel time. The location of each checkpoint scanner—such as 313A or 313B—may be stored as part of a geospatial registry within the CRM or logistics server. By correlating the scan location with the route metadata, the system confirms conformity or deviation.

In other embodiments, the verification of route adherence may be supplemented with onboard or attached GPS modules embedded into the package 311A or its transport vehicle. Such location tracking technologies may periodically emit geolocation pings that are captured by the application server 103 and mapped onto the stored route path 314. This provides an additional mechanism to verify whether the vehicle or package has deviated from the planned path. The GPS-based validation may be used in real-time or batch analysis and may include polygonal geofence checks around expected corridors.

In cases where the package 311A deviates from the defined route path 314, FIG. 3A also illustrates a second, alternate path labeled as route 315. The second route path 315 may be triggered due to several factors such as traffic diversions, emergency route changes, infrastructure issues, unauthorized rerouting by the carrier, or fraudulent redirection of the shipment. The deviation path 315, while not part of the original plan, may still pass through some previously defined checkpoints or may avoid all validation points entirely, depending on the cause and nature of the deviation.

Upon reaching the final destination 312A (D4), the package 311A is subject to a scanning process as indicated by the received asset information 316B. The scanning at destination D4 is intended to extract final delivery data, such as item count, unique tags of each asset, package hash, timestamp, and scan device ID. This information 316B is transmitted to the application server 103, where it is programmatically compared against the originally stored dispatch information 316A. A structured comparison algorithm evaluates parameters such as package ID, tag authenticity, item count, hash integrity, and destination match.

In some embodiments, the application server 103 is configured to determine whether a transported package 311A has followed a designated route path 314 or deviated into an alternate path 315 by utilizing one or more data points associated with physical scans at predefined checkpoints 313A, 313B or based on location telemetry such as GPS coordinates periodically transmitted from the transport container, transport vehicle, or an associated mobile device. A route path 314 may be initially configured in the CRM system and mirrored to the application server 103, defining a sequence of checkpoints with associated geospatial data and expected time windows. As the package 311A is transported, scanning devices positioned at each checkpoint, such as ports, warehouses, or logistics hubs, scan one or more multimodal tags affixed to the package 311A. The multimodal tag may comprise encoded information such as a unique asset identifier, a cryptographically hashed value (e.g., QR_hash, NFC_hash), a timestamp, and scanning device ID.

Upon each scan at checkpoints 313A, 313B, the scanned data is transmitted to the application server 103, which cross-references the scan metadata against the predefined route path 314. In some embodiments, the server 103 compares the physical coordinates of the scanning device or checkpoint with the expected checkpoint data. If the scan occurs at a location within the allowable geofence of a known checkpoint, and within a defined timing tolerance, the application server 103 logs a valid path segment confirmation. Once multiple such segments are confirmed in sequence, the server determines that the package 311A has followed the planned route path 314.

Alternatively, in some embodiments, the application server 103 monitors the path of the package 311A based on telemetry data originating from GPS devices affixed to the transport unit or vehicle. These devices may transmit location updates at defined intervals or upon triggering events such as stopping, opening a package, or crossing geofenced regions. The application server 103 may reconstruct the actual path taken by plotting these GPS updates on a map interface and overlaying them against the designated route path 314. The degree of conformity may be determined using route-matching algorithms, such as shortest-path deviation, point-in-polygon matching for geofences, or time-delta thresholds.

In embodiments where package 311A deviates from the planned path and follows an alternate route 315, the application server 103 may identify this deviation either due to missing scan records at one or more predefined checkpoints or due to GPS paths not aligning with the expected route. The server 103 may label such deviations as exceptions and trigger alerts or event logs, optionally categorized by cause (e.g., traffic rerouting, unauthorized detour, missing scan).

In some embodiments, the package 311A may experience asset loss during transit. The loss may be detected when the package reaches the final destination 312A (D4) and is subjected to a scanning event that extracts received asset details 316B. This scanned data may include item-level identifiers, tags, and quantities. The application server 103 compares these received details 316B against the originally recorded dispatch details 316A, which include an expected asset count, identifiers, and hashes. If the received asset count is lower than the expected value, the server identifies a discrepancy and logs it as an asset loss event. The server 103 may then analyze scan histories along the checkpoints 313A, 313B to determine where the loss occurred, such as by identifying the last point where the asset was confirmed and the first point where it was missing.

In some embodiments, loss location tracing may be further supported by analyzing checkpoint-specific scan logs. For example, if at checkpoint 313A all 1000 items were scanned and validated, but at checkpoint 313B only 950 were found, the application server 103 may determine that the loss occurred between 313A and 313B. If the GPS logs show an unplanned stop in that segment, the server 103 may further flag that point as a suspect loss location. A recovery process may be initiated, such as alerting ground staff near the loss location, triggering investigation requests, or activating route retrace for the vehicle.

In other embodiments, fraudulent insertion of pirated or duplicate assets into package 311A may be attempted during transit. Such pirated assets may be physically indistinguishable from legitimate ones but fail cryptographic validation. During destination scanning or intermediate checkpoint validation, each asset's tag is read, and the QR_hash and/or NFC_hash is transmitted to the server 103. The application server 103 maintains a hash registry of valid assets under the shipment. When a scanned asset returns a hash not registered in the original dispatch set, the system identifies it as an unauthorized addition. For example, if item ID “X123” was not in the initial set but appears during final scan, and its QR_hash does not match any entry in the trusted dispatch data, it is flagged.

In some embodiments, pirated assets may reuse legitimate QR codes, but due to lack of a matching NFC hash or because of altered tamper-proof hardware signatures, a mismatch is identified. The server 103 may run a validation routine comparing both QR_hash and NFC_hash in combination and may use additional features such as scan device ID, time, and geolocation to further confirm integrity. Upon detecting such mismatches, the system may isolate the asset as compromised and update the shipment integrity status.

Additionally, in some implementations, the system may use machine learning algorithms at the server 103 to detect patterns indicating fraudulent behavior or tampering, such as repeated deviations on similar routes, frequent mismatches from certain checkpoints, or excessive scan delays. The system may dynamically adjust the risk profile for shipments or apply enhanced validation to assets routed through suspect zones.

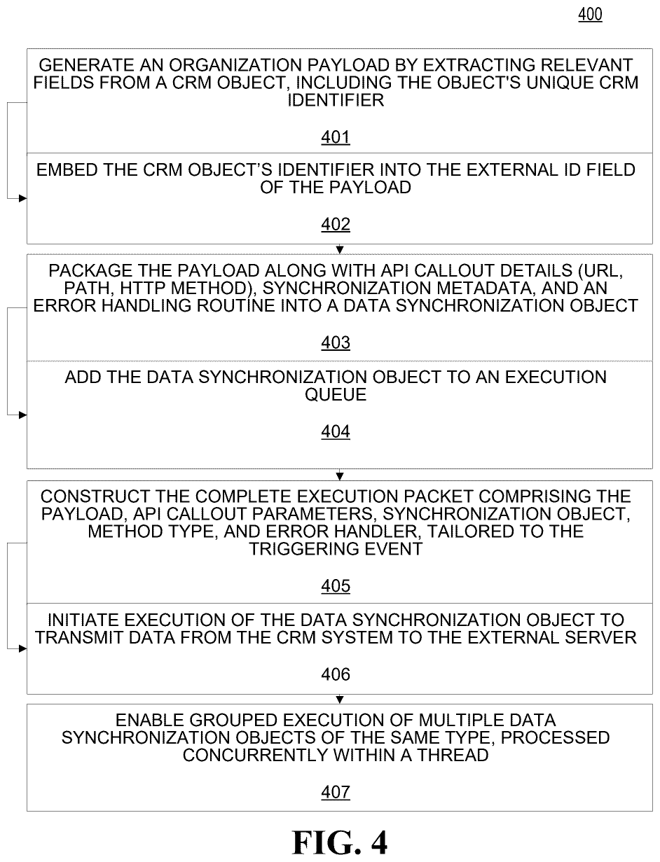

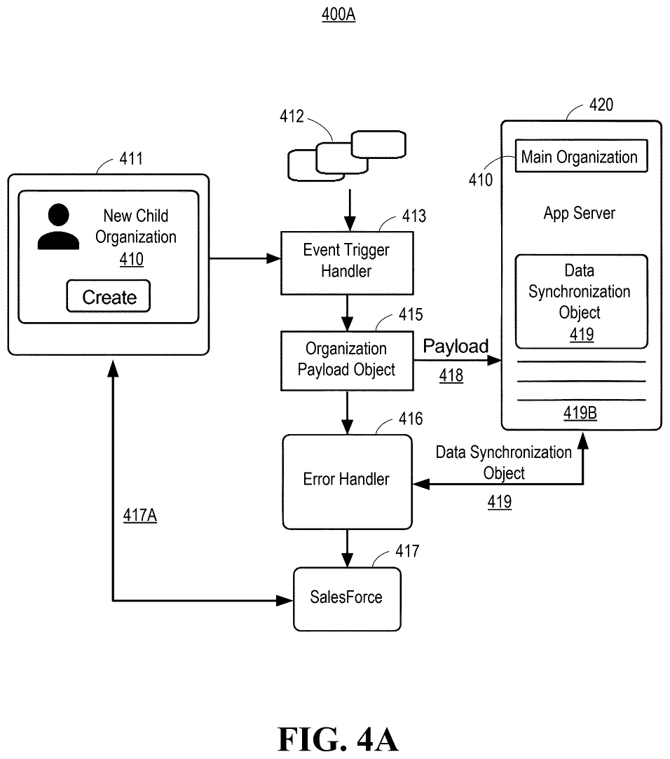

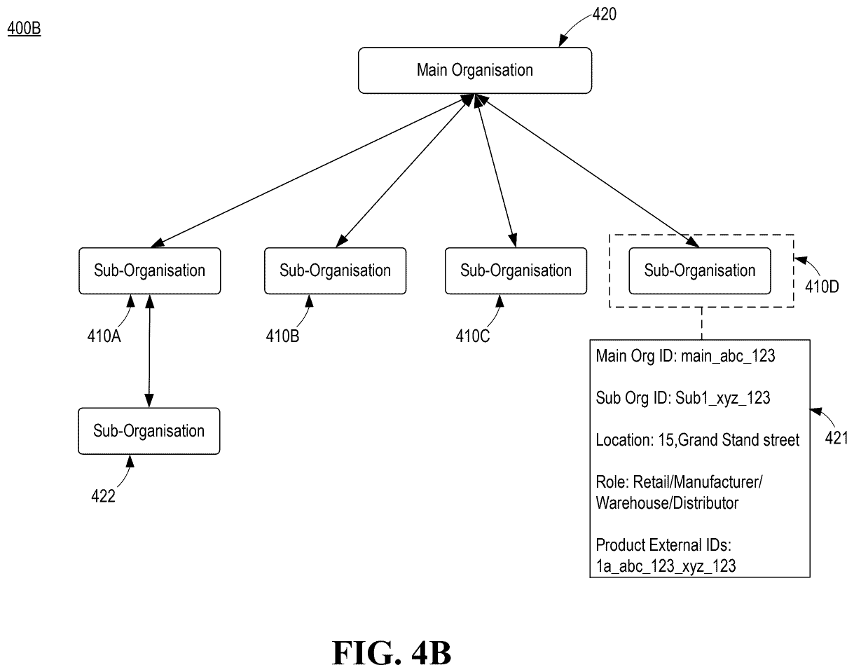

Referring now to FIG. 4, a process flow 400 is illustrated that depicts a structured and automated method of transmitting data from a Customer Relationship Management (CRM) system to an external product application server through the construction and execution of one or more Data Synchronization Objects (DSOs). The process shown in FIG. 4 includes multiple sequential steps beginning with CRM data extraction and ending in concurrent, thread-based execution of synchronization objects. Each block in this diagram is functionally independent, yet contributes collectively to the robust and scalable synchronization architecture.

At step 401, the process begins with the generation of an organization payload by extracting relevant fields from a CRM object, which includes the object's unique CRM identifier. The CRM object may be any record that represents an entity within the CRM system, such as an Organization_c, Facility_c, TrackableAsset_c, or RoutePlan_c. The payload generated in this step comprises selected data fields that are deemed suitable for synchronization with the external system. In some embodiments, this payload is structured as a JSON object or XML block that includes both metadata and user-defined fields, such as organization name, address, operational zone, or classification tags. The unique CRM identifier associated with the object may be a Salesforce Record ID, which follows a string format such as “001XXXXXXXXXXXXXXX” and serves as the primary source of truth within the CRM instance. The payload generation process may be governed by a trigger handler or platform event listener that listens for create, update, or merge events on predefined object types. In further embodiments, field mapping logic may be applied to transform internal field names into external representations suitable for the product application server schema.

At step 402, the CRM object's identifier, such as the Record ID or system-generated reference string, is embedded into the external ID field of the generated payload. This embedding process facilitates future traceability and synchronization correlation between the CRM record and its mirrored counterpart on the product application server. The external ID field is often a UUID-compatible string within the target external system, and embedding the CRM identifier enables bidirectional linking. For example, when a product application server responds to a later update or query, it can return this external ID, which the CRM application then maps back to the original record. In some embodiments, the embedding process may also include concatenation with namespace tags, version identifiers, or other prefix-suffix logic to prevent collision across different organizations or deployments. If multiple payloads are created in parallel, each may have a composite external ID that includes both the CRM identifier and a timestamp to assist in audit trail reconstruction. This external ID field is stored within the data synchronization structure to support downstream validation and verification steps.

At step 403, the payload constructed in step 401 and tagged in step 402 is packaged into a Data Synchronization Object (DSO), along with relevant API callout details. These callout details include the API endpoint URL, the request path, the HTTP method type (e.g., POST, PUT, PATCH), synchronization metadata, and an error handling routine. The DSO may be an internal CRM class, such as a custom Apex object or data structure, or a generalized container that encapsulates all necessary parameters to initiate a synchronization action. Synchronization metadata may include timestamps, triggering event types, schema versioning information, retry configuration settings, and destination object type mappings. The error handling routine may point to a fallback function or a failure queue where unsuccessful transactions are logged for later analysis. For example, if the API call returns a 500-series error or a timeout, the DSO can flag itself as failed and either raise an alert in the UI or submit itself for retry after a fixed interval. This packaging step transforms the raw payload into a fully structured object ready for queued execution.

At step 404, the constructed DSO is added to a designated execution queue. This queue may be implemented within the CRM application layer using native asynchronous processing mechanisms such as Apex Queueables, Platform Events, or Scheduled Jobs. Alternatively, the queue may reside in a middleware service that aggregates multiple DSO entries and submits them to the external product application server in batches. The act of queuing introduces scalability and decouples the data preparation logic from the actual network transmission logic. In some embodiments, multiple DSOs representing different object types—e.g., Organization_c, Facility_c, RouteStop_c—are assigned to separate queues based on object hierarchy, priority, or synchronization frequency. Queuing also allows for dependency resolution. For example, if an Organization_c must be created before a Facility_c can be mirrored, their respective DSOs can be ordered accordingly in the queue. In further embodiments, queue metadata may include execution attempt counters, priority levels, and time-out deadlines.

At step 405, the system constructs a complete execution packet that comprises the payload, API callout parameters, synchronization object, method type, and error handler, all tailored to the triggering event. The triggering event may be a database-level change such as INSERT, UPDATE, DELETE, or a user-initiated action such as “Mark as Ready for Sync.” The execution packet is the final in-memory structure that contains every necessary input required by the external synchronization engine. For example, the API callout parameters may include HTTP headers like authorization tokens, content type declarations, and tenant-specific routing information. The method type determines how the data will be interpreted on the external server: a POST may create a new object, a PUT may replace an existing one, and a PATCH may selectively update fields. The execution packet may also include a context object with audit details, such as the user ID who triggered the event, the time of the original CRM transaction, and a transaction hash for integrity verification.

At step 406, the system initiates execution of the constructed Data Synchronization Object to transmit data from the CRM system to the external product application server. This transmission may take place over HTTPS using RESTful API calls, SOAP calls, or through intermediary message brokers such as RabbitMQ or AWS SQS, depending on system design. In some embodiments, the execution occurs within an asynchronous batch context, allowing hundreds or thousands of DSOs to be executed without exceeding CRM API governor limits. The transmitted data includes the organization payload, header metadata, and any validation token needed by the external server to accept the data. Upon successful submission, the product application server returns a response object, which may contain a confirmation status, a newly generated UUID, or an error message. This response is captured and stored in the DSO object or logged for downstream reconciliation. The system may also timestamp the execution and update the associated CRM record to reflect its synced state and external system ID.

At step 407, the system enables grouped execution of multiple DSOs of the same event type, allowing them to be processed concurrently within a shared thread or batch session. This capability supports both parallelization and throughput optimization. For example, if 50 child Organization_c objects are created simultaneously, their corresponding DSOs can be grouped and processed in a single job, reducing API overhead and improving synchronization consistency. Grouped execution also permits shared error handling logic, such as rerouting the entire batch if authentication fails. In some embodiments, the grouping logic uses hash-based bucketing or timestamp-based batching. This step also supports retry logic at the batch level—if a batch fails partially, only the failed DSOs are retried. By isolating DSOs based on triggering event types, object schemas, or destination endpoints, the system maintains clean separation between unrelated workflows and avoids cross-contamination of state between objects.

Referring now to FIG. 4A, an exemplary embodiment of a system 400A is illustrated that facilitates the creation, packaging, and processing of a new child organization 410 within a CRM environment, with synchronization to an external server 103 representing a main or parent organization 420. The illustrated system includes a user interface 411, which may be implemented as a web-based portal or application used by administrators or authorized users to initiate the creation of a new child organization 410 within the CRM system. The user interface 411 includes a graphical input component labeled “Create,” which, when selected, initiates a backend event-driven process architecture.

At the onset, upon selection of the “Create” button within the interface 411, the system generates an internal creation event that is passed to an event trigger handler 413. The event trigger handler 413 may comprise software logic or a rule-based automation script configured to monitor CRM object creation activities. The trigger handler 413 may detect creation of a new instance of the organization object (e.g., Organization_c), extract the relevant metadata such as timestamps, user credentials, organizational role hierarchy, and relational context, and pass this metadata downstream for further processing.

The system 400A also shows a plurality of assets 412, which may represent software modules, plugins, user accounts, third-party extensions, or organizational dependencies associated with the new child organization 410. The presence of these assets 412 in the system may trigger additional validations or conditional logic flows within the trigger handler 413. For example, if a created organization 410 is linked to a jurisdiction with specialized compliance regulations, the handler 413 may flag the payload generation for special annotation.

The event trigger handler 413 forwards the processed organizational metadata to an intermediate object called the organization payload object 415. The organization payload object 415 is instantiated to encapsulate structured information regarding the new child organization 410. This includes, but is not limited to, the CRM object identifier (e.g., Salesforce ID), parent organization references, naming conventions, assigned permissions, and business classification tags. This payload may be serialized in JSON, XML, or a custom binary format depending on the communication protocol supported by the external application server 103.

Once the organization payload object 415 is generated, the system prepares a data synchronization object 419 for outbound transfer. In some embodiments, the organization payload 418 is packaged together with API callout configuration details such as endpoint URLs, HTTP method types (e.g., POST, PUT), headers, and security tokens. These callout parameters may be dynamically selected based on the nature of the triggering event detected by handler 413 and incorporated into the full payload structure transmitted to application server 103.

The system further incorporates an error handler module 416, which validates the contents of the organization payload object 415 before initiating outbound communication. The error handler 416 may inspect structural schema consistency, mandatory field inclusion, field length constraints, and cross-object dependencies. If any discrepancies or violations are detected, the error handler 416 may generate an internal fault report and halt propagation to the external server. The user may then be notified through the interface 411 via error response path 417A.

If the payload 418 passes validation by the error handler 416, the system proceeds to push the data synchronization object 419 to the application server 103. The application server 103 may be part of a larger enterprise integration hub, tasked with maintaining mirroring integrity between CRM-originated entities and operational backend systems. The application server 103 includes logic to ingest the payload, authenticate the transmission, and instantiate a corresponding child organization record within the database structure of the main organization 420.

Once the data synchronization object 419 is received by the application server 103, it may be enqueued in a processing queue 419B. The queue 419B may contain multiple synchronization objects of the same or differing types, including but not limited to organizational creation, update, deletion, or reassignment events. The queue processor may apply thread-based or priority-based scheduling algorithms to optimize synchronization timing, minimize race conditions, and reduce API throttling impact.

During execution of the data synchronization object 419, the application server 103 may assign a unique identifier to the newly created child organization record in the external system. This identifier may be mapped back to the originating CRM object via an ExternalID_c field, preserving referential integrity. Additionally, relationship hierarchies may be maintained through inclusion of a parent organization identifier received from the payload 418.

Following successful execution, a confirmation response may be transmitted back to the CRM instance 417. The confirmation message may include the external server-generated ID, processing timestamp, result code, and optionally a processing log. This response may be logged by the Salesforce instance 417 and presented to the user via interface 411 to confirm successful registration of the new child organization 410.

In some implementations, if an error is encountered at the external server 103 during execution of the synchronization object 419, such as a schema mismatch or connectivity failure, the error handler 416 may capture the fault and display it within the Salesforce interface 411 via a banner alert or modal window through notification path 417A. The system may allow resubmission after correction or allow an administrator to override certain non-blocking constraints.

The organization payload object 415 may also include optional metadata related to organizational attributes such as jurisdiction, industry code, compliance level, and service package tier. This enables the application server 103 to classify and route the newly created organization record to the appropriate downstream modules or business units. For example, an organization registered under a healthcare industry code may be linked with HIPAA-compliant infrastructure on the application server.

Alternative embodiments may allow the user to initiate creation of the new child organization 410 via an API call rather than the GUI-based interface 411. In such cases, the payload may be programmatically constructed using software development kits (SDKs) or command-line tools. The process flow thereafter would follow the same path through the event trigger handler 413, payload generator 415, error handler 416, and outbound transfer to the application server 103.

In another embodiment, the error handler 416 may be implemented as a chained validator module comprising discrete logic gates, each responsible for inspecting a different dimension of the payload. These validators may operate asynchronously or in sequence and may be configured to escalate faults based on priority or sensitivity. For example, a missing parentOrgID may be considered a hard fault while a missing optional address field may be downgraded to a warning.

The payload 418 transmitted to the external server 103 may optionally include audit metadata such as creation user, originating IP address, device fingerprint, and action source (GUI/API). These attributes may be logged by the server 103 for traceability, audit trail maintenance, and forensic analysis in the event of data discrepancies or user disputes.

The data synchronization object 419 may also include version identifiers that reflect the schema or protocol version used for packaging the payload. The server 103 may use this version data to route the object to the appropriate version-aware handler within the backend system, maintaining backward compatibility across diverse client environments.

In some embodiments, the queue 419B may be implemented as a distributed message queue (e.g., AWS SQS, Apache Kafka) that decouples the CRM system from the application server 103. This design enables resilience to server downtimes, throttling events, or network latency. The queue processor may include retry logic, dead-letter queues, and rollback mechanisms in case of processing failures.

As the queue 419B accumulates data synchronization objects 419, it may include logic to prioritize certain synchronization types or time-sensitive payloads. For example, creation of a child organization related to a time-bound project or procurement process may be escalated for immediate processing, while less critical updates may be scheduled during low-load periods to conserve resources and maintain application responsiveness.

In some embodiments, once the child organization 410 has been registered within the application server 103, the system may initiate one or more post-synchronization activities, such as provisioning default roles, permissions, or configuration templates based on the organization's type or vertical. These may include loading prebuilt CRM dashboards, compliance workflows, or associating the child organization with default datasets curated for the relevant market segment.

The application server 103 may also initiate registration of the newly created child organization 410 into other external systems that form part of a larger enterprise infrastructure. These systems may include an inventory management platform, financial reconciliation engine, or service ticketing system, each requiring the same or a derived payload from the data synchronization object 419. In such embodiments, the application server 103 acts as a central hub for cascading registration actions based on the initial CRM trigger.

Referring again to FIG. 4A, the confirmation or error data received back from the application server 103 may be written into a log accessible through the Salesforce instance 417. This log may store detailed entries corresponding to each synchronization event, including the payload content, timestamps, synchronization status, returned identifiers, and fault codes. Such logging provides administrators or developers with a searchable history to diagnose failures or confirm successful transactions.

Embodiments of system 400A may support real-time notifications of synchronization status back to the user interface 411 via communication channel 417A. These notifications may be presented in various formats, such as on-screen banners, notification badges, modal dialogs, or triggered emails/SMS depending on user preferences and platform capabilities. Such feedback mechanisms contribute to transparency and real-time visibility into system actions.

In a scenario where multiple child organizations 410 are created in parallel by different users or automated processes, the system may initiate parallel flows for each instance, generating distinct organization payload objects 415, processing them through dedicated error handlers 416, and queuing corresponding synchronization objects 419. These parallel processes may be coordinated via thread-safe queuing mechanisms and batch execution models to maintain integrity and scalability.

Some embodiments may also include an administrative dashboard within the CRM interface 411, offering visualizations and metrics on all synchronization events handled by the system 400A. Such dashboards may track success rates, queue sizes, processing times, error frequencies, and trends across organizations. Administrators may be able to drill down into individual records to examine payload structures, review application server responses, and take manual action if needed.

In another variant, the organization payload object 415 may include references to associated sub-entities such as facilities, routes, tags, or assets related to the new child organization 410. When transmitted to the application server 103, these associations may be registered together in a single multi-entity synchronization transaction, reducing latency and avoiding partial registration states.

Referring to the application server 103, the synchronization logic may be backed by a modular service-oriented architecture. Different types of synchronization objects 419 (e.g., organization creation, asset ingestion, route registration) may be handled by specialized microservices. This allows for cleaner separation of responsibilities, easier deployment of updates, and more granular scalability across high-volume domains.

Each synchronization object 419 may include a transaction ID or session token that links all system actions related to the original event (e.g., creation of a child organization 410) under a single traceable identifier. Such grouping may facilitate rollback operations, coordinated audits, or downstream reporting based on user-initiated events.

In some embodiments, Salesforce instance 417 may be configured to delay user confirmation via interface 411 until a round-trip acknowledgment has been received from application server 103 confirming successful registration of the child organization 410. This approach offers a tightly synchronized user experience, although some deployments may opt for asynchronous confirmation to improve responsiveness.

In deployments involving multiple application servers or multi-region data centers, the system 400A may be configured to dynamically select the destination server 103 based on attributes within the organization payload object 415. For example, geographic location, business unit, or deployment tier may dictate which instance of the application server is the target for that synchronization object 419.

The data synchronization object 419 transmitted to the application server 103 may be wrapped with additional encryption protocols (e.g., TLS, AES) or secure tunnels (e.g., VPN) to meet data privacy regulations. In cases involving sensitive organizational data (e.g., government agencies, healthcare providers), compliance with standards such as SOC 2 or HIPAA may govern the format and handling of such payloads.

The application server 103 may include a policy engine that reviews incoming payload 418 for compliance with enterprise configuration standards before allowing registration of the child organization 410. Such policies may include field format rules, duplication checks, and preconfigured validation scripts. In case of non-compliance, a standardized fault code may be returned and logged by error handler 416.

Alternate workflows may exist where the event trigger handler 413 is replaced or supplemented with a polling mechanism that periodically checks for new CRM object creation events. Such architecture may be suitable for systems that do not support native triggers or where API callout restrictions are in place.

Still referring to FIG. 4A, the graphical user interface 411 may incorporate a preview or confirmation panel that allows users to review the inferred payload 418 before submission. This preview may include computed relationships, suggested default values, and editable optional fields to refine the registration process prior to triggering synchronization.

In embodiments involving batch organization creation, the interface 411 may allow CSV or JSON uploads containing data for multiple child organizations 410. The uploaded data may be parsed and processed sequentially or in parallel, each row generating a separate organization payload object 415 and resulting synchronization object 419.

System 400A may also support retry mechanisms that automatically reattempt synchronization upon transient errors detected at the error handler 416 or reported by the application server 103. Retry behavior may be governed by configurable thresholds for maximum attempts, back-off intervals, and escalation rules.

Advanced embodiments may support rollback mechanisms where, if a synchronization object 419 fails irrecoverably at the application server 103, a reversal transaction is triggered within the Salesforce instance 417 to delete or deactivate the child organization 410. Such functionality prevents orphaned data or mismatched records between CRM and backend systems.

The synchronization process described in FIG. 4A may be monitored and orchestrated by a centralized control service or agent that watches the health, performance, and synchronization frequency across all users and organizations within the enterprise. Alerts or dashboards may reflect the current status and queue length of synchronization objects 419B.

In some embodiments, the system described in FIG. 4A may support automated creation of a new child organization 410 within a CRM platform interface 411 upon detection of a qualifying event such as the scanning of genuine assets 412 using a defined CRM application (e.g., 104). In such embodiments, the CRM application 104 may be configured with logic to recognize asset-level scan interactions associated with a previously unregistered entity. The scan may be performed using any compatible interface, including but not limited to a mobile application, handheld scanning terminal, or browser-based UI rendered through interface 411.

The assets 412 scanned during the interaction may be encoded with one or more multimodal tags including data such as QR_hash, NFC_hash, or externally maintained identifiers. The scanning action may invoke a verification procedure that checks the scanned asset identifiers against a canonical registry hosted on the application server 103. If a match is found and the assets 412 are verified as genuine (i.e., corresponding to legitimate asset entries provisioned by the main organization 420), the system may trigger an automatic initiation of a new organization creation event.

In such embodiments, the event may originate not from a manual “Create” button in interface 411, but from an underlying system trigger handler 413 configured to listen for valid scan events from the CRM application 104. The trigger handler 413 may capture the scanning context, including asset ID, timestamp, GPS coordinates (if available), user device ID, and any organizational metadata inferred from the scanning session. This information may then be passed to a dynamic payload generator which constructs an organization payload object 415 encapsulating the inferred organizational profile.

The organization payload object 415 in this automated flow may include default values or derived entries for required fields such as organization name, inferred location, default role assignment, and reference to the scanning entity. In embodiments where the scanning user is linked to a distributor, retailer, or vendor entity under the hierarchy of the main organization 420, the system may assign the parent-child relationship implicitly based on the scanning metadata.

The constructed organization payload 418 may be passed through an error handler 416 for schema validation and optionally flagged with a provisional status depending on business rules. If the assets 412 scanned are validated as genuine, the error handler 416 may allow the data synchronization object 419 to be queued and dispatched to the application server 103 via queue 419B for final registration and mirroring within the backend enterprise environment.

In some embodiments, the approval process for activating or finalizing registration of such new child organizations 410 may be conditional upon the origin of the scanning. For example, if the scan is initiated by an authorized distributor or a known vendor channel previously authenticated by the main organization 420, the system may allow for automatic approval and registration. Conversely, if the scan originates from an unverified party or if the assets 412 are detected as pirated—determined by comparing hash mismatches (e.g., mismatched QR_hash or NFC_hash against server 103 data)—the process may be halted and flagged for review or rejection.

In further embodiments, approval from the main organization 420 may be mandated regardless of scan origin. In such cases, after the organization payload object 415 is validated and packaged into synchronization object 419, a hold status may be assigned, and a notification sent to interface 411 of the administrative user at the main organization 420. That user may review the request, inspect scan logs, and approve or reject the creation of the child organization 410 based on internal criteria.

The system 400A may also be configured to apply additional filtering logic, such as rejecting scans initiated outside authorized geofences, or identifying repetitive scan patterns indicative of fraudulent behavior. If flagged, the event may be forwarded to a security review queue rather than the data synchronization queue 419B.

Alternative methods of initiating the child organization creation may also be supported. For example, an organization identifier may be encoded within the multimodal asset tags, and during the first scan of assets 412 by a new entity, that identifier may be extracted and mapped to a provisional child organization 410 structure in the CRM. The payload 415 generated in such a flow may contain trace elements linking the organization to the original asset lineage and issuer.

Another alternative method may rely on time-bound scanning logic, where the system detects recurring scan activity from an unknown source over a defined threshold (e.g., more than 50 valid scans in 48 hours), and uses that pattern as a trigger for automated organization registration. This method may be useful in deployment environments where manual pre-registration is impractical or delayed.

Additionally, the system 400A may incorporate machine learning models deployed on the application server 103 to predict whether a new scanning entity is likely to represent a legitimate sub-organization. Features such as scanning frequency, device signature, IP address clustering, asset category, and prior approval rates may be used as inputs to generate a confidence score. Based on this score, automated workflows may proceed, escalate, or block creation of the child organization 410.

In some embodiments, the present invention provides systems, methods, and apparatuses for initiating, managing, and synchronizing the registration of new child organizations under a parent organization through a Customer Relationship Management (CRM) platform (e.g., 411), in conjunction with a centralized application server 420. In some embodiments, the process begins with a user interacting with a CRM-based interface to create a new child organization record. This organization may represent an entity such as a retailer, logistics handler, manufacturing unit, or distributor that is intended to operate under the oversight of a parent organization within a broader supply chain network.

Once initiated, the CRM system (400A) generates an organization payload object which serves as the digital representation of the child organization to be registered. The payload object comprises several parameters necessary for uniquely identifying and mapping the child organization within the ecosystem. These parameters may include a unique CRM object ID (e.g., a system-generated alphanumeric key), the name of the organization (e.g., “XYZ Retail Pvt Ltd”), a reference to the parent organization ID, a geographic location identifier (e.g., postal address or GPS coordinates), and organizational metadata such as creation timestamp, industry type, or operating license ID. The location identifier can include a latitude-longitude pair, city-level identifiers, or a geofence configuration that may later be used to validate scans or deliveries.

The organization payload object may further include an external identifier field, which acts as a persistent reference to link the CRM object to its corresponding entity on the application server. This external identifier may be in UUID format, and may be generated either by the CRM or assigned by the application server upon successful registration. This enables bidirectional synchronization and future reference when scan data or asset movement needs to be associated with a given child organization.

In some embodiments, the payload object contains specific fields indicating the organizational role of the child entity, such as whether it is a distributor, retailer, logistics handler, or manufacturing unit. These classifications may drive logic on the application server, such as setting permissions for scan access, asset handling authority, or route participation rights. For example, a manufacturing unit may be permitted to generate asset QR codes, while a logistics handler may be allowed to perform intermediate scans without triggering ownership transfer.

Once the payload object is fully assembled, it is combined with a callout information object, which comprises parameters required for remote API invocation to the application server. This callout object includes fields such as a destination URL (e.g., https://api.appserver.com/orgs/create), the API path (e.g.,/orgs/create), the HTTP method (e.g., POST or PUT), and the content-type header (e.g., application/json). The full payload and callout information are assembled into a Data Synchronization Object (DSO)-a composite object used by the CRM system to queue, track, and execute synchronization requests to the application server.

The DSO may further comprise a synchronization flag indicating the type of operation to be performed at the application server. This flag may hold values such as “CREATE,” “UPDATE,” or “DELETE,” depending on the intent of the transaction. For example, creating a new logistics partner would use the “CREATE” flag, while updating address information for an existing retailer might invoke the “UPDATE” flag. This field allows the application server to perform appropriate operations on the mirrored object database.

Additionally, the DSO includes an error handler module designed to capture, process, and respond to synchronization issues. This module may log error messages with codes, timestamps, and descriptive texts into a CRM-side audit log, display alert banners in the CRM UI for administrative users, and optionally trigger retry logic according to preconfigured policies (e.g., exponential backoff with 3 retries within 10 minutes). Errors such as timeouts, 400-series client errors, or 500-series server errors may be categorized and acted upon differently.

Once the DSO is fully prepared, it is placed into a queued execution list maintained by the application server or by a middleware synchronization service. The queue may operate as a first-in-first-out (FIFO) scheduler or may prioritize operations based on criticality or timestamp. For example, child organization creation events may be prioritized higher than contact information updates.

Upon its turn in the queue, the execution engine invokes the callout using the parameters in the DSO. The payload is sent to the application server via a secure HTTPS connection. The application server receives, processes, and returns a response, which may include a newly assigned external ID, indicating the organization has been successfully registered, or an error response detailing reasons for failure. If successful, the CRM system stores the returned external ID back into the CRM record for the child organization, establishing a synchronized link.

This entire process is designed to be programmatically triggered, allowing both manual creation by an administrative user and automated creation triggered by scanning of authenticated assets at new locations (as described in other embodiments). For example, if a verified asset is scanned at an unknown organization with valid permissions and scanned via the official CRM application, a trigger handler may automatically generate a child organization record, validate it via application server, and establish it within the supply chain tree.

These mechanisms contribute toward a secure and scalable method for registering supply chain participants, validating their legitimacy, and ensuring the integrity of asset tracking operations. Such structures allow enterprises to rapidly onboard and monitor partners, trace asset journeys accurately, and minimize the risk of asset misuse, diversion, or piracy within decentralized or dynamic supply networks.

Referring now to FIG. 4B, an exemplary system 400B is depicted, wherein a hierarchical relationship is established between a main organization 420 and multiple sub-organizations 410A, 410B, 410C, and 410D. In some embodiments, the main organization 420 may refer to an enterprise entity such as a corporate headquarters, a centralized manufacturer, a parent company, or a logistics aggregator platform responsible for onboarding, managing, and supervising a network of subsidiary or related operational units. For example, the main organization 420 may be a pharmaceutical manufacturer overseeing a network of regional distributors, retailers, warehouse depots, or regulatory compliance centers functioning under discrete operational roles. The structure illustrated in system 400B enables a logically organized and validated method of tracking data, roles, and transactions across the organization hierarchy.

In the embodiment shown, each sub-organization 410A through 410D is communicatively or logically affiliated with the main organization 420 and is granted an operable relationship that permits data exchange, asset transfers, and role-based management between entities. The sub-organizations may be programmatically created within a CRM application interface or may be manually entered and validated using a configuration interface. A typical sub-organization, such as 410A or 410B, may represent a retailer in a distribution network, a sub-assembly unit in a manufacturing chain, a warehouse location where physical assets are stored, or a regional customer-facing outlet with localized responsibilities. For example, sub-organization 410C may function as a cold-storage unit for perishable goods and may interact with IoT sensors or asset tracking systems specific to its operational domain.

According to the system 400B, a unique sub-organization 410D is illustrated as a prospective or newly-added sub-entity, which may undergo validation, synchronization, and role assignment before becoming an active node in the hierarchy. Sub-organization 410D is illustrated using dashed boundaries to signify that it may be in a provisional or onboarding state. In some embodiments, the process of adding sub-organization 410D is initiated via user interaction with a CRM platform (such as interface 411 shown in FIG. 4A), which collects metadata including organizational role, location, parent organization reference, and unique sub-organization identifiers. Such metadata may then be assembled into a payload that is transmitted to an application server 103 (shown in prior figures) where it is queued and processed.

Each sub-organization 410A-410D may be assigned a unique identifier string that is programmatically generated based on one or more contextual variables, including but not limited to, the name or code of the main organization 420, geographic location codes, creation date, operational role type, and internal hash tokens used to prevent collisions across organizations. As seen in the sub-organization data 421 associated with sub-organization 410D, such identifiers may comprise a prefix corresponding to the main organization (e.g., main_abc_123) and a suffix or infix representing the sub-entity (e.g., Sub1_xyz_123). The unified structure allows traceability of asset and role metadata to its originating entity.

Further referring to the data structure 421 in FIG. 4B, the sub-organization profile may include additional fields such as physical address (e.g., “15, Grand Stand street”), operational role designation (e.g., Retail, Manufacturer, Warehouse, Distributor), and one or more external product or asset identifiers, such as 1a_abc_123_xyz_123, which links the sub-organization to specific product batches or asset entries created or owned by the main organization 420. This linking facilitates authentication of all actions or events associated with the sub-organization and provides a seamless audit trail.

In some embodiments, each asset handled by the sub-organization 410A-410D may carry a product external ID, encoded via scannable media such as QR codes, NFC tags, RFID tags, or other unique encoding technologies. Upon scanning by an external system or during internal processing, these identifiers may trigger a callout to a centralized application server 103 or cloud-hosted backend which performs lookup validation based on the ID prefix and confirms ownership, assignment, or authenticity of the product. For example, if an asset handled by sub-organization 410A is scanned and its prefix maps to the main organization 420, then the authenticity is confirmed. In contrast, if a mismatch or collision occurs (e.g., invalid prefix or unknown suffix), the system may flag the asset as suspicious or pirated.

In some embodiments, the main organization 420 may define configurable rules or conditional workflows which determine the approval pathway, access rights, and data synchronization cadence for each of the associated sub-organizations. These rules may include role-based access policies, approval requirements, reporting thresholds, asset count limits, and synchronization windows. For example, a sub-organization acting as a distributor (e.g., 410B) may have permission to generate additional downstream sub-organizations (e.g., 422), subject to validation via payload matching and/or approval from the main organization 420.

Sub-organization 422 is illustrated as a child node under sub-organization 410A, representing an extended hierarchy within the system 400B. In such arrangements, the CRM interface or backend server (e.g., 103) may maintain a recursive or nested parent-child organizational tree, with references stored in relational or document-oriented database structures. The relationship between 410A and 422 may be visually and logically defined by metadata such as ParentOrgId, ParentExternalId, or OrganizationLevel field types. These allow the platform to query, audit, and display multilevel organizational contexts.

In one or more embodiments, sub-organization 410D may be automatically added based on intelligent triggers such as asset scan events, mobile location-based presence, or backend activity logs that indicate consistent or authenticated use of platform services by an unidentified or newly active participant. For example, a warehouse in a new city scanning genuine assets repeatedly using a CRM mobile application may automatically be proposed as a sub-organization to be added. The application server 103 may generate a provisional profile, log the scanning metadata, and forward a request to the main organization 420 for approval or automatic linkage based on policy.

The organizational schema illustrated in FIG. 4B enables a scalable and traceable structure, where each entity-whether main or subordinate-can operate semi-autonomously while maintaining referential integrity with upstream and downstream entities. In some embodiments, each sub-organization 410A-410D, including sub-organization 422, may be restricted in function or capability depending on its assigned role. For example, sub-organization 410B may be restricted to dispatching but not receiving, while sub-organization 410C may be limited to receiving and storage without permission to generate further child sub-organizations. These functional roles may be enforced via configuration settings at the main organization 420 level, or programmatically via dynamic permission assignment during data synchronization.

The registration of sub-organizations 410A-410D may be initiated via multiple input channels including web-based CRM interfaces, mobile applications, or backend administrative consoles. In some embodiments, an administrator of the main organization 420 may manually initiate creation of a sub-organization by completing a form that includes entity type, geographic coordinates, authorized users, assigned assets, and intended operational function. Alternatively, an approval-based registration method may be implemented, wherein a sub-organization sends a request for affiliation and waits for manual or automated approval from the main organization 420 based on trust score, authentication events, or preconfigured policies.

In some cases, sub-organizations may be registered passively or indirectly, such as through third-party data integration systems or partner network APIs. For example, if the main organization 420 is a global retail chain and a third-party logistics provider starts transacting assets tied to the main organization's QR/NFC codes, the system may autonomously detect this activity and propose the creation of a provisional sub-organization record. This record may be held in a sandbox or staging environment until formally approved and promoted by an administrator of the main organization 420 or an AI agent operating under predefined heuristics.

The unique identifiers assigned to each sub-organization are critical for downstream activities such as auditing, inventory control, financial reconciliation, and compliance validation. These identifiers may be constructed using concatenated strings or hashed representations comprising segments such as parent organization ID, sub-organization index, geographic code, or a creation timestamp. For example, the identifier Sub1_xyz_123 may denote that this entity is the first sub-organization under a geographic zone or division labeled xyz, and was the 123rd such entity registered under this taxonomy. These identifiers are typically stored within the CRM platform and mirrored in the application server 103 to maintain synchronization across systems.

As depicted in the sub-organization data 421, the role field may denote one or more operational capacities assigned to the entity. These roles may be discrete (e.g., Retail, Manufacturer, Warehouse) or composite, depending on the business model and logistical flow of the main organization 420. For example, sub-organization 410C may act as both a warehouse and a distributor, receiving bulk goods and subsequently distributing them to downstream retailers. In such a case, the role string may include both tags: “Warehouse/Distributor.” These roles may determine the kinds of transactions and asset flows the sub-organization is permitted to engage in.

The external product identifiers embedded in the metadata of sub-organization 410D serve a dual function: asset attribution and authenticity verification. In some embodiments, each product handled by a sub-organization is tagged with an identifier such as 1a_abc_123_xyz_123, wherein the prefix 1a may denote the product class, abc_123 maps to the parent organization, and xyz_123 corresponds to the handling sub-organization. Such identifiers may be encoded into scannable formats such as QR codes or NFC hashes and attached physically to the asset or container. When scanned, these identifiers may prompt an API call to application server 103 for verification.

If the identifier is valid and registered to the scanning entity, the application server 103 may return a validation message along with additional metadata such as batch number, manufacturing date, and authorized route. Conversely, if the identifier is unknown, tampered, or improperly formatted, the system may return an invalidation message or trigger a risk flag. This approach may be particularly effective in detecting pirated or counterfeit goods that masquerade as legitimate products. Since unauthorized actors cannot reproduce valid hashes or prefix structures without access to the application server's credentialed generation tools, any mismatched identifier serves as a red flag.

Sub-organization 422, which is illustrated as a child of 410A, demonstrates the capacity of the system to represent and manage nested organizational structures. Such hierarchies may be relevant in cases where a distributor (410A) manages a group of dependent retailers (422), or where a warehouse (410C) subcontracts with a storage unit (422). These sub-sub-organizations may be fully enrolled with distinct identifiers, roles, and permissions, or may operate under inherited credentials and visibility from their parent sub-organization. The CRM system may allow deep nesting and retrieval of these hierarchies for querying, reporting, and process automation.

In some embodiments, when a sub-organization such as 410A initiates the creation of a child organization like 422, a payload object may be generated within the CRM platform (e.g., 411), containing fields such as proposed organization name, role type, parent organization reference (i.e., pointing to 410A), proposed location, and requested permissions. This payload object may then be wrapped into a Data Synchronization Object (DSO) and sent to application server 103 for validation, logging, and conditional approval. The application server 103 may return an approval, a rejection, or a request for additional information. Upon acceptance, the new child organization 422 becomes visible in the hierarchy tree and is granted a unique ID prefixed with the ID of its parent, e.g., Sub1.1_xyz_123.

One method of approval may involve the use of a defined approval hierarchy stored in metadata within the CRM database. This metadata may specify that certain roles (e.g., Administrator at 410A) have authority to create child organizations without oversight, while others may require multi-party approvals involving the main organization 420. For example, if 410A is a certified regional distributor, it may have autonomous rights to add local retailers like 422. However, if 410A is a third-party contractor with limited permissions, then creation of 422 may require explicit approval from the main organization 420 or a compliance review process executed at the application server 103.

Each organizational relationship defined in the hierarchical map of FIG. 4B may also include metadata for data lineage, traceability, and reporting. These may include timestamps for creation and last modification, the user ID of the creator, reason codes for the organization's establishment (e.g., expansion, acquisition, partnership), and scope of visibility for associated records. For example, sub-organization 410C may only have visibility into assets and transactions it originates or receives, while the main organization 420 may have omniscient access across the entire hierarchy. These visibility rules may be governed by attribute-based access control (ABAC) or role-based access control (RBAC) frameworks defined within the CRM environment.

In some implementations, any scan or transaction executed by a sub-organization (e.g., scanning of assets at 410B) may include the sub-organization ID in the metadata sent to the application server 103. This inclusion allows the server to automatically map the event to the correct organization in the hierarchy and validate the event against permitted behaviors. If the event is initiated by an unknown sub-organization or includes a malformed ID that does not correspond to the established structure, the application server 103 may log the anomaly and raise alerts to the main organization 420 via a notification mechanism (e.g., webhook, email, CRM in-application message).

Referring again to the unique ID string of each sub-organization, in some embodiments, these identifiers may be cryptographically signed by the application server 103 to prevent forgery. A digital signature or hash may be appended to the ID string and verified whenever the sub-organization attempts to perform a restricted action, such as asset transfer, child organization creation, or data export. This cryptographic assurance enhances the integrity and trustworthiness of the system, especially in environments dealing with high-value or regulated goods (e.g., pharmaceuticals, electronics, defense equipment).

The system 400B may also support visualization layers that graphically display the organizational hierarchy in the CRM interface or on an administrative dashboard. These visualizations may use node-link diagrams, collapsible trees, or nested lists to allow users to navigate, explore, and modify the organizational structure. Sub-organizations 410A-410D and 422 may be displayed with attributes such as online status, asset count, recent activity log, pending synchronization events, or compliance score. This makes it easier for administrators at main organization 420 to monitor and audit operations across multiple regions and business units.

In other embodiments, the sub-organization hierarchy may be enriched with location-aware capabilities. Geographic coordinates may be stored along with each sub-organization's profile, allowing for mapping and spatial queries. The CRM application may plot all sub-organizations on a GIS map, allowing the main organization 420 to plan logistics, service coverage, or compliance audits. Sub-organization 410D may be automatically flagged if it is detected to be operating outside of its assigned region or if it overlaps operationally with another sub-organization already in the system.

Assets managed by the sub-organizations may carry a traceable lineage tied to the main organization 420, both via prefix in the external ID and via synchronized records in the backend database. In some cases, assets manufactured by the main organization 420 and transferred to sub-organization 410A may still retain the main organization's ownership signature or authentication metadata. When these assets are transacted further by sub-organization 410A or scanned by an end customer, the traceability information may be surfaced via web services or verification portals pointing to the origin at 420.

Sub-organizations may also inherit default configurations, policies, or event triggers from their parent organization. For example, when sub-organization 422 is created under 410A, it may automatically inherit alert configurations, data synchronization rules, compliance flags, and asset classification schemas defined by 410A or further upstream at 420. This inheritance reduces setup time and maintains consistency across the hierarchy. Administrators may be able to override some or all inherited settings, based on permission levels or business needs.

In some embodiments, an asset may be initiated at the main organization 420, which could represent a manufacturer, central distributor, or corporate head office, depending on the implementation. The asset is assigned a unique asset ID, which includes a prefix corresponding to the identifier of the main organization 420. The asset is further associated with one or more multimodal tags, such as a QR code, NFC chip, and/or a secure external ID. The multimodal tag comprises cryptographically verifiable information, including one or more of a QR_hash or NFC_hash, that references asset metadata stored on a backend application server 103. When the asset is dispatched from main organization 420 to a designated sub-organization-say, sub-organization 410A—the transfer is logged within the CRM platform and mirrored in the application server 103 through a Data Synchronization Object (DSO), including asset metadata, transaction timestamp, and recipient organization ID.

Upon reaching sub-organization 410A, the asset may be scanned by an authorized device, triggering a verification request to application server 103. The scanned tag data, such as the asset ID, QR_hash, or NFC_hash, is matched against stored values on the server. If a match is confirmed, the server returns an authenticated confirmation along with asset attributes such as origin, asset status, authorized recipient, and intended next-hop sub-organization if any. If the tag data does not match or is missing expected fields, the server may respond with an invalidation signal, log the discrepancy, and optionally alert administrators via configured alerts or CRM notifications.

In some embodiments, loss or theft detection may occur at various points in the asset's journey. If an asset is expected at sub-organization 410B based on a known logistics path but fails to scan at its intended checkpoint within a specified timeframe, the application server 103 may flag the asset as “missing in transit.” Route tracking logs stored at 103 can be used to trace the last known checkpoint (e.g., 410A), scan timestamp, vehicle ID if applicable, and responsible personnel. This forensic data enables the system to reconstruct the last authenticated leg of the journey and narrow down possible points of loss or theft. Such detection may further be enhanced using embedded GPS modules in the asset if available, or by correlating location data from scanning devices.

When a scanned asset is determined to be fraudulent—for example, a duplicated QR code or cloned NFC tag—the application server 103 may detect the anomaly by identifying a mismatch in hash verification, unexpected organization IDs, or access attempts from unauthorized sub-organizations. For example, if sub-organization 410C attempts to scan and validate an asset originally tagged for 410B without a registered transfer in the system, the server may detect the deviation and raise a fraud alert. Additionally, if two different entities scan an asset ID with the same QR_hash in separate geographic regions at overlapping times, the server may identify a duplication anomaly, indicating counterfeiting or shadow inventory circulation.

If an asset is reported as incomplete or tampered with upon arrival at sub-organization 410D, a receiving scan may trigger a comparison between dispatch details and received details. For example, the dispatch payload recorded by 420 or 410A may state that the asset was shipped with three subcomponents or a total weight of 10 kilograms. If the received metadata upon scanning at 410D reports only two subcomponents or a different weight, the system identifies the discrepancy and logs the event. A claim or investigation may be initiated automatically or manually through the CRM platform by authorized users at 410D or at the main organization 420.

The system may also accommodate traceability by embedding route metadata into each asset transaction. Each asset's transfer from one organization to another—say, from 420 to 410A to 410C—is recorded with timestamps, handler IDs, and contextual metadata (e.g., vehicle ID, delivery batch number). This chain of custody allows full lineage reconstruction for auditing, quality control, and regulatory reporting. Assets may also carry route permissions, meaning that a given asset is only allowed to traverse a predefined organizational path. If the asset is scanned in an unauthorized sub-organization or region, the application server 103 may invalidate the transaction.

In some cases, assets may start their lifecycle at a sub-organization, such as when 410D acts as a local manufacturer. In such scenarios, 410D may generate an asset registration request to be approved by the main organization 420, or depending on its permissions, may directly initiate asset creation within the CRM platform. Upon registration, the asset receives a unique identifier with prefix from 410D, and optionally from 420, indicating parentage. Multimodal tags are generated using platform-authenticated methods and are hashed with organization-specific salts to reduce forgery risks. Once created, the asset may undergo the same scanning, validation, and monitoring procedures as assets originating from 420.

Embodiments may further allow for exception handling and audit trails. If an asset is marked as lost or misrouted, the system may automatically issue alerts to previous and next-hop organizations in the hierarchy. QR/NFC scans at downstream locations may also serve to auto-recover unaccounted assets. Additionally, the system may be configured to disable scanning for blacklisted asset IDs or previously flagged assets, helping to mitigate fraud recurrence.

A process 100 may include creating a new child organization in the CRM application triggering an organization create event (block 101). For example, an automated device may create a new child organization in a CRM application triggering an organization create event. An Organization payload object may be created using pertinent fields from an object, including a CRM ID of the object (block 102).

For example, a device may create an organization payload object using the pertinent fields from an object, including a CRM id of the object, as described above. Process 100 may also include putting the CRM object ID into an external ID of a payload. For example, the device may put the CRM object id into an external id of a payload, as described above.

Packaging the payload may include callout information including URL, path, and HTTP method; the synchronization; the method; and the error handler into a Data Synchronization object.

For example, the device may package the payload, callout information including URL, path, and http method; the synchronization; the method; and the error handler into a data synchronization object.

In some embodiments, a server may include a bus, a processor, a memory, a storage, a battery, an input component, an output component, and a communication interface.

The bus may include a component that permits communication among the components of gateway. The processor may be implemented in hardware, firmware, or a combination of hardware and software. The processor may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, the processor includes one or more processors capable of being programmed to perform a function.

Memory may include one or more memories such as a random-access memory (RAM), a read only memory (ROM), and/or another type of dynamic or static storage device (e.g., a flash memory, a magnetic memory, and/or an optical memory) that stores information and/or instructions for use by processor.

The storage stores information and/or software related to the operation and use of the server. For example, storage may include a hard disk (e.g., a magnetic disk, an optical disk, a magneto-optic disk, and/or a solid-state storage), a compact disc (CD), a digital versatile disc (DVD), a floppy disk, a cartridge, a magnetic tape, and/or another type of non-transitory computer-readable medium, along with a corresponding drive.

The battery or other energy storage device may be connected along a power conduit to supply power to processor, memory, and internal components of gateway. Battery may supply power during field measurements by gateway. Battery permits gateway to be a portable integrated device for conducting field measurements of propagation delay in a RAN.

Input component includes a component that permits gateway to receive information, such as via user input (e.g., a touch screen display, a keyboard, a keypad, a mouse, a button, a switch, and/or a microphone). Additionally, or alternatively, the input component may include a sensor for sensing information (e.g., a GPS component, an accelerometer, a gyroscope, an optical sensing device including an optical sensor, scanner, or a camera, and/or an actuator).

Output component includes a component that provides output information from A server (e.g., a display, a speaker, a user interface, and/or one or more light-emitting diodes (LEDs)). Output component may include a display providing a GUI, such as interface. Input component and output component may be combined into a single component, such as a touch responsive display, also known as a touchscreen.

Communication interface may include a transceiver component (e.g., a transceiver and/or a separate receiver and transmitter) that enables gateway to communicate with other devices, such as via a wired connection, a wireless connection, or a combination of wired and wireless connections. Communication interface may permit gateway 14 to receive information from another device and/or provide information to another device. For example, communication interface may include an Ethernet interface, an optical interface, a coaxial interface, an infrared interface, an RF interface, a universal serial bus (USB) interface, a Wi-Fi interface, a cellular network interface, or the like.

A server may perform one or more processes described herein. A server may perform these processes by processor executing software instructions stored by a non-transitory computer-readable medium, such as memory and/or storage. A computer-readable medium is defined herein as a non-transitory memory device. A memory device includes memory space within a single physical storage device or memory space spread across multiple physical storage devices.

Software instructions may be read into memory and/or storage from another computer-readable medium or from another device via communication interface. When executed, software instructions stored in memory and/or storage may instruct processor to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

In practice, a server may include additional components, fewer components, different components, or differently arranged components. Additionally, or alternatively, a set of components (e.g., one or more components) of A server may perform one or more functions described as being performed by another set of components of gateway.

In operation, the asset tracking system may function as follows. The NFC tag or COR may first be activated for tracking by operating a mobile application stored on the gateway. The user may initially log in and scan the tag, to which an object record and corresponding barcode may appear on the display of the interface. Next the user selects either an iQR or NFC tracker on the interface displayed on the display of the gateway, selects “tag” operation to tag an object, and saves the tagged object to add tracking functionality to the tag.

Subsequently, through either the action of the user by using an optical sensor of the gateway and/or placing of the gateway with the embedded NFC chip in proximity of the NFC tag, the processor of the gateway receives data from the tag. Here, the processor determines whether the data is received from a CQR code label or an external Identification (ID) device via optical scanning by an optical sensor on the gateway (e.g., a camera), or an NFC tag, via proximate contact with an NFC reader chip located within the gateway.

Upon determining that the data is received from the QR code label, the processor proceeds to retrieve an URL including an object ID and a hash code from the CQR label. The processor then sends a POST request to the server for validation. Here, the POST request (e.g., an API call such as “assets/{assetID}/ScanFromApp) includes the object ID, the hash code, an authentication token that attaches the POST request to an authenticated user for a log-in, a qr hash including a hash value from the URL, and a location of the gateway, including a latitude and a longitude at which the gateway is located.

Alternatively, upon determining that the data is received from the external ID device, the processor retrieves an external ID unique to an item within an organization. The processor then sends a POST request to the server for validation. Here, the POST request (e.g., an API call such as “assets/external/ScanFromApp”) may include the external ID unique to the organization, the authentication token having an organization ID that describes the organization of a user performing a scan of the external ID device, and the location of the gateway, including the latitude and the longitude at which the gateway is located.

Upon receiving the POST request, the server processes the POST request. Here, the processing of the POST request includes comparing the external ID with the organization ID of an existing object retrieved from the database. Upon the external ID matching the organization ID, the server returns the information of the object back to the user. In contrast, upon determining that the external ID fails to match the organization ID, the server creates a unique object record and stores the information in the database.

Further, upon determining that the data is received from the NFC tag, the processor retrieves a Universally Unique Identifier (UUID) (e.g., a 128-bit label used for information in computer systems) of the object and an NFC hash from the NFC tag and sends an API request to the server. Here, the API request (e.g., “device/nfc/validate”) includes parameters includes the authentication token, the location of the mobile device including the latitude and the longitude at which the gateway is located, the identification of the object to which the tag is placed, and the NFC hash of the object to which the tag is placed.

Once the server receives the API request, the server performs a validation of the API request based on the parameters. Here, the validation involves the server comparing the NFC hash from the API request from an NFC hash data (e.g., nfc_hash retrieved from the database). Upon a verified validation by the server, the processor receives the full information associated with the object from the server.

A server may include a processing circuitry coupled to a memory, a storage, and a network interface. In an embodiment, the components of the server may be communicatively connected via a bus.

The processing circuitry may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory may be volatile (e.g., RAM, etc.), non-volatile (e.g., ROM, flash memory, etc.), or a combination thereof. In one configuration, computer readable instructions to implement one or more embodiments disclosed may be stored in the storage.

In another embodiment, the memory is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry to perform the various processes described herein.

The storage may be magnetic storage, optical storage, and the like, and may be realized, for example, as flash memory or other memory technology, CD-ROM, Digital Versatile Disks (DVDs), or any other medium which can be used to store the desired information.

The network interface allows an asset tracking system to communicate with the A server for the purpose of, for example, receiving data, sending data, and the like. Further, the network interface allows the asset tracking system to communicate with the database for the purpose of collecting qr_hash and nfc_hash column data.

As used herein, a Scratch Org may include a temporary CRM environment used primarily for development and testing. It is a key component of CRM DX (Developer Experience), which provides tools and processes for modern development on the CRM platform.

### Key Features of Scratch Orgs:

Ephemeral and Configurable: Scratch Orgs are short-lived environments that can be created and discarded as needed. They are highly configurable, allowing developers to tailor the environment to their specific needs, such as enabling or disabling features, applying different settings, and using specific metadata.

Source-Driven Development: Scratch Orgs are designed to be integrated into a source-driven development process. Developers can push and pull code and metadata between the Scratch Org and a version control system, facilitating better collaboration and continuous integration.

Automation: Since Scratch Orgs can be created from scripts or CLI commands, they are easily integrated into automated workflows, including CI/CD pipelines. This allows for automated testing, deployments, and other processes.

Multiple Orgs: Developers can create multiple Scratch Orgs simultaneously, allowing them to work on different features or projects in parallel without affecting each other.

Defined Lifespan: Scratch Orgs have a defined lifespan, typically between 1 to 30 days, after which they automatically expire and are deleted. This ensures that the environments are always fresh and reduces the need for manual cleanup.

Sandbox vs. Scratch Org: Unlike Sandboxes, which are copies of a production environment used for development and testing, Scratch Orgs are empty environments that a user builds from scratch (hence the name). Sandboxes are better for testing production-like scenarios, whereas Scratch Orgs are ideal for development and rapid prototyping. Typical Use Cases:
a) Feature Development: Developers can create a Scratch Org to work on a new feature in isolation before merging it into the main codebase.
b) Bug Fixes: Scratch Orgs can provide a clean environment for reproducing and fixing bugs.
c) Testing: Since Scratch Orgs are relatively easy to spin up and discard, they are suitable for running automated tests, especially in CI/CD pipelines.
d) Training and Demos: Scratch Orgs can be used to create specific configurations and setups for training sessions or product demos.

### How to Create a Scratch Org:

Creating a Scratch Org typically involves using the CRM CLI (Command Line Interface). Developers define the Scratch Org configuration in a ‘project-scratch-def.json’ file, specifying the settings and features they want. Then, they use a command like ‘sfdx force: org: create-s-f config/project-scratch-def.json-a MyScratchOrg’ to create the org.

### Benefits:

a) Rapid Setup: Developers can quickly set up a new environment without waiting for a sandbox to refresh or copy.
b) Isolation: Work can be isolated in separate orgs, reducing the risk of conflicts or accidental changes to other features.
c) Version Control: Since Scratch Orgs are designed to work with source control, they support modern development practices and help maintain clean, manageable codebases.

Overall, Scratch Orgs are a useful tool for CRM developers, enabling efficient, scalable, and modern development practices.

A Dev Instance in the context of software development, especially in environments like CRM or cloud computing platforms, refers to a development environment or server specifically set up for development purposes. It is a place where developers can write, test, and debug their code without affecting the production environment or other stages of deployment like staging or QA (Quality Assurance).

### Key Characteristics of a Dev Instance:

Isolation: A Dev Instance is isolated from production environments, ensuring that any changes or experiments performed during development do not impact the live system. This allows developers to safely test new features, fix bugs, and try out different configurations.

Configuration: Dev Instances are typically configured with similar settings to production but may include additional tools or permissions that aid in development. For example, they might have debugging tools enabled, less restrictive security settings, or sample data instead of real customer data.

Frequent Updates: The code in a Dev Instance is updated as developers push new changes, experiment with features, or iterate on their work. These instances are typically the first step in a deployment pipeline.

Integration: Dev Instances may be integrated with version control systems (like Git) and CI/CD pipelines, allowing for continuous integration and delivery of code. This integration ensures that the code in the Dev Instance is always up-to-date with the latest changes from the development team.

Temporary: While a Dev Instance can be long-lived, it is often considered a temporary environment. Once development work is complete, the instance may be reset, reconfigured, or decommissioned to prepare for new projects or updates.

Multiple Instances: Larger teams or projects might use multiple Dev Instances to handle different tasks or teams working on separate features. This reduces the risk of conflicts and allows for parallel development streams.

### Uses of a Dev Instance:

Feature Development: Developers use Dev Instances to create and test new features before merging them into the main codebase.

Bug Fixing: When a bug is identified, a developer can reproduce it in the Dev Instance, apply a fix, and test the solution before moving it to higher environments like QA or staging.

Code Review and Collaboration: Dev Instances often serve as collaborative environments where developers can share their work, conduct peer reviews, and test integrations with other code components.
a) Prototyping: A Dev Instance is an ideal environment for prototyping and experimenting with new ideas, as changes can be made rapidly without affecting other environments.

In CRM, a Dev Instance might refer to:
a) Developer Edition: A free CRM environment with limited storage and features, intended for individual developers to learn and experiment with CRM's platform.
b) Sandbox: A copy of the production environment used for development and testing. Sandboxes can be of different types (Developer, Developer Pro, Partial Copy, Full) depending on the amount of data and metadata they include.
c) Scratch Org: As previously mentioned, a Scratch Org is another type of Dev Instance in CRM, used for short-lived, project-specific development.

### Benefits of a Dev Instance:

a) Safety: Since it is isolated from production, developers can experiment freely without the risk of breaking the live system.
b) Flexibility: Dev Instances can be configured as needed to suit specific development needs, including adding specific tools, libraries, or permissions.
c) Scalability: Teams can spin up as many Dev Instances as necessary to handle various aspects of a project, enabling parallel workstreams.

A Dev Instance may provide a safe, flexible environment for developers to create, test, and refine their code before it moves closer to production.

A CRM Instance refers to the physical infrastructure and environment provided by CRM that hosts and runs a user CRM organization. When a user accesses CRM, a user is interacting with an instance that contains a user specific CRM org, along with all its data, customizations, and applications.

Components of a CRM Instance may include:

Physical Data Center: CRM instances are hosted in CRM's data centers around the world. Each instance is associated with a specific data center, and CRM has multiple data centers in different regions to ensure availability, redundancy, and compliance with data sovereignty laws.

Instance Name: A CRM instance may have a unique name, such as, for example, a combination of a region identifier and a number (e.g., NA56, EU14, AP20). This name may indicate a specific server cluster that hosts a user organization.

Multi-Tenancy: A CRM may operate on a multi-tenant architecture, meaning that multiple customers share the same physical infrastructure (instance) while keeping their data and configurations isolated from each other. This allows the CRM to provide a scalable, secure, and cost-effective service.

High Availability: CRM instances may be designed for high availability, with multiple layers of redundancy to ensure that services remain operational even in the event of hardware failures or other issues. CRM uses techniques like data replication and load balancing to maintain uptime.

Instance Upgrades: A CRM may update instances with new features, security patches, and enhancements. These upgrades are typically scheduled three times a year during major releases. Since customers on an instance may share a same version, upgrades may be coordinated and may not require individual action from customers.

Data Residency and Compliance: CRM instances may be located in different regions to comply with local data residency and compliance requirements. For example, customers in Europe might be hosted on an instance located in the EU to comply with GDPR.

Exemplary Types of CRM Instances may include, by way of non-limiting example:

Production Instance: This is the live environment where a user's actual business operations take place. It contains a user's real data and is used by end-users for day-to-day activities.

Sandbox Instance: These are copies of a user production environment used for development, testing, and training. Sandboxes can be refreshed from the production instance and are isolated from it, so changes in a sandbox do not affect the live system.

Developer Sandbox: A basic sandbox with limited storage, used for development and testing.

Developer Pro Sandbox: Similar to the Developer Sandbox but with more storage.

Partial Copy Sandbox: Contains a subset of a user production data and metadata, used for more comprehensive testing.

Full Sandbox: A complete replica of a user production environment, including all data and metadata, used for thorough testing and staging.

Scratch Org: A temporary CRM instance created for development purposes, typically used in CRM DX. Scratch Orgs are highly configurable and short-lived.

### Accessing a CRM Instance:

When a user logs in to the CRM, the URL in a user browser may include an instance name, which indicates the specific server cluster a user org is running on (e.g., ‘https://na56.crm.com’). If the CRM needs to perform maintenance on a user instance or if there are any issues, a user may be temporarily moved to a different instance, which can be seen by a change in the URL.

### Monitoring and Status:

CRM may provide tools for monitoring the status of a user instance:

Trust Site: This site provides real-time information on the health, availability, and performance of CRM instances. A user can check the status of a user specific instance and get updates on any planned maintenance or incidents.

Instance Status Dashboard: On the Trust site, a user can view the status of all CRM instances globally, including information about upcoming releases, patch updates, and historical uptime data.

Key Features of VS Code with CRM-Specific Extensions:

### CRM Extension Pack:

The CRM Extension Pack is a collection of CRM-specific extensions that integrate tightly with VS Code. An extension pack may include tools for working with Apex, Lightning Web Components (LWC), Visualforce, and other CRM technologies.

Some exemplary components of a CRM Extension Pack may include:

CRM CLI Integration: Provides integration with the CRM Command Line Interface (CLI), allowing a user to run CRM DX commands directly from within VS Code.

Apex Language Support: Adds syntax highlighting, code completion, and error checking for Apex code.

Visualforce Language Support: Adds syntax highlighting and code completion for Visualforce pages and components.

Lightning Web Components (LWC): Supports the development of LWCs with features like syntax highlighting, code completion, and the ability to create, modify, and test LWC components directly within the editor.

SOQL Language Support: Provides syntax highlighting and autocomplete for CRM Object Query Language (SOQL) queries.

### IntelliSense and Code Completion:

VS Code offers IntelliSense for CRM languages, including Apex, SOQL, and LWC. IntelliSense provides smart code completions based on the context of a user code, making it easier to write error-free code faster. It may also offer hover information and inline documentation to help a user understand different classes, methods, and properties.

### Debugging:

VS Code supports debugging Apex code using the CRM Apex Debugger. This allows a user to set breakpoints, inspect variables, and step through a user code to diagnose and fix issues.

Debugging support may also be available for Lightning Web Components, allowing a user to troubleshoot JavaScript code and inspect the DOM directly from the editor.

### Version Control Integration:

VS Code has built-in Git integration, which is essential for source-driven development. A user can manage a user CRM codebase in version control, track changes, and collaborate with other developers.

The CRM extensions work seamlessly with version control systems, ensuring that a user can push and pull changes from repositories, create branches, and resolve merge conflicts directly within the IDE.

### Org Browser:

An Org Browser feature may be available through the CRM extensions and provide a visual way to explore metadata in a user CRM org. A user can browse, retrieve, and deploy metadata components without needing to write complex CRM CLI commands.

### Visual Studio Code Terminal:

VS Code includes an integrated terminal, allowing a user to run CRM CLI commands and interact with a user CRM org directly from the editor. This streamlines the development process by keeping everything within a single interface.

### Snippets and Customizations:

The CRM extensions include snippets for common code patterns in Apex, Visualforce, and LWC, helping a user write code faster.

A user can also customize a user development environment by creating a user's own snippets, changing themes, and installing additional extensions to support other languages or tools.

### Lightning Web Components (LWC) Development:

The extensions support creating and testing Lightning Web Components. A user can scaffold new LWC components, edit their HTML, JavaScript, and CSS, and deploy them to a user CRM org for testing.

The development experience is enhanced by features like auto-completion for standard and custom components, real-time linting, and error checking.

### Integrated Testing:

A user can run unit tests for Apex directly within VS Code and view test results in a dedicated output panel. This helps in maintaining code quality and ensures that a user code behaves as expected.

For LWC, a user can also write and run Jest tests within the same environment, making it easier to maintain test coverage.

### Key Concepts of Declarative Development:

### No-Code Approach:

Declarative development is often synonymous with no-code development. This approach is aimed at users who may not have programming skills but need to configure systems, automate processes, or build applications.

It emphasizes simplicity and accessibility, allowing a broader range of users to contribute to the development and maintenance of a system.

Configuration over Customization:

Declarative tools focus on configuration rather than customization. This means using pre-built, configurable components that require no coding, as opposed to writing custom code to achieve similar results.

Configuration usually involves setting up or adjusting settings, defining rules, creating flows, and connecting pre-built components to achieve desired outcomes.

### Common Declarative Elements in CRM:

### Process Builder:

Process Builder is a powerful tool that allows users to automate business processes with a point-and-click interface. Users can define criteria and actions that automatically trigger based on changes to records, allowing for automation of tasks, approvals, notifications, and more.

### Flow Builder:

Flow Builder enables the creation of complex business processes and user interactions using a visual interface. Flows can guide users through a sequence of screens, update records, send emails, or interact with external systems.

Flow offers capabilities like looping, decision-making, and integrating with external services through API calls.

Validation Rules are declarative tools that enforce business rules by preventing users from saving records that do not meet certain criteria. These rules are created through a simple interface where conditions can be specified without writing code.

### Approval Processes:

Approval Processes are used to automate the approval of records in CRM. These can be set up using a point-and-click interface where a user defines the approval steps, conditions, and actions to be taken at each step.

### Reports and Dashboards:

Reports and Dashboards allow users to create powerful, data-driven insights using a drag-and-drop interface. Users can create custom reports, group data, apply filters, and visualize data through charts, without needing to write any SQL or code.

Dynamic Dashboards enable real-time visibility into key metrics, tailored to individual users.

### Schema Builder:

Schema Builder provides a visual interface for managing data models. Users can create, modify, or delete objects, fields, and relationships through a drag-and-drop interface, ensuring that database schema changes are made without writing SQL.

### Lightning Application Builder:

Lightning Application Builder allows users to build custom pages for the CRM Lightning Experience and mobile application using drag-and-drop components. Users can assemble different components, like lists, charts, or custom components, to create tailored interfaces.

### Custom Objects and Fields:

Custom Objects and Fields can be created and configured through a declarative interface, allowing users to extend CRM's data model to suit their business needs without writing any database scripts.

### Lightning Flow for Service:

Lightning Flow for Service enables the automation of customer service processes. It allows admins to build guided processes for service agents to follow, improving efficiency and ensuring consistency in customer service interactions.

In some embodiments a user interface with a schematic map may be created via:

### Open Interactive Maps:

Go to Interactive Map URL in a user web browser.

### Search for Starting Location:

In the search bar, enter the starting location of a user delivery route (e.g., a user warehouse or first delivery stop).

### Click on Directions:

Click on the “Directions” button to begin creating a user route.

### Add Multiple Stops:

Enter the address of a user first stop in the “Add destination” field.

To add additional stops, click on the “+” button below the destination field to add more stops. A user can add multiple destinations to form a user delivery route.

### Reorder Stops:

Drag and drop the stops to reorder them as needed to optimize a user delivery route.

### View the Route:

Once all the stops are entered, Interactive Maps will automatically calculate the best route between all stops and display it on the map.

### Save or Share the Route:

A user can save the route to a user Interactive account or share the link with others. A user can also print the route or send it to a user mobile device for navigation.

### Example Route

A user may have the following stops that an Asset may travel within a tolerance of travel error:
i) Starting Point: 123 Main St, City A;
ii) Stop 1:456 Elm St, City B;
iii) Stop 2:789 Maple Ave, City C;
iv) Stop 3:101 Oak Dr, City D; and
v) Final Destination: 202 Pine St, City E.

In some embodiments an Asset route may be automatically optimized and a tolerance adjusted according to real time variables, such as, for example: automatically arranging tops in the most efficient order to minimize travel time or distance, and real time traffic considerations wherein an interactive map provides real-time traffic updates, so a user can adjust a user route based on current conditions.

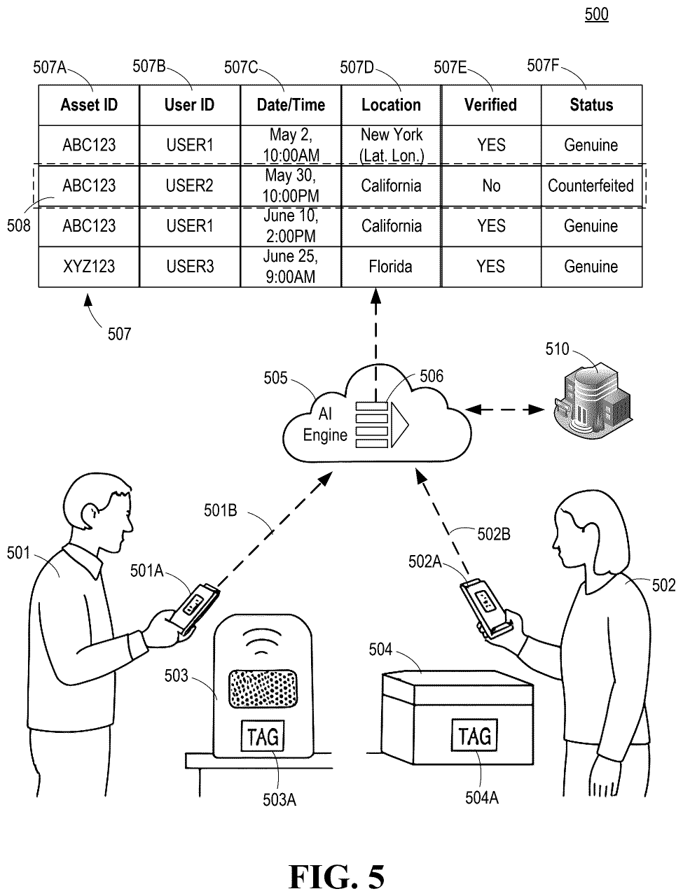

Referring now to FIG. 5, an exemplary system 500 illustrates tag-based asset validation, in which identical tags affixed to different assets may be scanned by multiple users using respective mobile gateway devices, in accordance with some embodiments of the present disclosure. The system 500 includes a first user 501 and a second user 502, each using a respective gateway device, referred to herein as the first gateway device 501A and the second gateway device 502A. Each of the gateway devices 501A and 502A may be implemented as a smartphone or a similar scanning-enabled computing device that is configured to operate a verification software application. This software application may be downloaded from or authorized by an entity such as a manufacturer, distributor, or authorized seller. In some embodiments, the first user 501 and the second user 502 may be at a registered/authorized location or organization associated with a parent organization of the assets (e.g., 503-504).

The first user 501 and the second user 502 are each interacting with respective physical assets 503 and 504. In the illustrated example, asset 503 and asset 504 may be of the same product type, such as wireless speakers. Affixed to the first asset 503 is a first tag 503A, and affixed to the second asset 504 is a second tag 504A. The tags 503A and 504A are represented (as an example) as visually identical, indicating that one of them may have been duplicated or cloned. The duplication of tags may occur as a result of counterfeit activity, in which a counterfeiter replicates a valid tag 503A from a genuine asset 503 and applies the replica tag 504A to a counterfeit asset 504, thereby misrepresenting the counterfeit asset as genuine.

The first gateway device 501A is operated by the first user 501 to scan the first tag 503A, and similarly, the second gateway device 502A is used by the second user 502 to scan the second tag 504A. Upon scanning, each gateway device 501A and 502A transmits a respective POST request 501B and 502B to a server 505 managed by an organization 510. The POST requests 501B and 502B may include data extracted from the scanned tags, such as a URL pointing to an asset verification endpoint, a unique asset identifier, and additional metadata including the user's authentication token, geolocation data, timestamp, and device signature.

The server 505 includes a verification database 506 and an AI engine configured to analyze incoming POST requests and evaluate the authenticity of the asset tags, the legitimacy of the asset-user pairing, and the contextual parameters such as scan location and frequency. The server 505 may be operated by an organization 510, such as LocatorX Inc., which may be responsible for managing product authentication infrastructure, verifying distributed assets, and identifying counterfeit activities. The AI engine in the server 505 may extract data from each POST request and performs one or more verification steps against the database 506.

The database 506 stores detailed records for each registered asset, including asset identifiers, hash values, user associations, valid geolocations, permitted usage times, and historical scan data. FIG. 5 includes a verification table 507 stored within the database 506, comprising multiple rows of scanned asset events. Each row includes columns such as asset ID 507A, user ID 507B, date/time 507C, scan location 507D, verified status 507E, and resulting status 507F (e.g., Genuine or Counterfeited 508). This verification table 507 is updated dynamically as new POST requests are received and processed.

In the example depicted, asset ID 507A “ABC123” is scanned on three different occasions: first by USER1 on May 2 at 10:00 AM in New York, then by USER2 on May 30 at 10:00 PM in California, and again by USER1 on June 10 at 2:00 PM in California. The AI engine evaluates these scans for consistency. The first and third scans by USER1 are considered valid and verified, while the second scan by USER2 is flagged as unverified and marked with the status “Counterfeited” 508. This analysis implies that tag 504A on asset 504 was duplicated from a valid tag 503A but used in an unauthorized context by an unauthorized user. In some embodiments, one or both of the first user 501 and the second user 502 may be at a location or organization not registered with the parent organization of the assets (e.g., 503-504).

The AI engine may analyze user ID 507B in conjunction with asset ID 507A to identify whether the user initiating the scan is recognized and authorized to interact with the corresponding asset. In the present case, if USER2 has not previously interacted with or been assigned asset ABC123, the system flags the POST request 502B as originating from an unauthorized source (second user 502). This determination may further be strengthened by checking whether USER2 has ever been within a designated proximity or logistics chain associated with asset ABC123.

In addition to comparing user credentials, the AI engine may analyze the scan's geolocation data 507D to assess if the scan location is consistent with the asset's known distribution path or expected operational geography. For example, asset ABC123 may be a portable asset allowed to move between locations, but its usage is tracked. If USER1 was the original owner or authorized handler of asset 503 and has valid scans from both New York and California, this information may validate USER1's continued association with the asset. In contrast, if USER2 scans the asset in California at an unexpected time and location, and with no previous association to that asset, this may indicate a tag-cloning event.

In some embodiments, the system 500 may incorporate additional metadata analysis such as timestamp clustering, device identifiers, and scan frequency. A cloned tag often results in multiple scans with identical asset IDs but different devices, locations, or authentication tokens in a short time window. Such behavior is identifiable by the AI engine, which may trigger alerts or log anomalies in the verification table 507.

The server 505 may further be configured to issue real-time feedback to the gateway devices 501A and 502A after analysis. For example, after scanning the first tag 503A, the first user 501 may receive a confirmation message such as “Asset Verified-Genuine,” while the second user 502, after scanning the second tag 504A, may receive a warning such as “Verification Failed-Potential Counterfeit.”

In yet another embodiment, the verification table 507 may be visualized by an administrative dashboard operated by the organization 510, wherein personnel can audit scan histories, monitor flagged events, or export records for legal or compliance purposes. The dashboard may display table 507 with filtering capabilities based on asset ID, user ID, status, and location.

Each scan entry in table 507 may be used as part of a broader supply chain verification strategy. By recording and analyzing asset-user interaction events, the organization 510 is equipped to maintain visibility into distributed product usage, detect counterfeiting, and assess unauthorized access patterns.

In the depicted example, the AI engine not only detects tag duplication but can also perform behavioral analysis of user scanning patterns. If a user such as USER2 repeatedly scans various unrelated assets within a constrained time frame, the system may flag such activity for further investigation.

Server 505 may also transmit alerts or automated responses to notify product owners, asset managers, or compliance officers whenever a cloned or unauthorized scan is detected. Such alerts may be dispatched via email, push notifications, or internal monitoring systems.

The verification logic may further include risk scoring, where each scan is assigned a confidence score based on how closely the current scan context matches historical patterns. The AI engine may assign low scores to suspected counterfeits, medium scores to new but uncertain users, and high scores to verified, consistent scans.

The data architecture of system 500 may also support decentralized scanning environments. For example, authorized retailers, service centers, or inspection agents may scan asset tags independently, with all events routed back to a centralized or federated server cluster operated by organization 510.

In scenarios where asset ID duplication is suspected, the organization 510 may invoke secondary validation mechanisms, such as comparing serial number holograms, internal NFC hashes, or user-submitted photos of the physical asset taken during the scan.

Asset authenticity verification may further be linked to downstream systems such as inventory management, warranty activation, product return validation, or fraud detection services. In some embodiments, if scan 502B was identified as counterfeit, an automatic hold may be placed on processing a return request for asset 504.

The AI engine in server 505 may also learn from historical scan anomalies to strengthen its future prediction models. Each time a cloned tag is identified and confirmed, the system updates its internal feature set to improve identification accuracy over time.

In some implementations, organization 510 may operate a secure blockchain ledger storing hash representations of asset scans, enabling independent auditability and tamper resistance. The server 505 may expose APIs to third-party verification clients or consumer-facing applications to allow asset verification without compromising proprietary backend validation rules.

In an alternate embodiment, the gateway devices 501A and 502A may also capture biometric user data during scan sessions, enabling multifactor validation when determining if a scan is authorized. The asset ID 507A stored in the tag may also encode embedded metadata such as model, batch number, region, or time of manufacture. The AI engine may verify consistency of this metadata with external records.

System 500 may support offline validation workflows wherein scan data is cached locally and transmitted in bulk once network connectivity resumes. Each delayed transmission is time-stamped and analyzed in sequence. In another embodiment, tags 503A and 504A may include tamper-evident printing or physical damage detection layers, which are scanned and analyzed alongside digital data.

The depicted system architecture allows real-time interaction between physical-world scanning and cloud-based decision engines, enabling both immediate and forensic counterfeiting detection.

In a commercial implementation, an online retailer may integrate system 500 to validate asset tags at customer returns, thereby reducing restocking of counterfeit goods. From a regulatory standpoint, the logged scan history in verification table 507 may be exported and submitted to compliance authorities or brand protection units.

In the consumer domain, end users may use gateway applications to scan second-hand products and verify original manufacturer authentication based on their personal device. Each gateway device 501A and 502A may include unique device identifiers, which may be tracked in the verification database 506 to flag shared use of a compromised application or account.

In implementations where the same tag is applied to distinct assets, system 500 enables organizations to differentiate usage contexts and disassociate cloned units from genuine units. In some cases, the AI engine may receive input from computer vision modules validating product images taken at the time of scan to detect mismatched product design.

The use of an AI engine allows adaptive, non-rule-based determination of authenticity, incorporating behavior analytics, user patterns, location variability, and probabilistic reasoning. The verification table 507 may further include user notes or incident flags, allowing human reviewers to annotate suspected counterfeit records. The organization 510 may also generate asset usage analytics from verified scans, producing reports on user engagement, distribution flow, and field deployment metrics.

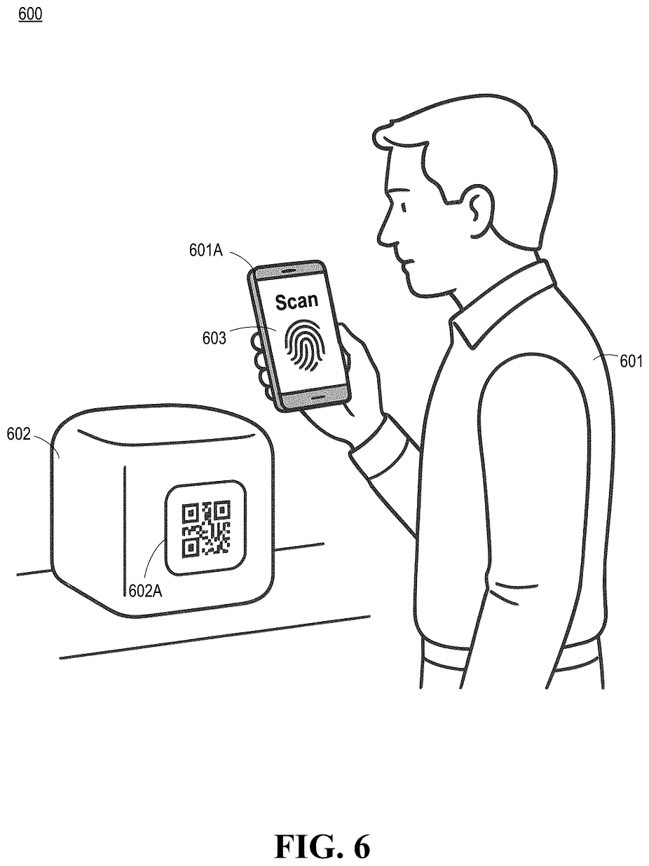

Referring now to FIG. 6, an example of asset verification illustrates that a mobile device 601A prompts for biometric authentication 603 from a user 601 during or after scanning a tag 602A affixed to an asset 602, thereby enabling a secondary layer of user-specific validation, in accordance with some embodiments of the present disclosure. The system 600 depicted in FIG. 6 enables a hybrid validation workflow wherein both the authenticity of the asset 602 and the authorization of the user 601 attempting to interact with the asset 602 are evaluated in tandem. This model enables asset-level traceability coupled with user-level accountability, strengthening asset authentication in high-risk, high-value, or sensitive environments. In some embodiments, the user 601 may be scanning the asset 602 at a registered/authorized location or organization associated with a parent organization of the asset 602. In other embodiments, the user 601 may be scanning the asset 602 at a location or organization not registered with the parent organization of the asset 602.

In the illustrated embodiment, the user 601 holds a mobile gateway device 601A that is actively executing an asset verification application. The mobile gateway device 601A may be implemented using any handheld computing device, such as a smartphone, augmented reality (AR) device, or wearable scanner capable of reading encoded tags, capturing biometric inputs, and communicating with a remote server over a secure connection. The mobile device 601A is shown, presenting a fingerprint icon and the word “Scan” on the display interface, which reflects a prompt for biometric authentication 603. This authentication may be completed using a fingerprint sensor embedded in the display surface, a physical button, or a dedicated biometric scanner integrated into the device 601A.

The asset 602 shown in FIG. 6 may be any physical item to be authenticated, verified, or access-restricted. The asset 602 includes a tag 602A affixed to its surface. The tag 602A is depicted as a QR code in this embodiment, but may alternatively be a Certified QR (CQR) code, a barcode, a 2D data matrix, an NFC tag, or a visual marker embedded with a unique pattern or machine-readable information. The tag 602A may encode data such as an asset identifier, a cryptographic hash, a redirection URL, or a digitally signed payload. Upon scanning the tag 602A, the mobile device 601A retrieves the encoded data and begins a validation process.

In some embodiments, the validation workflow initiated by scanning tag 602A may trigger an additional layer of security requiring the user 601 to authenticate their identity using biometric credential 603 before the scanned data is processed or submitted to a validation server. This biometric step may be performed prior to sending any network request, allowing the system to prevent unauthorized users from even initiating remote validation attempts. In other implementations, biometric authentication 603 may occur after the scan but before any asset data or profile information is presented to the user 601.

The biometric authentication 603 requested by the mobile device 601A may include fingerprint scanning, facial recognition, voice matching, iris detection, or any combination of such biometric modalities. In certain cases, the system may offer multi-modal biometric prompts to verify user identity with higher confidence. For example, a technician verifying access to a sensitive control panel may first provide a fingerprint and then perform a facial scan to complete the process.

Upon successful biometric authentication 603, the mobile device 601A may transmit a validation request comprising the scanned tag data, an authentication token associated with the verified user 601, device metadata, location data, and a timestamp to a backend verification server. The server may extract the asset identifier from tag 602A, compare it to a known asset registry, and verify that the authenticated user 601 is permitted to interact with or access the asset 602 under current circumstances. In some embodiments, the authentication token may be derived from the biometric authentication 603 and then sent to the server for verification analysis.

The use of biometric authentication 603 prior to submission of tag data increases resistance to fraudulent scanning attempts. If a malicious user were to physically obtain the mobile device 601A, such biometric gates would restrict their ability to initiate unauthorized scans without matching the required physical characteristics of the intended user 601.

In further embodiments, the user's biometric identity may be linked to a permissions matrix stored on the backend server, defining allowed actions per asset, time restrictions, location zones, or user roles. The server may then cross-reference the asset 602 scanned via tag 602A and user 601's verified identity to approve or deny access or perform further auditing actions.

The biometric prompt 603 may be dynamically triggered based on scan context. For example, if the scanned asset 602 is of high value, under transport, or has a suspicious scan history, the mobile application running on device 601A may prompt for additional biometric input regardless of user session state.

In a practical example, a government technician accessing an encrypted hard drive may scan tag 602A attached to the drive and be prompted to confirm their identity via biometric fingerprint match. Only upon successful matching of the fingerprint to a previously enrolled profile will the mobile device 601A permit the request to be sent to the cloud server.

The biometric identity captured during authentication 603 may not be stored directly, but instead may be matched locally against a securely encrypted biometric template stored within a secure enclave of the mobile device 601A. This method aligns with best practices for data protection while allowing secure identity confirmation.

The asset 602 may represent a product distributed through a controlled supply chain, such as pharmaceuticals, aviation components, or specialized test equipment. By associating user-level biometric identity to each scan, the organization managing authentication may track not only where and when an asset was scanned, but also by whom.

In another embodiment, the system may allow field operators or third-party service agents to scan assets on behalf of another account or supervisor, provided biometric authorization is confirmed and matched against a permission list preapproved by the managing entity.

The tag 602A on asset 602 may also embed a digital signature or PKI-based certificate that is decrypted during scan and used to validate tag origin. In such embodiments, biometric input 603 is used in parallel to confirm that not only is the tag valid, but the person scanning the tag is an authorized entity.

In still further embodiments, the biometric step 603 may include behavioral biometrics such as typing speed, hand pressure, or motion-based gestures detected via the gyroscope or accelerometer within the mobile device 601A.

Asset 602 may be a fixed installation such as a wall-mounted sensor, lab device, or secured compartment that is accessed only during certain shifts or intervals. In such use cases, scan logs tied to biometric validation may allow review and auditing of access compliance.

Each biometric-authenticated scan session may be uniquely logged and assigned a session ID or validation event token, which is later referenced in audit reports, incident reviews, or regulatory filings. In some cases, the fingerprint-based biometric prompt 603 may be replaced with secure PIN input when biometric scanning fails, enabling continued access but reducing trust level scores.

The system 600 may be configured so that certain scan workflows require dual-authentication. For example, both the scanning technician and a supervising officer may each present biometric credentials before the mobile application authorizes submission of scan data. In another example, the mobile device 601A may request biometric confirmation to unlock only specific functions within the application-such as enabling tag re-assignment, tag deletion, or comment entry-following a standard scan.

Organizations using the system 600 may define global or context-specific rules for when biometric authentication 603 is triggered, such as after a set period of inactivity, at defined geographic coordinates, or upon detection of a risky scan pattern.

The prompt display shown on the screen of the mobile device 601A may also include visual cues, such as animation or color change, to signal to the user 601 whether the scan is in progress, completed, or awaiting biometric confirmation. The mobile device 601A may also retain a local encrypted record of biometric-validated scan events, which are batch-uploaded to the server when connectivity is restored.

In the event of unauthorized use attempts, such as failed biometric matches, the application may alert administrators or automatically revoke the scanning privileges of the device 601A until re-authorized.

The scan data from tag 602A, combined with user authentication 603, may also be used to generate digital certificates of possession, associating a given person with a given asset scan at a particular time and place. In industrial environments, system 600 may be deployed across factory lines, where shift workers scan assets, authenticate with biometrics, and confirm machine configurations or inventory transitions.

The biometric scan event may be combined with geolocation confirmation to form a three-factor authentication, verifying asset, user, and location before access or transaction is permitted. In some embodiments, mobile device 601A may support third-party authentication platforms (e.g., SSO, federated ID) which are initiated after local biometric validation is passed. If device 601A is shared among multiple workers, biometric step 603 facilitates that the application cannot be used anonymously, enabling traceability per scan event.

The asset 602 may also include internal sensors (e.g., temperature, motion) that log environmental data alongside each user-verified scan to offer full audit trails. Biometric authentication 603 may also allow system 600 to prevent bulk scan spoofing, where cloned tags are rapidly scanned to pollute validation logs with fake entries. The fingerprint prompt 603 may additionally serve to unlock encrypted portions of the asset metadata retrieved from the tag 602A, such as warranty, ownership, or diagnostic fields.

In environments such as airports, data centers, or laboratories, the combination of physical tag scanning and biometric user validation reduces risk of unauthorized entry or handling. System 600 may also support a privacy-protected audit model, where user identities are pseudonymized, but scan verification integrity remains auditable. The user 601 may be notified of their own biometric-based scans with summaries, warnings, or success notices to reinforce correct application us.

Multiple biometric identities may be registered per device 601A for shared-use environments, with access rules segmented by user role, such as technician vs supervisor. By requiring biometric confirmation for scans like that of tag 602A, misuse of lost or stolen devices 601A is minimized, particularly where assets 602 are of high monetary or operational value.

In retail settings, such as luxury goods counters, scan-and-verify flows with biometric authentication support in-store authentication or anti-fraud checkouts. The biometric authentication step 603 may be temporarily bypassed under “emergency mode,” subject to later audit and managerial override.

The presented architecture of system 600 creates a fusion of digital identity and physical validation, enabling comprehensive security for enterprise and consumer verification workflows. This biometric-driven workflow also empowers compliance with policies requiring not only authentication of an object (asset 602) but also verification of its human operator (user 601). As new mobile operating systems advance their biometric capabilities, the asset verification application on device 601A may continuously benefit from increased speed, accuracy, and security.

Refinements to system 600 may include biometric prompts adaptive to environmental conditions—e.g., enabling iris scan in gloves-on environments. In implementations where data protection regulations apply (e.g., GDPR), biometric data may be processed entirely on-device with no central storage, meeting policy constraints while preserving functionality.

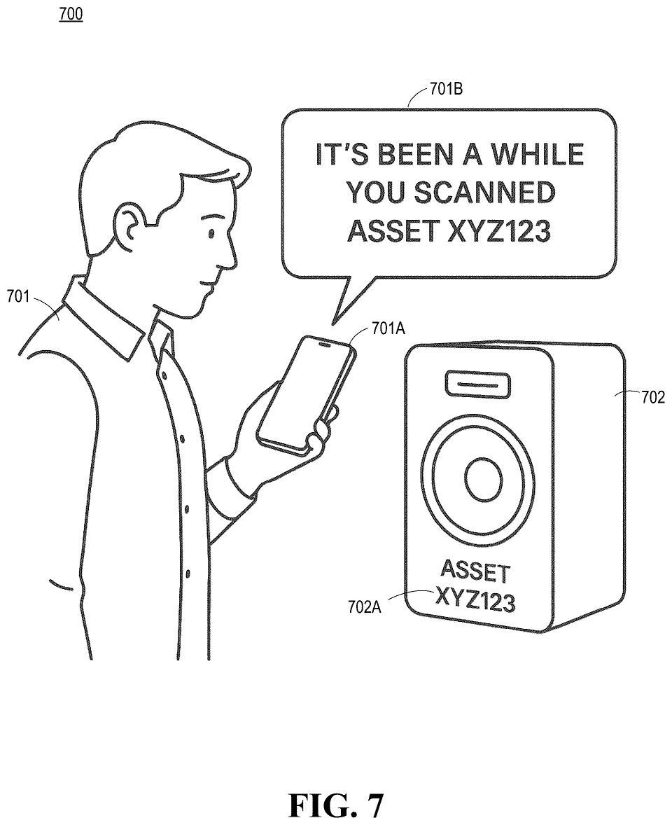

Referring now to FIG. 7, an example of a periodic asset verification system 700 is illustrated, wherein a verification prompt 701B is generated on a user device 701A, reminding a user 701 to rescan a previously validated asset 702 to maintain continued validation and monitored possession, in accordance with some embodiments of the present disclosure. The system 700 addresses a situation where an asset 702 that has been previously scanned and verified by the user 701 is subsequently stolen or transferred without authorization, and yet remains falsely treated as verified due to a lack of ongoing validation requirements.

In the illustrated embodiment, the user 701 is holding the gateway device 701A, which may be a smartphone, a tablet, or another mobile computing device capable of executing a verification software application. The device 701A displays a notification 701B, indicating a system-generated reminder that it has been a period of time since the user 701 last scanned the asset 702. The asset 702 shown in FIG. 7 is represented as a speaker-like device with a visible identifier “ASSET XYZ123” and a tag 702A affixed to its surface. The tag 702A may be a QR code, Certified QR, NFC tag, barcode, or similar scannable label encoding asset-specific data.

The periodic prompt 701B serves as a mechanism to request re-validation from a previously authenticated user 701 to confirm that the asset 702 is still in their possession and being used legitimately. In some embodiments, the system 700 may schedule such prompts based on fixed time intervals, such as daily, weekly, monthly, or custom-configured periods. The prompt 701B may be generated automatically by a remote server that monitors scan history or by the local application executing on the device 701A.

In some embodiments, after a successful verification of asset 702 via tag 702A, the server may store an association between the asset ID 702A and the user ID corresponding to user 701. If the user fails to revalidate the asset 702 within the configured period, the server may flag the asset as “validation expired” and issue reminders to the user. In such a case, the asset 702 may still appear as verified in legacy logs, but real-time interactions would show its status as pending re-validation.

To support configurable security policies, organizations deploying system 700 may define re-verification schedules per asset class. For example, high-value assets such as portable industrial devices, medical instruments, or secure communication terminals may require re-validation every 48 hours, while general consumer items may only require monthly re-checks.

The prompt 701B displayed on the device 701A may take the form of a notification banner, pop-up alert, audio signal, or vibration pattern. It may include contextual language such as the time elapsed since last scan, the asset name or type, and options to initiate a new scan or delay the verification.

The system 700 may record the exact timestamp when each periodic prompt 701B is issued, whether the user responded by scanning tag 702A, and the result of the re-validation attempt. These records may be used to generate audit logs, detect behavioral anomalies, or enforce organizational compliance policies.

If a legitimate user 701 responds to the prompt 701B and rescans tag 702A, the system 700 may update the scan history in its backend database and reset the periodic scan timer. If the user fails to respond, the system may begin escalation procedures.

In some embodiments, failure to scan asset 702 after a prompt 701B may trigger status downgrade actions, such as deactivating features of the asset, revoking software access, or sending escalation notices to administrators or compliance officers.

The verification prompt 701B may be location-aware. If the user 701 is detected within a safe or pre-approved zone, the frequency of periodic prompts may be reduced. Conversely, if the user travels to a high-risk or unfamiliar location, the system may accelerate the re-verification interval.

In another embodiment, the periodic prompts such as 701B may include a countdown clock, indicating the time left before the asset 702 is flagged as unverified. This creates urgency for the user 701 to comply with the prompt.

The prompt 701B may also include biometric re-authentication, whereby the user must first verify their identity using fingerprint, facial scan, or voice before performing the asset scan. In some implementations, system 700 may support hierarchical ownership. For example, the asset 702 may be assigned to a team rather than an individual. In such cases, re-verification may be permitted by any authorized team member, provided the system logs user credentials at the time of the scan.

The asset tag 702A may also include anti-tampering features that record physical changes to the tag or its housing. If the tag appears damaged or duplicated during re-verification, the system may block the asset. The system 700 may include logic for determining when multiple failed re-validation attempts indicate possible theft. For example, if three re-scan attempts are performed from unrelated locations or unauthorized devices, asset 702 may be flagged as compromised.

A lockout function may be triggered if a predetermined number of failed verifications is detected. For example, after five unsuccessful attempts to scan asset ID 702A, the system 700 may block any further validations and issue a warning that asset 702 has been disabled pending administrative review. In some embodiments, the user 701 may manually mark an asset 702 as stolen using the application on device 701A. This process may require the user to confirm their identity via authentication mechanisms before flagging asset ID 702A as compromised. Once flagged as stolen, asset 702 may be added to a global blocklist. Any subsequent attempt to validate tag 702A on any device triggers an alert to the system administrator and may display a warning such as “Asset Flagged as Stolen” to the scanning user.

The system 700 may maintain a registry of flagged assets, where each entry includes asset ID 702A, date of last scan, reporting user, status flag, and notes or supporting documentation submitted during the reporting process. If a stolen asset 702 is recovered, the rightful user 701 may be required to perform a re-verification and submit supporting identity documents to unblock the asset.

The prompt 701B system may include adaptive algorithms that adjust prompt frequency based on user behavior. If the user 701 has consistently validated the asset 702 over time, the system may gradually increase the re-verification window. In retail or rental scenarios, periodic prompts like 701B may be used to confirm continued possession of rented items. If the asset is not re-validated by the customer within the agreed period, late return penalties may be triggered.

Organizations implementing system 700 may visualize scan compliance metrics across users. Dashboards may indicate users who routinely ignore prompts 701B or repeatedly fail scans, helping to identify training needs or security risks. If the user 701 receives a prompt 701B and intentionally ignores it, the system may allow limited grace periods, after which the asset 702 may be disabled or suspended. The verification application on device 701A may allow users to snooze prompts or request verification extensions, provided such actions are audited and managed under policy-defined limits.

System 700 may be extended to integrate asset usage data. For example, if the asset 702 is equipped with sensors, the system may correlate usage activity with scan timing to determine if prompts are being ignored during unauthorized use. The asset tag 702A may also be dynamic in nature, such as an e-ink or programmable tag that changes display after successful verification, providing visual confirmation of re-validation status.

If asset 702 includes network connectivity, it may independently report scan status or prompt user 701 through its own interface if overdue for verification. System 700 may integrate with GPS or indoor positioning systems to validate the current location of the asset 702 during re-verification and compare it with expected zones. Each re-verification event may be assigned a unique transaction ID, digitally signed, and stored for long-term auditability.

In some embodiments, the prompt 701B may allow the user 701 to attach a contextual photo or comment with the scan, adding proof-of-presence or condition verification. Periodic verification logic in system 700 may apply to both owned and leased assets. In a leasing model, re-validation provides accountability for items under temporary custody.

The server backend may include an anomaly detection engine that flags unexpected scan intervals, repeated prompt dismissals, or unusual response patterns. Each asset 702 may be linked to a policy profile defining the frequency and response requirements for prompts 701B, enabling tailored compliance enforcement. User device 701A may also receive reward incentives for timely scan compliance, encouraging consistent user engagement with system 700.

In educational settings, periodic prompts 701B may track return of loaned devices, such as tablets or lab kits, helping institutions monitor usage and minimize losses. In large fleets, prompts 701B may be coordinated across hundreds of devices, prompting regional users to confirm physical presence of their assigned assets.

If the asset 702 is used in fieldwork, such as survey kits or mobile routers, re-verification logs help build a location trail for compliance, security, and recall purposes. To enhance privacy, system 700 may store only abstracted metadata of prompt responses, without capturing sensitive location or biometric data unless explicitly permitted.

System 700 may further include automated escalation rules whereby failed re-verifications are routed to supervisors or compliance teams with contextual event history. In some deployments, system 700 may use environmental context (e.g., accelerometer data, movement logs) to determine if assets have remained stationary for too long, triggering prompts proactively. In combination with asset usage monitoring, re-verification helps validate both possession and utilization, supporting audit readiness and operational transparency.

The verification application on device 701A may allow users to view a history of their past re-validations, upcoming prompts, and outstanding scan obligations. If integrated with organizational identity systems, user 701's profile may be updated in real time to reflect compliance with verification prompts 701B, enabling access to higher-tier asset classes.

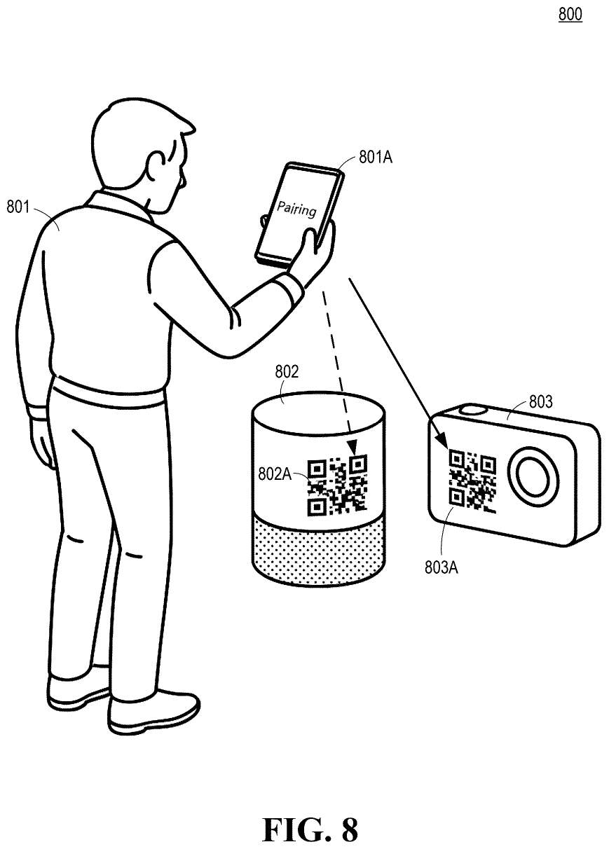

Referring now to FIG. 8, an exemplary system 800 illustrates pairing two or more devices with each other using a mobile device, wherein the pairing is based on multimodal verification of tags associated with each device, in accordance with some embodiments of the present disclosure. The system 800 includes a user 801 who interacts with a mobile gateway device 801A to initiate and complete the pairing process between a first device 802 and a second device 803. The pairing process is performed by scanning a first tag 802A affixed to the first device 802 and a second tag 803A affixed to the second device 803. The gateway device 801A may execute a verification software application that allows for asset scanning, multimodal validation, and secure pairing procedures.

In the illustrated embodiment, the first device 802 may be a wireless speaker and the second device 803 may be a media player. These devices are intended to operate together in a functional configuration, such as playing audio transmitted from the player to the speaker. However, to prevent fraudulent or unauthorized devices from connecting, the system 800 performs verification on both the first tag 802A and the second tag 803A before establishing the pairing.

The tags 802A and 803A may include various encodable formats such as QR codes, certified QR (CQR) codes, NFC tags, barcodes, or other scannable elements, each comprising unique identifiers, cryptographic hashes, authentication tokens, or redirection URLs. Each tag serves as a secure identity anchor for the respective device. The scanning of these tags by gateway device 801A enables the system to extract encoded data and initiate validation requests.

Upon scanning the first tag 802A using gateway device 801A, the mobile application may extract the asset ID of the first device 802, along with a hash value generated at manufacturing or provisioning time. This data is then temporarily stored or submitted to a remote validation server, which verifies the authenticity of the first device 802.

Following the successful verification of the first tag 802A, the user 801 may proceed to scan the second tag 803A located on the second device 803. The second scan yields another set of identity and integrity data, which is similarly validated by the system.

Once both devices 802 and 803 have been verified as genuine and registered assets in a trusted database, the gateway device 801A proceeds to complete the pairing operation. This may include the generation of a mutual association record between the two device IDs and the creation of a digital pairing certificate.

In some embodiments, the pairing certificate may be stored locally on both devices 802 and 803 or remotely on a cloud server, where future attempts to operate the devices together can be cross-referenced for pairing validity.

The verification server may additionally apply context rules during the pairing process. For example, if either of the devices is currently marked as compromised, flagged for recall, or previously associated with a blocked account, the pairing request may be denied.

In certain implementations, the system may also validate that the devices 802 and 803 are from the same manufacturing batch, model generation, or certification class before pairing is permitted. This adds a further layer of control over compatibility and counterfeit detection.

To secure the pairing event, the gateway device 801A may also associate the identity of the user 801 with the session, such as by requiring biometric or passcode authentication. This association allows later audit of who initiated the pairing and under what context. In some use cases, the paired devices 802 and 803 may transmit encrypted communication keys to each other upon pairing. These keys are generated only after successful verification of both tags 802A and 803A.

The pairing process shown in system 800 helps prevent scenarios in which a counterfeit media player 803 is used to control a legitimate speaker 802, potentially damaging brand reputation or user experience. Beyond speaker and player combinations, the system 800 may be employed to validate and pair various combinations of connected devices such as controller-sensor pairs, medical equipment with handheld interfaces, or access control readers with encrypted ID cards.

As an example, a validated infusion pump (first device 802) may be paired only with a genuine touchscreen controller (second device 803), scanned and paired by a technician 801 using a hospital-issued mobile device 801A. The pairing function may also be time-limited or context-bound. For example, a device pair may remain valid for only a specified number of sessions, hours, or geographical zones, configurable by backend policy.

Each successful pairing operation may be logged in a remote database, including device IDs, user ID 801, timestamp, and location of pairing. These records support future auditing, troubleshooting, or warranty enforcement.

In some embodiments, if a previously paired device pair (802 and 803) is later found to be involved in a security breach, the system may retroactively disable the pair by pushing a revocation signal to either or both devices. The tag validation process may also include visual confirmation, where each device displays a confirmation code or LED indicator once verified, enabling the user 801 to visually verify successful pairing.

The mobile device 801A may be configured to display step-by-step guidance during the pairing process, such as “Scan First Device,” “Scan Second Device,” and “Pairing Complete,” with accompanying progress indicators. In some scenarios, the user 801 may scan multiple devices in sequence using device 801A to create a group pairing. For example, a speaker 802, player 803, and remote controller may be grouped into a single interoperable unit. Paired devices may be locked to a particular account or enterprise identifier, such that they do not function in unauthorized environments or after unauthorized resets.

The pairing process depicted in FIG. 8 also protects against cases of mixed authenticity, where one genuine device is paired with a non-genuine device. The validation server denies such requests unless both device tags 802A and 803A are verified. Pairing logic may also validate version compatibility between devices 802 and 803, disallowing pairings between mismatched firmware or incompatible protocol stacks. System 800 supports batch pairing, where a verified user 801 scans multiple sets of devices for enterprise deployment, associating each pair for field usage.

In educational institutions, verified student-issued tablets may be paired with specific lab instruments using system 800 to track usage and prevent theft. In defense applications, verified encrypted radios may be paired with assigned operator terminals after tag verification to maintain communication security.

The verification of tags 802A and 803A may be enhanced with tamper-detection features, which alert the gateway device 801A if a tag appears altered or damaged. Once paired, devices 802 and 803 may periodically check pairing integrity using heartbeat signals validated against the pairing certificate.

System 800 may support remote unpairing, where an administrator triggers disassociation of devices 802 and 803 via backend interface, disabling their cooperation. In consumer electronics, product registration during pairing can be streamlined, collecting user info, device specs, and warranty activation in a single flow. If pairing is attempted using invalid or duplicated tags, the server may alert manufacturer fraud teams or initiate anti-counterfeit protocols.

System 800 supports multilingual prompts and accessibility features on device 801A, improving usability in global and diverse settings. The pairing certificate may be cryptographically signed and include timestamps, location data, user metadata, and device identifiers for authenticity. In autonomous vehicle fleets, verified pairing of sensor modules and control units using system 800 prevents assembly-line errors and enforces compliance.

Device pairing may also be initiated by NFC tap-to-scan, BLE handshake, or secure QR scan modes, depending on deployment conditions. For field devices lacking displays, pairing status may be communicated via LED flashes, vibration motors, or audible tones after tag validation. The gateway device 801A may support offline pairing, caching verification data and syncing with the backend server when connectivity is restored.

In scenarios involving device returns, pairing logs can verify original configuration and usage context, supporting reverse logistics and refurbishment. To enhance security, system 800 may employ location geofencing, denying pairing requests unless both devices 802 and 803 are in the same approved region. Paired devices may negotiate mutual cryptographic keys validated by the backend server to prevent spoofing or man-in-the-middle attacks post pairing. Device pairing based on tag verification promotes secure plug-and-play assembly in smart home, industrial automation, and logistics systems.

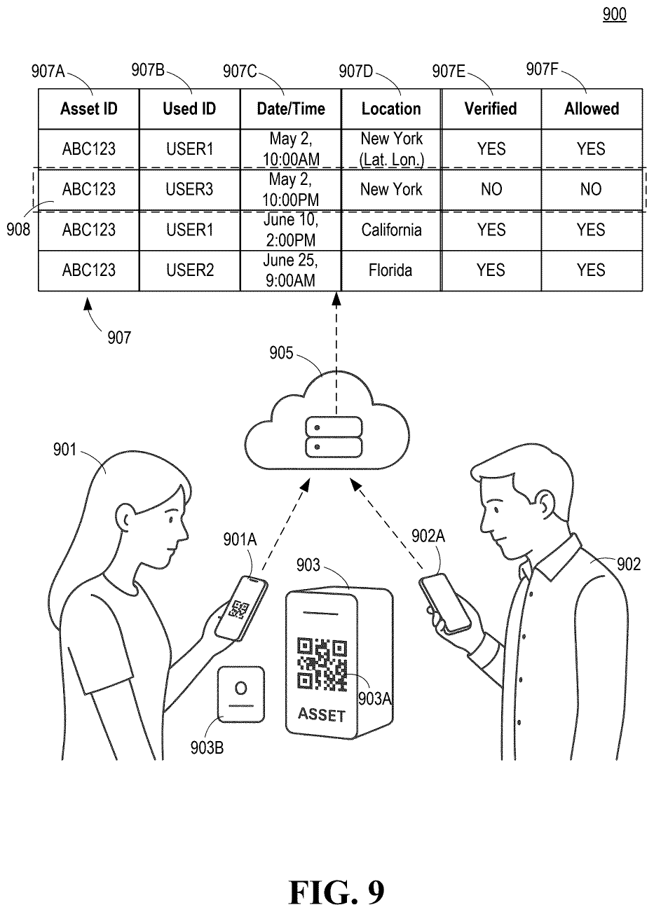

Referring now to FIG. 9, an exemplary system and method (900) is illustrated for validating an asset 903 through scans performed by multiple users 901 and 902 using separate mobile gateway devices 901A and 902A, in accordance with some embodiments of the present disclosure. The illustrated system 900 enables shared access to a tagged asset 903 by more than one authorized user under a predefined organizational policy. The asset 903 may include a multimodal tag 903A, which may take the form of a certified QR code, an NFC tag, an RFID device, or an external ID device. The system permits access control, scan-based verification, and multi-user traceability in enterprise and distributed environments.

In the depicted example, a first user 901 and a second user 902 both interact with the asset 903 and independently scan the multimodal tag 903A using respective gateway devices 901A and 902A. The verification software operating on these devices generates respective POST requests comprising tag scan data, user identity tokens, and contextual metadata such as location and timestamp. These requests are transmitted to a remote validation server 905 for processing.

The server 905 comprises a verification engine interfaced with a structured database containing a log table 907. Each POST request received from gateway devices 901A and 902A is parsed and logged into this table, which tracks verification history, user associations, and authorization status per scan. The fields in table 907 include asset ID 907A, user ID 907B, scan date/time 907C, scan location 907D, verification result 907E, and access permission outcome 907F.

In some scenarios, organizational policy may define multiple valid users for a single asset 903, such that both the first user 901 and the second user 902 are granted access or verification rights. For example, the asset 903 may be a shared field device such as a medical diagnostic unit, a rugged tablet, or a mobile data acquisition terminal issued by an organization to multiple team members.

The log table 907 shown in FIG. 9 provides evidence of this multi-user access structure. In the first row, USER1 is recorded as scanning asset ID ABC123 in New York at 10:00 AM on May 2, receiving both a successful verification (YES in 907E) and access permission (YES in 907F). The third row shows the same user scanning again from California, similarly receiving successful verification and access.

The second row, however, reveals that USER3 attempted to scan the same asset ID ABC123 from the same location (New York) on May 2 at 10:00 PM. Although the scan may have occurred at the same geographic location, the verification result was NO (907E) and access permission was denied (NO in 907F), indicating that USER3 is not an authorized user for that asset, regardless of location.

The fourth row depicts USER2 scanning from Florida on June 25 at 9:00 AM and receiving successful verification and access. This illustrates that geographical proximity alone is not a valid indicator of access rights; the decision logic resides in the backend server 905 and depends on user-role mappings maintained by the organization.

Each scan performed by users 901 and 902 is uniquely identified by a POST request and is independently validated. Even when the same asset tag 903A is scanned multiple times, the system uses the combination of asset ID, user ID, and contextual metadata to determine validity.

In some embodiments, an asset administrator such as user 901 may have permission to register additional users to a given asset. For example, after validating their own access via a scan of tag 903A, user 901 may navigate within the verification application to assign user 902 temporary or permanent access rights.

The registration of new users may require additional authentication, such as biometric confirmation, PIN entry, or access to a pre-assigned digital certificate. Once verified, user 902 may be added to an allowlist in the server 905's database.

Asset 903 may represent a hardware device managed by a corporate IT system. Once a new user is registered, they may be granted read or write permissions depending on their role. For example, some users may only query asset configuration, while others may update firmware or perform diagnostics.

In the depicted embodiment, asset 903 also includes a secondary tag 903B, which may not be physically affixed to the asset. This portable tag may reside with the team lead, issued as a digital keycard, or carried on a key fob. The tag 903B is scanned within a predetermined window in conjunction with tag 903A.

This dual-tag scanning creates a two-factor asset verification process. The system checks for the presence of both tag 903A (affixed to the asset) and tag 903B (portable and authorized), and verifies that both have been scanned within a defined time interval, such as 60 seconds.

If tag 903A is scanned without tag 903B, the system may issue a conditional warning or deny verification. This functionality prevents misuse of the asset even when tag 903A is cloned, as pairing with 903B is mandatory for completion.

The secondary tag 903B may be linked to a specific user, team, location, or operational schedule. When scanned, its data is transmitted to the server 905 and matched against known access criteria.

In some configurations, tag 903B may rotate or change per shift or project, making unauthorized replication difficult. For example, each morning the supervisor is issued a dynamic tag 903B with encrypted validity, which must accompany asset scan requests throughout the day. Secondary tags like 903B may be implemented using programmable NFC devices, encrypted QR codes, or rotating digital signatures generated by a secure mobile application.

In a warehouse scenario, asset 903 may be a forklift tagged with 903A, while 903B is a badge carried by authorized operators. Only when both the vehicle and badge are scanned within proximity will operation be allowed. The combination of user-specific access rights and physical token pairing improves asset security across various industries including logistics, defense, medical services, and education. System 900 may support delegation rights, where user 901 may not only register user 902 but also define their scope of access, such as valid scan hours, zones, and functionality tiers. Backend policy engines operating on server 905 may use logic scripts or access control lists to determine allowed users per asset, asset groups, or usage modes.

In some embodiments, access logs from table 907 may be streamed to external analytics tools for compliance reporting, user behavior modeling, or predictive maintenance. Every user and scan event may be cryptographically signed to prevent forgery or tampering, and integrity verification may be performed prior to entry into table 907. System 900 may support group-based access, where an asset 903 is accessible to all users belonging to a defined team or department, eliminating the need to register individuals. The verification logic may also incorporate device fingerprinting. If user 902 attempts to scan from a device never previously registered, server 905 may flag the attempt.

If an unauthorized scan such as that by USER3 (908) is detected, the system 900 may notify administrators via SMS, email, or push notification, or initiate automatic lockdowns. The table 907 may also include additional columns such as scan method (QR vs NFC), session token ID, or confidence score of biometric match, enriching validation granularity. For high-risk assets, the system may require simultaneous scanning of 903A and 903B by two different devices held by different users, adding co-validation security.

Secondary tag 903B may also be associated with limited lifespan, self-expiring after a defined number of uses or time window, reducing potential for misuse. System 900 may visualize relationships between users and assets as a graph, with node connections updated in real-time based on registration and scanning activity.

In educational environments, students 901 and 902 may scan to check out lab equipment 903, with tag 903B carried by a supervising faculty member who co-validates the access. In emergency services, paramedics may validate portable medical kits using dual tag scans of equipment and issued digital keys, preventing unauthorized substitution.

If tag 903A is cloned and reused by unauthorized parties, system 900 detects repeated user ID mismatches and geographic anomalies in table 907, prompting investigation. In construction, tools 903 may be tagged with 903A and accessed only if the contractor holds a project-specific NFC wristband 903B. Users such as 901 and 902 may be issued QR code credentials to access online dashboards that reflect their scan history, assigned assets, and pending authorizations. For mobile assets such as drones or field sensors, tag 903B may be carried by certified technicians, creating a virtual keyring linked to identity and role.

In some embodiments, if asset 903 has embedded connectivity, it may self-report when scanned by an unauthorized user, creating closed-loop monitoring. If multiple unauthorized users attempt to scan asset 903 within a short time, server 905 may temporarily disable all verifications for that asset and mark it as under review. The design of system 900 allows flexible multi-user management while preserving granular control, visibility, and security over each scan and validation event.

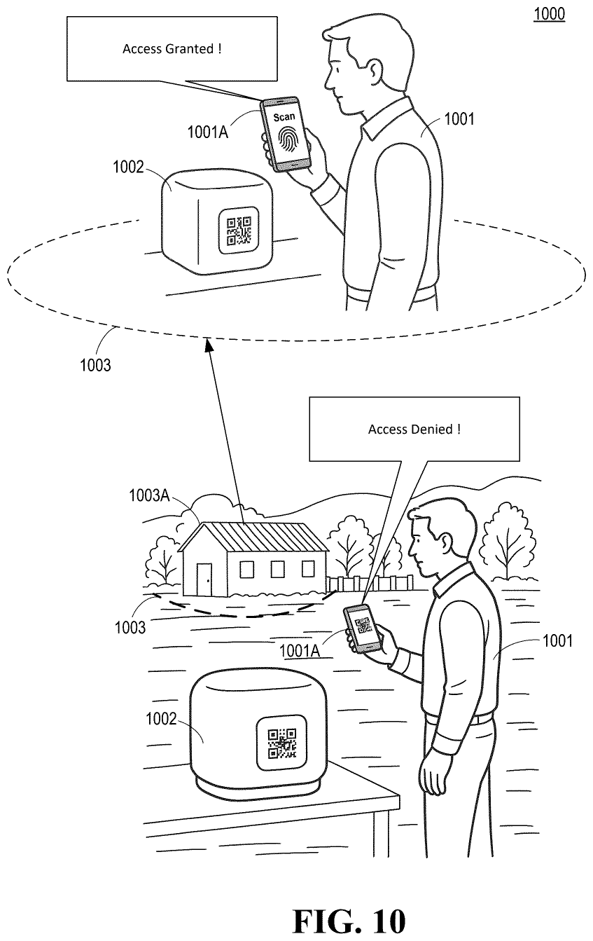

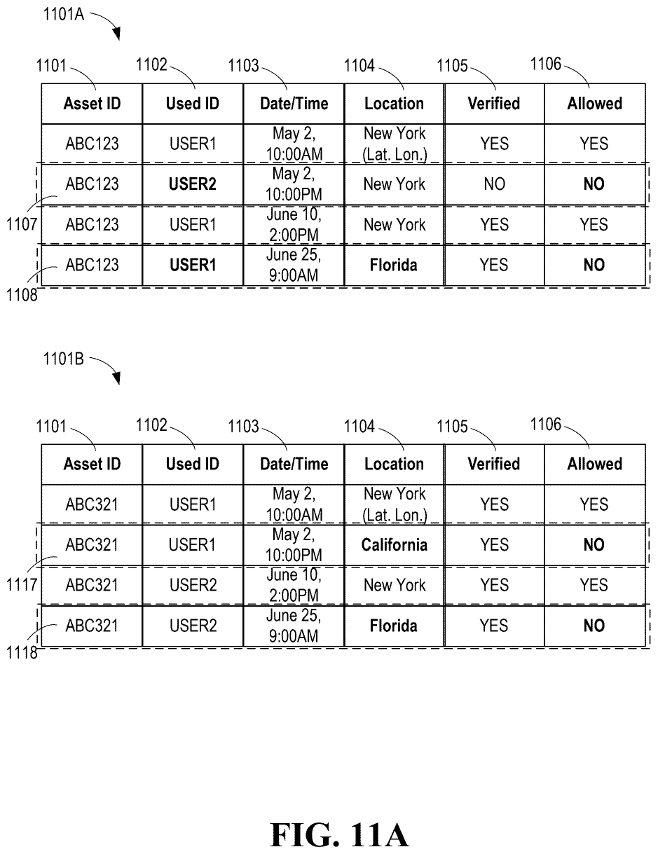

Referring now to FIG. 10, an exemplary system 1000 and method are illustrated for verifying an asset that is location-bound (e.g., within a child organization's building), in accordance with some embodiments of the present disclosure. The system 1000 includes a user 1001 interacting with an asset 1002, which is embedded with a tag. The tag may be a QR code, Certified QR (CQR), NFC tag, barcode, or external ID component that facilitates the initiation of the asset verification process via a gateway device 1001A. In the present system, verification outcomes depend not only on the authenticity of the asset 1002 and identity of the user 1001, but also on whether the scan occurs within a designated geographic boundary 1003.

In the upper half of FIG. 10, the user 1001 is depicted initiating a scan using the gateway device 1001A while being present within a predefined location perimeter 1003. This location 1003 may be defined as a geofence-a virtual perimeter implemented using GPS coordinates, Wi-Fi positioning, or beacon triangulation. The system detects the gateway device 1001A location via built-in positioning modules and compares it to the authorized boundary 1003. Upon successful match, the system renders an “Access Granted!” response, indicating that the scan is valid and the user 1001 may proceed to interact with the asset 1002.

The lower half of FIG. 10 illustrates the same user 1001 scanning the asset 1002 from outside the geofenced location 1003. Here, the location is shown relative to a physical structure 1003A, such as a home, office, school, or factory. Since the gateway device 1001A is now outside the geofenced region 1003, the system renders an “Access Denied!” message, denying the scan event regardless of user or asset validity.

The geofence 1003 may be associated with any operational environment or physical facility. In some embodiments, it may surround a residential home where a user 1001 manages access to smart appliances, such as the asset 1002 representing a connected speaker, thermostat, or backup power unit. The geofence prevents operation or configuration of such devices outside the registered home perimeter.

In another embodiment, the geofence 1003 may enclose an educational institution such as a university campus. The asset 1002 may represent a lab-grade measurement instrument or teaching apparatus, permitted to operate only when scanned within school premises.

A similar application may be found in industrial contexts, where the geofence 1003 encapsulates a warehouse or factory. The asset 1002 may be a sensor node, material handling robot, or controller, scanned and configured only when present within factory-defined zones.

The system 1000 may define geofences using polygons, circles, or complex shapes depending on facility layout. Each geofence may have multiple entry points and perimeter thresholds, adjustable by the asset management authority.

To detect presence within location 1003, the gateway device 1001A may use its onboard GPS module to retrieve latitude and longitude values. These values are then compared by a server-side engine to those of the geofence 1003. In some embodiments, the asset 1002 itself may include embedded location reporting modules. If the asset is mobile and equipped with GPS, it may transmit its own coordinates during a scan request, enabling dual-source location validation.

Access control decisions in system 1000 may depend on both static (gateway location) and dynamic (asset-reported) location inputs. A mismatch between the two may raise suspicion or trigger additional validation layers. The tag embedded in the asset 1002 may encode an asset identifier, a geofence ID, and a hash of permissible scan regions. When decoded by the gateway device 1001A, these values may be used to validate presence within an authorized area.

In one example, a medical professional attempting to access/verify a sterilized surgical instrument (asset 1002) tagged with a CQR is prompted for both biometric authentication and verified presence within a hospital operating room defined by geofence 1003. A failure to meet geofence 1003 conditions results in denial of access even if the user 1001 and the tag scan are otherwise valid. This protects asset operation and data access based on physical presence.

In retail and rental applications, system 1000 can restrict product use to specific vendor zones. An e-scooter (asset 1002) may be usable only inside a geofence 1003 representing an urban deployment boundary. Access responses may vary based on geofence proximity. While direct access is granted within 1003, users slightly outside may receive a soft warning indicating proximity to a valid zone. In high-security implementations, access outside of geofence 1003 may trigger escalation events. These may include email alerts to administrators or real-time lockdown of the asset 1002.

Organizations managing multiple sites may use geofence 1003 profiles to manage regional access to fleet assets. Each asset ID may be mapped to a list of valid geofences stored centrally. A backend validation engine may track scan frequency per geofence, identifying patterns such as repeated invalid scan attempts from outside location 1003. The gateway device 1001A may cache geofence data locally to support offline scanning, and once online, the system reconciles all scan events with live coordinates.

Assets 1002 may report whether their current scan is within the expected geofence using internal sensors. A mismatch between gateway and asset locations indicates potential tampering or relocation. Access results such as “Access Granted!” or “Access Denied!” may be logged with timestamp, user ID, asset ID, scan location, and geofence ID for forensic and compliance records.

System 1000 supports policy profiles where different users receive different geofence permissions for the same asset. For example, user 1001 may access the asset from a primary location, while a supervisor may override from elsewhere. Multiple geofences may be associated with one asset 1002. For example, a mobile testing unit may be authorized at several registered facilities defined by separate geofence identifiers.

The structure 1003A shown in FIG. 10 represents a point of reference that anchors the geofence 1003. This may be manually defined using GIS tools or automatically derived from satellite imagery. System 1000 may provide users with visual maps highlighting their current location relative to geofence 1003 to aid in compliance during field operations. Asset-specific geofence constraints may be encoded dynamically during tag provisioning. Tag 1002 may include a timestamped signature binding its operation to specific time/location pairs.

If asset 1002 is relocated improperly and scans continue outside of geofence 1003, system 1000 may automatically deactivate the asset 1002 or place it in restricted mode. In disaster response or emergency use, the geofence 1003 may be temporarily disabled by authorized override via secure admin interface. This is logged for audit. Each geofence 1003 may include a unique ID or name, helping administrators manage access at scale across multiple zones, assets, and users.

System 1000 supports geofencing in rural areas using satellite and mobile network triangulation for more reliable detection compared to GPS alone. User 1001 may receive audio or haptic feedback on gateway device 1001A based on proximity to geofence 1003 before a scan is attempted, aiding usability. The verification software may include timers that enforce maximum duration for scans outside of valid zones, e.g., allow temporary access outside geofence for 10 minutes only.

Combined with time-of-day rules, geofence 1003 can allow access during working hours only within designated facilities. Location context may be combined with usage mode. For example, read-only access may be allowed outside of geofence 1003, while configuration mode is restricted to inside. System 1000 may provide audit maps plotting asset scan events against authorized geofences to detect anomalies in deployment or usage.

Each scan denied due to geofence mismatch may generate a security flag associated with that user, helping to detect policy breaches over time. User-specific allowances may be geofenced to different levels. A technician may have broader geofence access than a contractor. Assets 1002 may support dynamic geofencing based on operational lifecycle. For example, during shipment, geofence expands; once deployed, geofence 1003 becomes strict.

Some assets 1002 may include BLE beacons as location anchors, providing more granular indoor location validation within a warehouse or hospital wing. Geofence-related access decisions can also feed machine learning systems to optimize asset placement, detect underuse, or predict logistical challenges.

If geofence 1003 is breached multiple times, the system may trigger revocation of user credentials associated with repeated violations. User 1001's scan behavior within or outside geofence 1003 may contribute to a trust score that affects future scan validation logic. System 1000 may be integrated with external mapping systems for real-time tracking and enforcement of geofencing at global scale.

In some embodiments, two or more tags associated with a single asset may include respective hash codes that are logically coupled to each other. For example, a Certified QR (CQR) code and an NFC tag affixed to the same asset may each encode a distinct hash code that is cryptographically linked via a shared seed, derivation rule, or interdependent structure. The server may maintain a pairing record for such tags, wherein hash A (from the CQR tag) is expected to correspond with hash B (from the NFC tag) for a specific asset ID. During verification, the gateway device may scan one or both tags and transmit both hash codes to the server, where the backend logic checks not only for individual hash matches but also validates the internal correlation between the two hashes.

This coupling approach enhances security by reducing the risk of tag cloning or substitution. For example, if a counterfeiter reproduces the CQR code alone, but fails to pair it with a valid NFC hash code, the system may detect a mismatch in the coupled hash relationship and classify the asset as counterfeit. In some implementations, the two hash codes may be derived using a shared key and salt, with different input positions, such that their validation requires successful decryption or verification of both.

In further embodiments, the server incorporates an AI engine configured to learn movement patterns of the asset over time. As verification data accumulates across users, locations, and timestamps, the AI engine builds a behavioral profile for the asset that includes typical scan times, authorized users, geographic mobility range, and scan frequency. Using this learned model, the AI engine dynamically adjusts thresholds for acceptable movement between locations or time windows. For example, if an asset is historically scanned every weekday at 9:00 AM in a defined factory region, but then appears at 2:00 AM 300 miles away, the AI may classify the event as an anomaly and flag it for review.

In one illustrative example, a field technician scans both the CQR and NFC tags of a diagnostic kit using a gateway device. The hash codes are transmitted and verified against the paired entries in the server. Based on historical data, the AI engine confirms that the technician frequently verifies this asset in different factory branches across two states, with travel typically occurring in a 6-12 hour window. If a subsequent scan of the same asset occurs in a third state just 45 minutes later, the AI engine may infer logistical infeasibility and generate a warning-even if the hash codes individually validate.

Such AI-driven learning improves the system's sensitivity to context-specific movement behaviors and reduces false positives in verification decisions. The AI engine may also adapt by learning user-specific movement capabilities, such as frequent flyer behavior for traveling executives or cross-facility technicians. All movement-based insights may be used not only for verification but also for policy enforcement, asset routing optimization, and exception management.

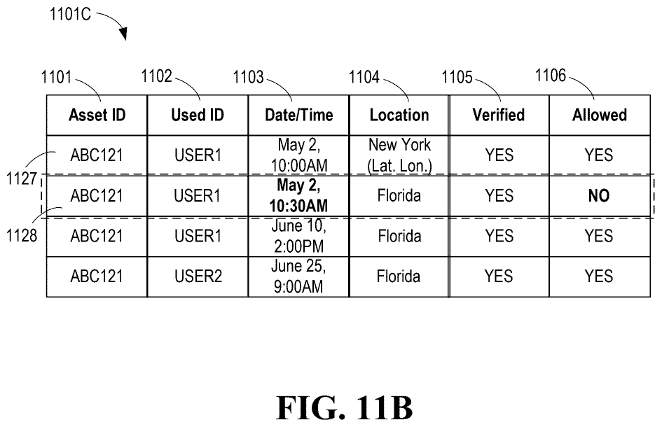

Referring now to FIGS. 11A-11B, exemplary validation tables 1101A, 1101B, and 1101C are illustrated, which may be stored, maintained, and queried by a backend server for managing scan histories and permission outcomes in accordance with various embodiments of the present disclosure. These tables reflect asset verification records involving a plurality of users and locations, and may be used by the system to evaluate the contextual eligibility of each scan request.

In FIG. 11A, the validation table 1101A comprises a plurality of fields identified as 1101 through 1106. These fields include: Asset ID 1101, User ID 1102, Date/Time of scan 1103, Scan Location 1104, Verification Result 1105, and Access Permission Result 1106. Each row of table 1101A represents a distinct asset verification event involving a specific user scanning a specific asset from a specific location at a particular time.

Table 1101A focuses on a location-bound asset identified by Asset ID “ABC123.” In this embodiment, asset ABC123 is designated by policy to be accessible and verifiable only within the geofenced location of New York. Furthermore, this asset is permitted for use exclusively by a single authorized user, identified by User ID “USER1.”

The first row in table 1101A shows a valid scan event. USER1 performed a scan of asset ABC123 on May 2 at 10:00 AM from a location identified as New York, with latitude and longitude coordinates potentially recorded as metadata. This scan was marked as Verified in field 1105 and Allowed in field 1106. This indicates that the system confirmed the authenticity of the asset, validated the identity of USER1, and determined that the scan occurred within the permitted geographic boundary for that asset.

The second row (row 1107) captures a scan attempt by USER2, a user who is not authorized to access asset ABC123. This scan occurred at 10:00 PM on the same date, May 2, from the same location-New York. Despite the location matching the authorized geofence for the asset, the system returned a result of “No” in field 1105 for Verification and “No” in field 1106 for Allowed. This demonstrates that mere location alignment is not sufficient to authorize access when the user identity does not match the approved list maintained for that asset. In some embodiments, the second row may represent an unregistered location or organization.

The third row in table 1101A shows another scan by USER1, this time from a different location: California. This scan took place on June 10 at 2:00 PM. In this case, the system recorded a “YES” in the Verified field 1105, indicating that the asset and user were both recognized, and their credentials were valid. However, the Allowed field 1106 shows “NO,” meaning that the user was operating from an unauthorized location. The system logic in this embodiment validates user and asset authenticity separately from location constraints. While USER1 is an authorized operator of asset ABC123, their scan attempt from outside the geofenced boundary of New York triggers a restriction in access.

The fourth row (row 1108) further confirms the enforcement of geolocation rules. USER1 performed another scan on June 25 at 9:00 AM from Florida. Similar to the third row, the asset was successfully Verified, but the Allowed field was returned as “NO” due to geographic mismatch. This provides a strong example of the dual-dependency logic enforced by the system, where both user identity and physical location must align with the registered policy to receive successful scan authorization.

These rows in table 1101A illustrate how the server leverages metadata collected during asset scan attempts-including user identity, timestamp, and GPS coordinates-to render access control decisions. This type of structured logging allows for enforcement of fine-grained policies for asset verification, movement tracking, and usage rights.

In some embodiments, the verification engine running on the backend server may enforce location policies dynamically. For example, during known operational hours, location sensitivity may be relaxed for trusted users, while outside of those windows, strict enforcement is maintained.

Table 1101A reflects a model useful for enterprises managing equipment, tools, or information assets that must remain in a fixed location due to compliance, safety, or logistics constraints. Examples include chemical sensors in a factory, power distribution equipment in a substation, or hospital devices bound to a specific operating room.

The data fields such as 1105 and 1106 also provide a clear audit trail for compliance enforcement. Auditors may use this data to determine if any scans were performed by unauthorized users or from non-permitted regions.

The dual control logic shown in table 1101A also enables anomaly detection algorithms. For example, if repeated failed attempts are recorded from USER2, alerts may be generated to investigate possible credential sharing or misuse attempts.

Moreover, this logging structure supports incident analysis. If asset ABC123 was tampered with, stolen, or malfunctioned, the system administrator can look up all access attempts, their timestamps, and decision outcomes to understand the chain of custody and access context.

Each scan record may further include associated scan device identifiers, such as IMEI numbers, MAC addresses, or application version numbers, enabling additional validation layers and security profiling.

Referring now to table 1101B, it illustrates a validation record for an asset identified as ABC321, in accordance with some embodiments of the present disclosure. The table 1101B is structured with multiple columns designated by headers 1101 through 1106. These columns respectively include: Asset ID 1101, Used ID 1102, Date/Time 1103, Location 1104, Verified 1105, and Allowed 1106. Each row in the table represents a historical record of a scan or verification attempt performed by a user at a specific time and geographic location.

In this embodiment, asset ABC321 is a location-restricted asset that has been assigned to multiple users, including USER1 and USER2. The authorization logic defined in the system for this asset allows access and interaction with the asset only when scanned from within a specified geofenced location—in this case, New York. Despite being authorized users, both USER1 and USER2 are limited in their rights to verify or interact with the asset outside this permitted geolocation.

The first row of the table 1101B shows that USER1 performed a scan on May 2 at 10:00 AM from a location identified as New York. The result for this scan indicates “YES” under both Verified 1105 and Allowed 1106, meaning that the identity of USER1 and the authenticity of the asset ABC321 were verified and that the scan location met the predefined geofencing requirement. This entry is consistent with the asset's configured policy, thereby allowing full access.

The second row (row 1117) shows another scan by USER1, also on May 2, but at 10:00 PM and from a different location-California. In this case, while the Verified column 1105 still reads “YES” because USER1 and the asset ABC321 are recognized and authenticated by the system, the Allowed column 1106 reads “No.” This result implies that although the identity credentials matched and the asset was verified successfully, the system rejected the attempt due to the location (or may be organization) being outside of the permitted geofence for asset ABC321. This illustrates the independent validation of user credentials and location compliance.

The third row of the table reflects a scan conducted by USER2, another authorized user, on June 10 at 2:00 PM from New York. The result is again positive across both fields 1105 and 1106, indicating that USER2 is authorized for asset ABC321 and that the scan occurred within the geofenced area of New York. This confirms that the system supports shared access for multiple users provided that the location constraints are also satisfied.

The fourth row (row 1118) shows a scan attempt by USER2 on June 25 at 9:00 AM from Florida. While the verification result under column 1105 still indicates “YES,” the Allowed column 1106 shows “No,” thereby denying access. This reinforces the system's location-enforcement logic even for authorized users. The separation of verification from allowance helps distinguish between user identity and contextual compliance, allowing more sophisticated access control.

The configuration demonstrated in table 1101B is relevant for use cases where mobile or portable assets are tied to specific deployment zones, but those assets are operated by rotating personnel. One example may be hospital diagnostic equipment designated for use only within a particular department or ward. USER1 and USER2 may be technicians authorized to operate the equipment, but only while stationed within the hospital zone. Another example includes tools or scanners used in secure government facilities, where geofencing prevents asset activation or access when carried outside secure premises.

The system generating table 1101B may utilize GPS data from the scanning device to determine scan location at the time of verification. In some embodiments, the system may cross-reference device-reported location with fixed boundaries stored in a centralized configuration database, such as a map overlay or geofence registry.

The use of granular verification and permission columns also supports audit logging and compliance reporting. Administrators can analyze patterns in this table to detect anomalies, such as multiple failed attempts by authorized users outside designated zones. It may also serve to identify cases where location access needs to be reviewed or updated, such as personnel reassignment to a new facility.

This format supports customizable policy enforcement, where each asset may have a distinct combination of allowed users and allowed geolocations. In more complex implementations, the system may also support temporal restrictions, where access is granted only during specific shifts, dates, or project phases.

In addition to displaying the final outcome of each scan attempt, the system backend may also store additional metadata, including network type (Wi-Fi, LTE), signal strength, scan method (manual or automated), and even confidence scores for user verification, to assist in forensic analysis or policy refinement.

Accordingly, table 1101B provides an advanced data structure that combines identity validation and spatial access control, enabling secure multi-user interactions with geographically restricted assets.

Moving to table 1101C, it illustrates a validation record for a movable asset identified as ABC121, in accordance with some embodiments of the present disclosure. Table 1101C includes multiple fields designated by headers 1101 through 1106: Asset ID 1101, Used ID 1102, Date/Time 1103, Location 1104, Verified 1105, and Allowed 1106. Each row in the table represents a logged verification attempt for asset ABC121 by one or more users from various locations.

In this embodiment, the asset ABC121 is not restricted to any particular location, meaning that it may be verified and accessed from multiple geographies as long as the verification request satisfies a set of broader contextual rules. These rules may be dynamically analyzed by an AI engine running on the backend server (e.g., as described in connection with FIG. 5). Unlike prior examples where geographic fencing dictated access eligibility, the AI-driven approach in this case evaluates user activity patterns, time intervals, and feasibility of movement to assess whether asset interactions are genuine or potentially fraudulent.

The first row (row 1127) in table 1101C shows USER1 successfully verifying and accessing asset ABC121 from New York on May 2 at 10:00 AM. The Verified column 1105 displays “YES” and the Allowed column 1106 confirms “YES,” indicating full system validation of this scan event. This establishes USER1 as an authorized user initiating a valid scan event from a permitted location.

The second row (row 1128) reflects another scan event performed by USER1 on the same day, May 2, but from Florida at 10:30 AM-30 minutes after the prior scan from New York. Although the asset and user are both verified correctly, the Allowed column 1106 shows “NO.” This outcome suggests that the AI engine evaluated the context and determined that it was physically infeasible for USER1 to travel from New York to Florida in the 30-minute window between scan events.

This temporal and spatial inconsistency leads the AI engine to treat the second scan as anomalous. The logic may infer that either the asset has been cloned and is being used simultaneously in two locations, or the user credentials have been compromised. Consequently, despite successful technical verification, access is denied to prevent unauthorized or potentially fraudulent use of the asset.

The third row shows a later scan by USER1 on June 10 at 2:00 PM from Florida. This entry is permitted (Allowed=YES) because no temporal conflicts are detected. The AI engine may have evaluated the time elapsed since the prior scan and determined that relocation of the asset from New York to Florida over that duration is entirely feasible.

The fourth row documents a scan performed by USER2 on June 25 at 9:00 AM from Florida. Both the verification and access fields are marked “YES,” confirming that USER2 was permitted to access the asset and the scan location was acceptable. In some embodiments, the asset ABC121 may be configured to allow access by multiple users or any user registered with the organization, depending on asset sharing policies.

In further embodiments, assets such as ABC121 may be part of portable deployment kits, mobile diagnostic tools, or educational kits assigned to various field operatives. These assets may not be locked to a fixed location or user and are instead monitored through behavioral intelligence and time-based consistency.

To evaluate the feasibility of each scan event, the AI engine may consider multiple factors beyond just time and location. These may include: (i) velocity calculations based on previous location and current location, (ii) known transportation routes and schedules, (iii) device metadata such as IP address, MAC address, or cellular tower data, and (iv) historical scan behavior patterns of the user.

For example, if USER1 routinely travels between New York and Florida and the scan times reflect this established pattern, the system may allow a tighter temporal threshold than for an infrequent traveler. In contrast, a sudden unexplained spike in movement speed or geographic variability may trigger access denials or additional verification steps.

The AI engine may also reference external data feeds such as airline schedules, traffic patterns, or access logs from connected assets to determine the plausibility of location transitions. For example, if a user claims to scan a mobile generator in California shortly after using it in Texas, the AI may check for supporting GPS traces or transit logs.

In another example, if a POST request for asset ABC121 is received from a geographic location known for frequent counterfeit activity, the AI engine may flag the event even if the timing appears reasonable.

The system may also weigh device authenticity. If USER1 uses different devices across scan events (e.g., new phones, unregistered devices), the AI engine may assign a lower trust score and deny access, even if location and time factors seem plausible.

In cases where asset ABC121 is open for verification by any user (e.g., public kiosks, mobile rental stations), access control may depend primarily on asset location and timing feasibility rather than user ID alone. Under this model, scan behavior across users is evaluated for pattern consistency.

For such open-access assets, the AI engine may analyze usage density, overlap, or scan concurrency to detect cloning or theft. If two users scan the same asset from distant locations within minutes, one scan may be denied or quarantined pending investigation.

The AI system may further evaluate usage rhythm, such as the time of day when scans usually occur. A sudden scan at an odd hour or in a dormant zone may trigger denials even if user ID and location seem permissible.

In certain embodiments, verification decisions may be influenced by the user's access history with that specific asset. If USER2 is a new user scanning ABC121 for the first time, the system may enforce a more conservative threshold. In contrast, users with consistent positive scan history may be granted more flexibility, forming a dynamic trust-based access model. The system may also record failed attempts, user overrides, and device-based exceptions to refine the AI engine's future decision criteria.

In some embodiments, the server may be configured to evaluate asset verification requests by analyzing time and location data from successive scans of the same asset. Each time a scan is performed via a gateway device, the associated verification request includes not only hash values extracted from a multimodal tag, but also metadata such as the time of scan and the geographic coordinates of the gateway device. Upon receiving such a request, the server may compare the new scan event with historical scan records stored in a verification database to determine continuity, consistency, and plausibility of asset movement.

For example, if an asset labeled ABC123 is scanned in San Francisco at 9:00 AM and a subsequent scan is received at 9:45 AM from a location in Los Angeles, the server calculates the geographic distance between the two locations and evaluates the feasibility of the asset physically traveling that distance within the given time window. If the calculated speed exceeds a predetermined threshold or violates expected asset transit patterns, the server may treat the movement as infeasible.

Based on this evaluation, the server may determine whether to flag the asset as suspicious, potentially counterfeited, or unauthorized. In some cases, the asset may be marked as “Moved” if the movement is feasible but uncharacteristic. In other cases, if the scan location deviates from predefined geographic boundaries assigned to the asset, or if the movement pattern contradicts historical behavior, the server may classify the asset as “Unauthorized” or “Counterfeited.”

The server then assigns a status label to the asset based on the outcome of this analysis. The status label may be selected from a set of predefined categories including: “Genuine,” “Moved,” “Counterfeited,” “Stolen,” or “Unauthorized.” For example, if the scan is conducted by an unauthorized user from an allowed location, the server may assign a “Stolen” label. If the scan is from an allowed user and location, but the hash fails to match reference data, it may be labeled “Counterfeited.” These classifications are logged in the verification database and may be used to generate alerts, block access, or escalate the scan attempt to administrative systems for manual review.

Such an embodiment allows the verification system to go beyond simple tag validation and incorporate spatiotemporal reasoning to identify high-risk usage, clone attempts, or theft in near real time, enhancing trust and traceability in physical asset management environments.

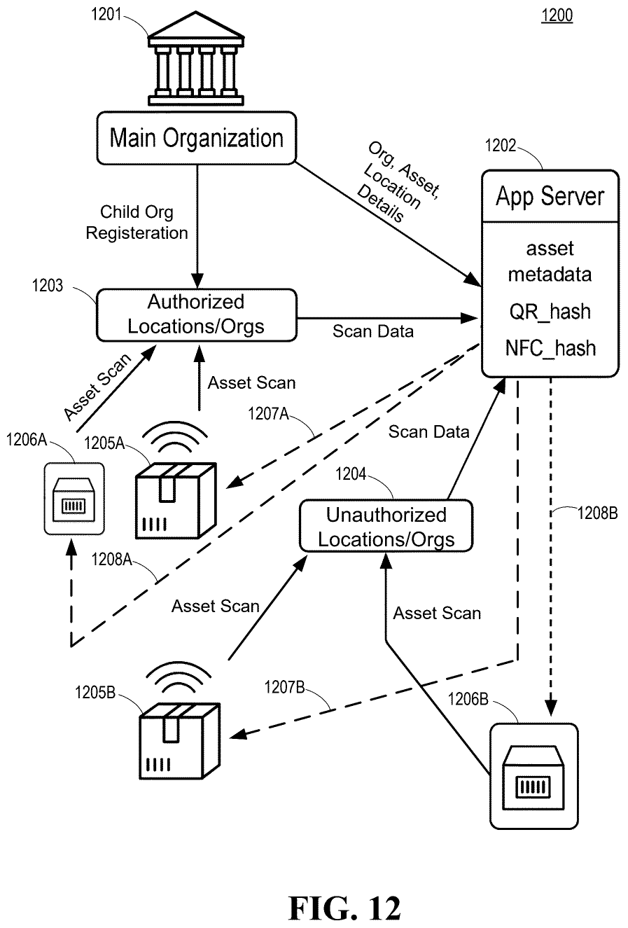

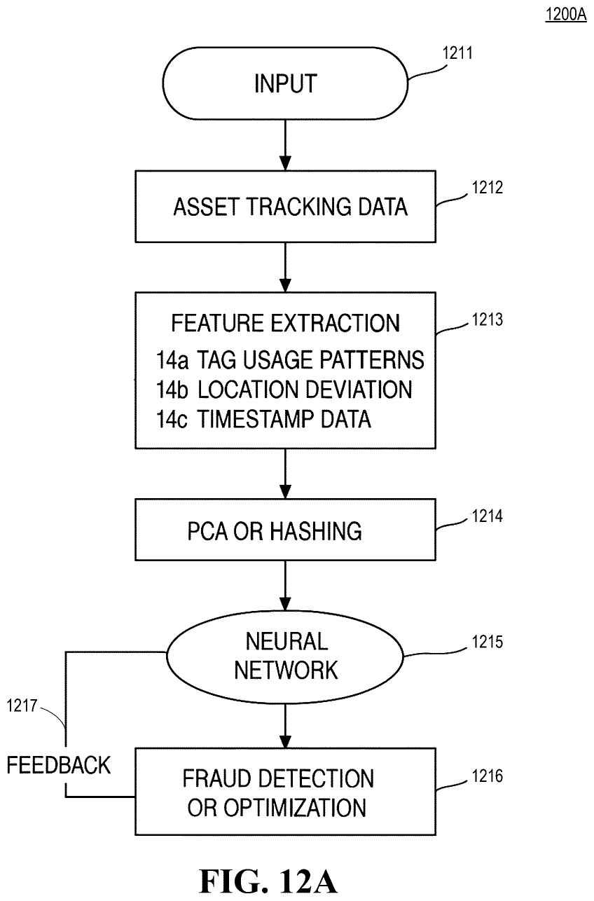

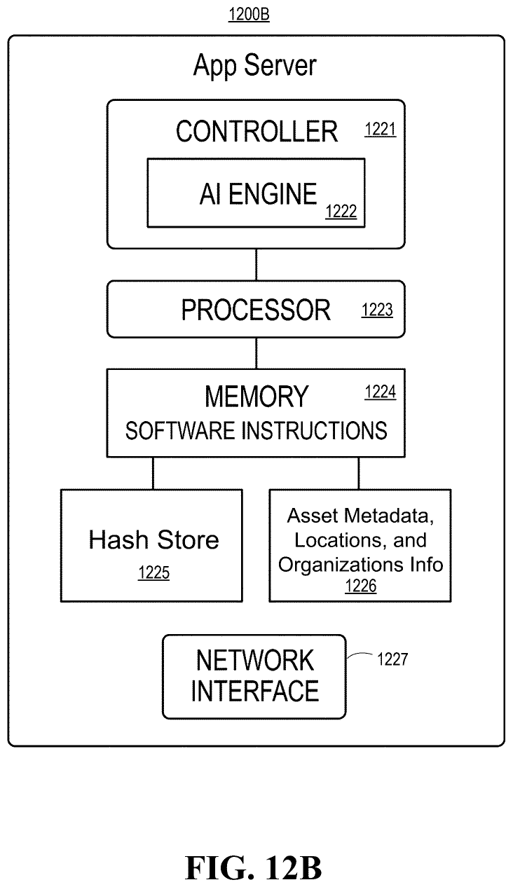

Referring now to FIG. 12, an exemplary system 1200 is illustrated for verifying asset authenticity and detecting unauthorized usage, theft, or loss of assets based on geographic location and organizational authorization, in accordance with some embodiments of the present disclosure. The system 1200 comprises a main organization 1201, an application server 1202, one or more authorized locations or sub-organizations 1203, one or more unauthorized locations or entities 1204, a plurality of assets including asset 1205A and asset 1205B, and one or more scanning devices such as 1001A.

The main organization 1201 may represent an entity such as a manufacturer, brand owner, licensing authority, logistics coordinator, warehouse operator, or other such governing body responsible for the distribution, validation, and lifecycle management of physical or digital assets. In various embodiments, the main organization 1201 may initiate the registration process of one or more child organizations or authorized locations 1203 under its administration, thereby associating these sub-entities with controlled asset flow and management structures.

In connection with this structure, the application server 1202 may be operated by or in communication with the main organization 1201. The application server 1202 may include various software modules such as Customer Relationship Management (CRM) platforms, data synchronization modules, compliance engines, and asset validation engines. The application server 1202 may store structured metadata including asset-specific identifiers, such as one or more of: QR_hash, NFC_hash, product ID, SKU, serial numbers, manufacturing batch identifiers, digital fingerprints, and time-stamped registration data.

The main organization 1201, through internal operations or integration tools, may mirror organizational and asset-related data to the application server 1202. This mirroring process may include storing the relationship mappings between the main organization 1201 and its authorized locations 1203, as well as maintaining an indexed database of asset metadata. Each asset under the control of the main organization 1201 may be uniquely tagged with tamper-proof physical tags, such as printed QR codes or embedded Near Field Communication (NFC) chips, with associated cryptographic hash values.

In some embodiments, the main organization 1201 may serve as the origin point for one or more genuine assets, such as asset 1205A and asset 1205B. These assets may be dispatched from the main organization 1201 or from an authorized sub-organization 1203 to another location, customer, or end-point as part of a logistical workflow. In such embodiments, the asset movement may follow a predefined route map, which may include geofenced checkpoints and estimated delivery timestamps configured into the application server 1202.

A scanning device (e.g., 1001A shown in FIG. 10) may be used at an authorized location 1203 (e.g., a scanning location or scanning organization) to perform a validation scan of a genuine asset 1205A. The scanning device may be a mobile barcode scanner, kiosk-mounted NFC reader, or integrated device connected to a CRM platform. Upon scanning, the scanning device may extract encoded information such as QR_hash or NFC_hash from the asset 1205A and transmit this scan data to the application server 1202.

Once the scan data reaches the application server 1202, a first authenticity check 1207A may be executed. This check may involve comparing the received QR_hash or NFC_hash against a secured and verified database of asset records already stored in the application server 1202. If the hashes match and the scan originates from a registered and authorized location 1203, the application server 1202 may log the event as a legitimate scan, updating the asset's lifecycle records.

In other embodiments, an asset 1205B may be scanned at a location or by an entity 1204 (e.g., a scanning location or scanning organization) that is not registered under the main organization 1201 or not present in the list of authorized sub-organizations 1203. This unauthorized scan may occur due to theft, misplacement, illegal distribution, or counterfeiting of the asset 1205B. A scanning device (e.g., similar to 1001A as shown in FIG. 10), operating in such a context, may still be able to extract and forward scan data to the application server 1202.

Upon receipt of scan data from an unauthorized source (location or organization), the application server 1202 may execute a second authenticity check 1207B. While the QR_hash or NFC_hash of the asset 1205B may match records in the asset database, the location or organization metadata associated with the scan data may not be included in the list of authorized entities (e.g., 1203). This mismatch may indicate a potential red flag associated with asset diversion, unauthorized sale, or possible counterfeiting.

Such second authenticity checks 1207B may also be supported by AI-based pattern recognition algorithms, wherein historical scan data, frequency of asset movements, tagging behavior, and known delivery routes are analyzed to classify an event as normal or anomalous. The AI module operating on the application server 1202 may utilize supervised or unsupervised learning models trained to detect location deviation patterns, timestamp inconsistencies, or hash manipulations that correlate with unauthorized activity.

In some cases, the application server 1202 may be configured to automatically send real-time alerts or notifications to the main organization 1201 when such unauthorized usage or suspicious scans are detected. The alert mechanism may involve SMS, email, dashboard notifications, or API callbacks to downstream systems managing compliance or inventory.

The application server 1202 may also maintain a fraud detection module that logs the GPS coordinates or IP addresses of the unauthorized scanners or devices that triggered the second authenticity check 1207B. Such data may be used to initiate recovery procedures, legal actions, or further investigation into the chain of custody of the asset 1205B.

In various embodiments, the main organization 1201 may grant different levels of scanning and asset handling privileges to the authorized sub-organizations 1203. For example, warehouse locations may be permitted to both scan-in and scan-out assets, while retail points may be permitted to scan-out only. These permissions may be managed within the application server 1202.

Further, scanning events may also be associated with timestamp logging, enabling time-based validation of whether an asset is within its expected delivery or handling window. For example, if an asset is scanned at a valid location but outside of an expected time range, this may raise an event trigger within the application server 1202.

In additional embodiments, each asset, such as asset 1205A, may include an embedded sensor that periodically transmits telemetry data (e.g., temperature, humidity, vibration). Such sensor data, when received in the application server 1202 alongside the scan metadata, may further help validate or question the asset's condition and origin.

The application server 1202 may also be configured to store a traceability log for each asset, showing all validated and attempted scans, associated timestamps, GPS metadata, and organizational identifiers. This traceability log may serve as a chain-of-custody proof in audits, disputes, or compliance submissions.

To further prevent spoofing, the application server 1202 may generate dynamic hashes or time-based tokens that must be matched with static hashes on the asset for validation to proceed. This may add an additional layer of security against replay attacks or duplication of asset tags.

In another embodiment, if a counterfeit asset is created with cloned QR or NFC data, and this fake asset is scanned at an unauthorized location 1204, the application server 1202 may detect the collision of asset hashes in unexpected geolocations or timestamps. This may lead to immediate blacklisting of the cloned hash value and tracing the distribution channel responsible for its propagation.

The application server 1202 may also generate compliance reports summarizing all first and second authenticity checks over a predefined time period. These reports may include number of valid vs. invalid scans, frequency of unauthorized access attempts, and geographic mapping of all scanning activities. In embodiments where the asset 1205B is a digital object such as software license or secure document, the scanning may be replaced by license key validation or API token check-ins. The same concepts described herein may be extended to such digital asset validation scenarios.

The scanning devices may also be configured to locally cache scan data when the network is unavailable and forward it to the application server 1202 upon reconnection. This enables consistent behavior even in remote or partially connected environments. In some cases, authorized organizations 1203 may be granted visibility into only their own asset handling activity through an access-controlled dashboard, while the main organization 1201 may have system-wide visibility.

If the same asset is scanned concurrently at multiple geographically separated locations, the application server 1202 may detect this anomaly using timestamp comparison and velocity heuristics, marking it as a potential duplication or cloning event.

The system 1200 may also be integrated with external ERP or supply chain platforms, where validated asset data flows into order fulfillment, invoicing, or distribution systems, making asset tracking part of the operational workflow. The asset hash values stored on the application server 1202 may also be encrypted using asymmetric cryptography, with private keys stored securely within the main organization's infrastructure and public keys used by scanning devices to validate authenticity.

In certain embodiments, smart contracts may be used within blockchain environments to log and validate asset authenticity events immutably. The scanning data may be recorded on-chain via secure transactions.

In some embodiments, the system 1200 may be configured to identify and handle events involving the introduction or insurgency of pirated, counterfeit, or fake assets such as asset 1206A and asset 1206B into the supply chain that primarily involves genuine assets managed by the main organization 1201. Such pirated or unauthorized assets may be intentionally or unintentionally introduced into the distribution or logistical network during various stages such as manufacturing, warehousing, shipment, handling by third-party transporters, retail delivery, or at the point of customer dispatch. The insurgency of such pirated assets may threaten the brand integrity, customer trust, and traceability compliance enforced by the main organization 1201 and may necessitate technical solutions to automatically detect and address such intrusions.

In some embodiments, a pirated asset 1206A may be physically present alongside legitimate assets in a batch being handled at an authorized location or organization 1203. This introduction may occur, for example, when a distributor or middle-tier entity attempts to insert lower-cost imitations into the authentic inventory in order to reduce costs or exploit the reputation of the brand. Upon scanning the pirated asset 1206A using a scanning device deployed at the authorized location 1203, the scan data including the QR_hash or NFC_hash of the pirated asset is transmitted to the application server 1202 for validation. The application server 1202 may perform a third authenticity check 1208A, wherein it evaluates the scanned asset identifier against a secured ledger of registered assets maintained by the main organization 1201.

During the third authenticity check 1208A, if the hash or digital signature derived from the pirated asset 1206A does not match any valid entry in the application server 1202, the server 1202 may classify the event as a case of unauthorized asset insurgency within a legitimate supply chain node. This classification may be further strengthened by comparing the metadata from the scan, such as the location identifier, timestamp, scanner ID, and associated sub-organization ID, with records indicating the expected assets to be handled at that authorized location 1203. When inconsistencies are detected, the application server 1202 may automatically raise an alert or trigger a notification to the main organization 1201 and/or the corresponding authorized organization 1203 to flag the incident for further investigation.

In such cases, the main organization 1201 may receive a digital report indicating the presence of a non-authentic item at an otherwise registered node. The report may include the scanned identifier of the pirated asset 1206A, the timestamp of detection, the location metadata of the scan event, and the scanner device ID or user ID involved in the process. This data may be used to initiate a focused audit of the particular batch, route, or entity that handled the compromised inventory. In some embodiments, the application server 1202 may integrate with automated response systems that lock the distribution rights of the authorized entity 1203 pending verification, or suspend further dispatches until the source of the counterfeit is identified.

In another embodiment, a second pirated asset 1206B may be scanned at an unauthorized location or organization 1204. The scan data may be forwarded to the application server 1202 for verification, similar to legitimate asset scans. The server 1202 may perform a fourth authenticity check 1208B. In this scenario, the fourth authenticity check 1208B may identify that the asset 1206B is not only invalid (e.g., hash not found or not in current registry) but is also scanned in a non-approved geographic or organizational location. The combination of these two factors may provide high confidence in classifying this event as fraudulent circulation or market injection of pirated goods.

Upon completion of the fourth authenticity check 1208B, the application server 1202 may classify the event under high-risk category events, and such detection may initiate an automatic escalation workflow. This workflow may include generating a comprehensive fraud report and forwarding the information to the compliance unit of the main organization 1201. In embodiments involving law enforcement or third-party investigative partners, the application server 1202 may anonymize and forward location metadata (e.g., IP address, geotag, city, retailer ID) to appropriate channels for further scrutiny.

In some embodiments, the detection of pirated assets such as 1206A or 1206B may also invoke a pattern analysis on historical scan events. For example, if multiple pirated assets are consistently detected within a particular region, city, or distribution channel, the system 1200 may flag that entire node or entity for a potential breach or unauthorized manufacturing source. The application server 1202 may generate route heatmaps, time series plots of piracy incidents, and distribution pathway anomalies, providing a visual and actionable representation to the main organization 1201.

In further embodiments, the server 1202 may utilize blockchain-based recordkeeping for immutable logging of authenticity checks 1208A and 1208B. Such distributed ledgers may include each scan event's hash, location, validation result, and involved scanning party. Upon detecting invalid hashes (indicative of pirated assets), these records may be publicly or semi-publicly reviewed to highlight breakpoints in the chain of custody.

The system 1200 may also include predefined threshold parameters to classify an authorized location 1203 as compromised if the rate of pirated asset detection (such as repeated 1208A failures) exceeds a defined margin. This triggers additional compliance protocols such as enforced revalidation of all inventory, temporary disassociation from the main organization 1201, or reduction in authorization privileges.

Moreover, upon detection of a pirated asset at an unauthorized entity 1204, the application server 1202 may automatically update its anomaly database with new device identifiers, associated scanner profiles, or IP addresses used in the event. These identifiers may be blacklisted or monitored for future attempts at injecting similar pirated goods into the system 1200.

The application server 1202 may also associate the fake asset hash with a class of known counterfeits, which can then be used to preemptively scan and detect pirated goods even before they are distributed in the market. For example, if the QR_hash of asset 1206B matches a template or pattern seen in other detected pirated assets, it may be automatically classified without requiring full forensic validation.

In embodiments involving image recognition, the scanning process of assets such as 1206A or 1206B may include visual tagging features that allow the server 1202 to analyze the label design, ink coloration, placement of the tag, or serial number formatting, using AI techniques to distinguish subtle differences from genuine assets. Such visual hashes may be compared with stored models for counterfeit detection.

Furthermore, in decentralized retail environments where resellers or distributors are allowed to handle assets, the detection of pirated goods using checks 1208A and 1208B may serve as a metric for assessing the reliability or compliance history of such entities. Entities with repeated incidents may face reduced inventory limits, increased monitoring, or loss of franchise rights.

In some embodiments, the present invention provides systems, and methods for tracking physical assets across a supply chain to detect authenticity, fraud, loss, or unauthorized use of said assets, by employing multimodal tagging technologies, secure scan data transmission, verification database comparison, and organizational-level authorization analysis. In some embodiments, a physical asset is tagged with a multimodal tag, which includes at least two types of machine-readable formats-such as a QR code and an embedded NFC tag-both uniquely identifying the asset and cryptographically bound to a digital profile associated with the asset. The tag encodes at least one hash code generated from secure asset metadata (e.g., serial number, batch ID, manufacturer info), an asset identifier that serves as a globally unique string assigned to the item, and a verification Uniform Resource Locator (URL) that, when accessed, directs to a backend verification endpoint hosted by a parent organization's server.

As the asset moves through the supply chain, a scanner device is used to scan the multimodal tag. The scanner device may be a handheld barcode reader used by logistics personnel, a smartphone application used at a warehouse, or a fixed-point POS terminal at a retail outlet. Upon scanning, the scanner extracts the tag's encoded contents, which include the hash code, asset identifier, and verification URL. This scan data is transmitted to an application server belonging to the parent organization (e.g., the original manufacturer or brand owner) using the verification URL. The transmission occurs over a secure network connection, and the application server uses the endpoint URL to receive, authenticate, and process the scan data.

Upon receiving the scan data, a controller embedded within the application server retrieves metadata associated with the scanning instance. This includes one or both of: (i) a location identifier, such as GPS coordinates of the scanning device, or a geofenced tag pre-mapped to a fixed site; and/or (ii) an organizational identifier, such as a unique ID representing the scanning organization (e.g., a distributor, sub-retailer, or logistics handler). These values are used to map the origin of the scan and contextualize the location or entity interacting with the asset.

Next, the controller evaluates whether the scanning location or organization is registered or authorized under the parent organization. This is performed by querying a registry of authorized locations and organizations, which may be stored in a relational database or managed through a CRM-integrated registry. If the scanning entity is not recognized, the event is flagged for further review, and the authenticity process continues under heightened scrutiny.

Simultaneously, the controller performs a comparison between the hash code extracted from the scanned tag and a reference hash value stored in a secure verification database maintained by the application server. This reference hash may have been generated at the time of asset manufacturing and may be derived from a cryptographic function applied to immutable asset metadata. The comparison verifies that the asset has not been cloned, duplicated, or tampered with by checking for consistency between the scanned hash and the official record.

Following the comparison, the controller initiates a set of authenticity checks. These may include: verifying that the scan occurs at an expected point in the delivery timeline; determining whether the organizational ID matches the expected next handler of the asset; evaluating time-based constraints (e.g., scan occurring earlier or later than permitted); or pattern matching against historical behavior to detect anomalies. These checks may also incorporate AI-based inference, where the controller's neural network engine applies trained models to detect unusual patterns indicative of fraud, such as scanning from unexpected countries, or from devices with spoofed metadata.

Based on the results of the authenticity checks, the controller then classifies the scan result to determine whether the asset is:
Authentic and valid, scanned at a registered location by an authorized organization;
Lost, where the asset was expected to be scanned along a defined delivery path but was either missing or scanned at an unregistered location;
Fraudulently duplicated, wherein another instance of the same hash code has been scanned elsewhere within a short time window, suggesting clone insertion;
or an unauthorized pirated asset, meaning that although the asset identifier and scan data exist, they do not match any entry in the reference database, and may be counterfeit attempts to imitate legitimate products.

For example, suppose an electronic device shipped from a manufacturer in Singapore is scheduled to reach a registered retailer in California. As the package is scanned at intermediary checkpoints-such as export hubs, ports, and regional warehouses—the system validates the scan locations. If the device is scanned in an unauthorized warehouse in Dubai with the same hash code, the system flags a potential diversion or parallel trade. Similarly, if two scans from different continents using the same hash occur within minutes, the system may detect duplication fraud.

In another embodiment, if a legitimate asset is scanned at a location that is not yet registered, and the scanned hash matches the reference hash, but the organizational ID is missing from the CRM registry, the system may trigger a child organization registration protocol, prompting the parent organization to authorize or deny the new location. This bridges asset verification with dynamic organizational onboarding in real-time.

Referring now to FIG. 12A, an exemplary process 1200A illustrates a method for performing fraud detection or optimization based on asset tracking data using a neural network, as may be executed by an application server such as the application server 1202 shown in related embodiments. The system ingests data at various stages, processes the data using a neural network model, and outputs a determination related to asset misuse, fraud, or operational optimization, incorporating feedback mechanisms for continuous learning.

At step 1211, the system receives one or more forms of input data that may originate from multiple sources including, but not limited to, asset scanners, tracking devices, point-of-sale systems, GPS modules, or network-connected scanning systems installed at physical checkpoints. The input may be initiated when an asset is scanned by an authorized or unauthorized entity during shipment, storage, or point-of-sale movement. The input may contain various identifiers such as asset IDs, timestamps, geographic coordinates, scanner ID, organization ID, or encoded hash values such as QR_hash and NFC_hash associated with the asset.

At step 1212, the system collects asset tracking data, which may include logs and real-time transmissions reflecting the movement, scan events, or positional data of one or more assets. The asset tracking data may be automatically logged from hardware devices communicating with the CRM platform or application server. The tracking data may further include transaction records, transportation checkpoints, entry and exit timestamps, location history, or digital trails associated with the handling of each asset. The purpose of this step is to generate a rich, time-sensitive dataset reflecting the lifecycle of asset circulation across different organizational nodes.

At step 1213, the system performs feature extraction from the collected tracking data. The extracted features may comprise, but are not limited to, the following: (i) tag usage patterns 14a, which may reflect how frequently or irregularly certain assets are scanned, whether patterns deviate from known routines, or whether abnormal sequences appear across locations; (ii) location deviation 14b, which measures whether assets are scanned in areas that fall outside the expected geofenced regions or transportation routes; and (iii) timestamp data 14c, which evaluates whether the time-related attributes of asset scans fall within the permissible operating windows or exhibit suspicious delays, duplication, or overlap across nodes. This step condenses the raw tracking data into a structured form for further computation.

At step 1214, the extracted features undergo dimensionality reduction or transformation, which may be achieved using Principal Component Analysis (PCA) or hashing techniques. The PCA method may be employed to reduce feature complexity while retaining relevant variance across input vectors. Hashing may alternatively be used to compress categorical or high-dimensional data into fixed-length hash representations for more efficient comparison, indexing, and neural computation. The goal of this step is to convert real-world, multidimensional data into a compact, computable format while preserving its decision-critical elements.

At step 1215, the transformed data is passed into a neural network, which may be configured as a supervised or unsupervised learning model depending on the application. The neural network may have been trained using historical datasets comprising legitimate and fraudulent asset behaviors, allowing it to learn relationships between scan patterns, spatial distributions, and asset characteristics. The neural network evaluates the input feature set to detect anomalies or confirm regularity based on weighted inferences derived from prior training. The output of this step may reflect a confidence score, fraud likelihood, classification label (e.g., authentic, pirated, misplaced), or optimization parameter.

At step 1216, the neural network produces a result related to fraud detection or optimization. In some embodiments, fraud detection may include identification of suspicious behavior such as asset duplication, tag spoofing, route deviation, unauthorized organizational access, or unusual scanning frequency. In another embodiment, optimization outputs may suggest adjustments in route planning, scanning intervals, or organizational trust levels to improve operational performance or security. The output data may be formatted for human review, automated trigger responses, or CRM system alerts.

At step 1217, the system accepts feedback based on the fraud detection or optimization output. Feedback may originate from manual verification performed by system administrators, confirmation from scanned locations, or cross-referencing with third-party logistics data. This feedback loop is used to retrain or adjust the neural network model, refine weightings, update known patterns, or suppress false positives over time. The feedback step contributes to iterative learning and adaptive tuning of the entire fraud detection pipeline.

Referring now to FIG. 12B, an exemplary block diagram 1200B illustrates the structural components of an application server (e.g., application server 1202) configured to receive, process, analyze, and respond to asset-related scan data, including but not limited to data for verifying asset authenticity, detecting unauthorized distribution, or optimizing asset tracking operations. In some embodiments, the application server 1202 may be a centralized or cloud-hosted infrastructure component managed by a main organization or an enterprise system, where it performs computational and analytical functions in response to scanned data inputs from distributed scanners across various authorized and unauthorized locations.

In some embodiments, the application server 1202 comprises a controller 1221, which may be a programmable logic controller, embedded computing unit, or general-purpose processing circuit that orchestrates the internal workflow within the server. The controller 1221 may receive instructions from higher-level modules such as the AI engine 1222 or interface directly with processors 1223 to execute stored routines, manage scan events, validate metadata, and initiate fraud detection operations. The controller 1221 may function as a coordinating element between memory systems, data stores, and network components.

Housed within the controller 1221 is an AI engine 1222, which may be implemented as a neural network or a hybrid machine learning system trained using supervised or unsupervised datasets.

Some principles of neural networks as used herein may include, for example, one or more of:
Layered Architecture: Consists of an input layer (accepts data), one or more hidden layers (transform data), and an output layer (produces results);
Artificial Neurons (Nodes): Each neuron computes a weighted sum of its inputs, adds a bias, and applies an activation function to produce an output;
Weights and Biases: Adjustable parameters that determine the strength and influence of connections between neurons;
Activation Functions: Introduce non-linearity, allowing the network to capture complex relationships. Examples include ReLU, sigmoid, and tanh;
Learning Through Training: Networks learn by adjusting weights and biases to minimize prediction errors, typically using algorithms like backpropagation and gradient descent;
Pattern Recognition and Adaptation: By training on data, neural networks can model intricate patterns, generalize to new data, and perform tasks such as classification, regression, image analysis, and natural language understanding; and
Data-Driven: Unlike traditional rule-based systems, neural networks improve their performance by learning directly from data.

A neural network may include a processor and memory executing software command to emulate a layered system of interconnected artificial neurons that learns to recognize patterns and solve complex problems by adjusting internal parameters based on data.

The AI engine 1222 is configured to process inputs such as asset tracking data (e.g., QR_hash, NFC_hash, scan location, timestamp), identify deviations from historical or expected behaviors, and flag anomalies indicative of fraudulent or pirated asset distribution. For example, the AI engine 1222 may learn tag usage patterns over time, infer whether assets are circulating in unauthorized zones, or detect timestamp irregularities in scanned records submitted from the field. In certain implementations, the AI engine 1222 may rely on reinforcement learning, where outcomes from prior fraud detection efforts contribute to optimizing future inferences.

The processor 1223 may be one or more microprocessors or cores operating in conjunction with the controller 1221 and AI engine 1222. In some embodiments, the processor 1223 performs low-level computation, including data parsing, scan input formatting, hash validation, or preparing payloads for downstream modules. The processor 1223 may also interact with cryptographic subroutines for validating the authenticity of scanned asset identifiers, facilitating blockchain verification (where applicable), or calculating data fingerprints.

Memory 1224, coupled to the processor 1223 and controller 1221, stores software instructions executable by one or more components of the application server 1202. These instructions may include routines for scan handling, fraud detection workflows, hashing algorithms, synchronization mechanisms, and rules-based evaluation modules. The memory 1224 may further include lookup tables, organizational policies, predefined route maps, asset type definitions, or condition-based triggers that determine how scan data should be interpreted or flagged. In some embodiments, memory 1224 stores workflows that determine whether an asset scanned at a new organization is sufficient to register the scanning entity as a legitimate sub-organization.

The memory 1224 may retain a hash store 1225, which retains hashed identifiers of all registered or trackable assets. These may include, but are not limited to, QR_hash values generated from asset-specific QR codes, NFC_hash values based on NFC tag identifiers, or hybrid hash constructs combining multiple modalities for better uniqueness and security. Hash store 1225 may be indexed using organization IDs or product categories, and may also maintain historical scan chains for each asset for audit or traceability purposes. In some embodiments, during a scan event, the received QR_hash is compared against the hash values stored in hash store 1225 to determine whether the asset is part of the legitimate supply chain.

In addition to the hash store, a parallel data store 1226 may be used to maintain asset metadata, authorized and unauthorized location identifiers, organization-specific routing permissions, and hierarchical relationships between main organizations and their sub-entities. This store may allow the AI engine 1222 or controller 1221 to cross-validate scan data against legitimate organizational contexts, thereby improving accuracy in fraud detection. For example, the metadata store 1226 may identify that asset ‘1a_abc_123_xyz_123’ is only valid in organization ID ‘Sub1_xyz_123’, which resides under ‘main_abc_123’, and any scan outside this scope is flagged as suspicious.

To enable real-time communication with remote scanners, CRM platforms, or external event sources, the application server 1202 also comprises a network interface 1227. This network interface 1227 may support protocols such as HTTPS, REST API, MQTT, or WebSocket to allow receipt and transmission of scan-related data packets. The network interface 1227 may also be configured to authenticate API calls, receive payloads from CRM systems or scanner devices, and transmit responses or alerts (e.g., fraud alerts, acknowledgment messages, synchronization commands) to client applications or centralized dashboards.

In various embodiments, the application server 1202 may operate in coordination with CRM platforms, verification applications, or route monitoring systems, wherein each scanning instance from an authorized location triggers a scan event, which is forwarded through the network interface 1227 to the controller 1221. The AI engine 1222 evaluates the input, matches hash values from store 1225, validates metadata from 1226, and sends a verified/fraudulent classification output. The classification output may then be logged for audit purposes, and optionally shared with relevant stakeholders such as sub-organization representatives or parent organization dashboards.

In some implementations, the application server 1202 may be deployed in a distributed environment such as a cloud computing framework where modules shown in 1200B are instantiated across multiple nodes for scalability. The controller 1221 and AI engine 1222 may exist in a containerized environment with dynamic allocation of processor 1223 and memory 1224 resources depending on processing load. For example, a spike in scan activity across a geography may lead to replication of the AI engine 1222 for regional fault-tolerant fraud detection and latency minimization.

In other embodiments, data in the hash store 1225 and metadata store 1226 may be periodically synchronized with blockchain networks or third-party registries, such that authenticity verification may occur in hybrid or federated verification models. The blockchain hashes may be derived from concatenation of product serial numbers, organization identifiers, manufacturing dates, and private keys from the main organization 1201 (as shown in earlier figures), providing immutable asset verification and auditability.

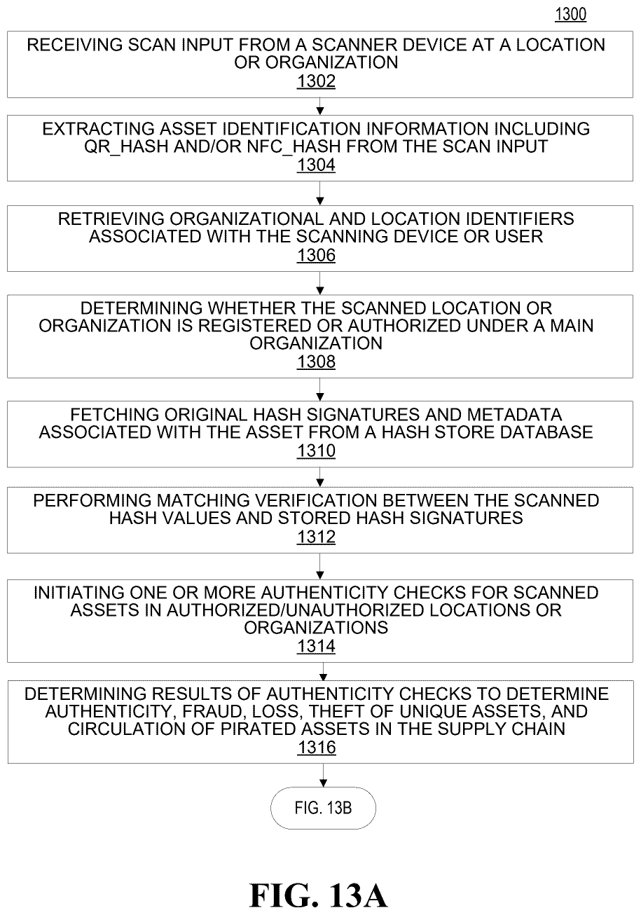

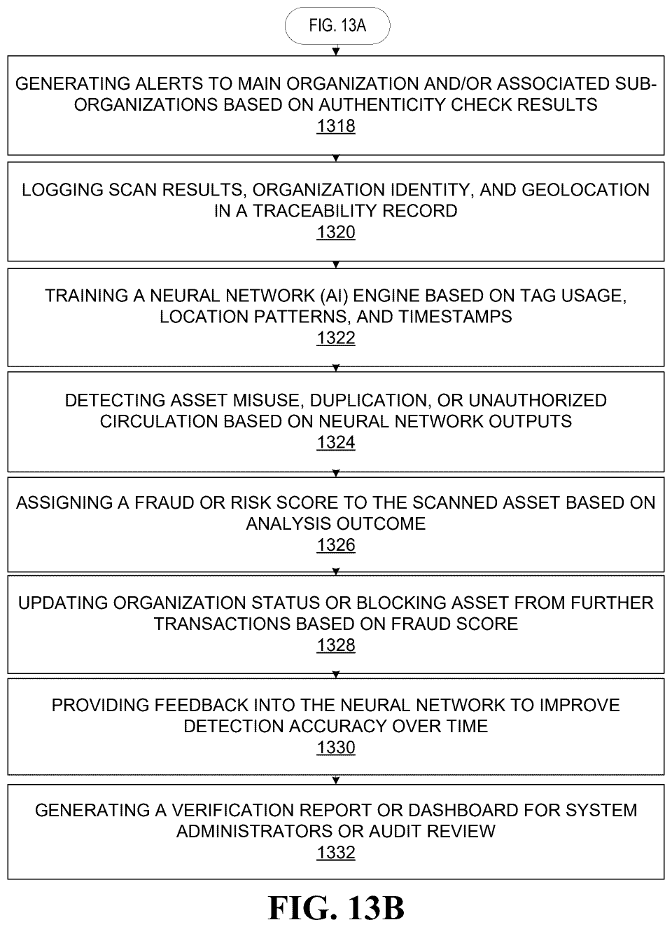

Referring now to FIGS. 13A and 13B, illustrated therein is an exemplary flowchart 1300 of method steps 1302 through 1332 for verifying asset authenticity and detecting unauthorized usage, fraud, loss, or circulation of pirated assets in accordance with some embodiments of the present disclosure. The method may be performed by an application server, such as the application server 1202 described in FIG. 12, comprising a controller, an AI engine, memory, and software instructions configured to analyze asset scan data. The method begins with receiving scan input from a scanner device at a particular location or organization and proceeds through a series of steps involving asset identification extraction, organizational and locational checks, hash-based authenticity verification, AI-assisted fraud detection, and traceability logging. As shown, the method further comprises feedback-driven improvement of the neural network, fraud score assignments, and status updates for scanned assets, ultimately leading to the generation of system-level verification dashboards. The steps described in flowchart 1300 facilitate a robust mechanism for validating legitimate asset movements while identifying fraudulent behavior and providing traceable audit records across authorized and unauthorized organizational points within a hierarchical supply chain structure.

At step 1302, a scan input is received into the system from a scanner device located at a particular physical location or belonging to a specific organization. The scanner device may include a handheld barcode or QR code reader, a point-of-sale (POS) terminal, a mobile application, or a desktop-based software tool capable of decoding encoded data from a physical tag. The scan input may pertain to an asset such as a product, component, package, or equipment item embedded with one or more identifiers including QR code or NFC tags. In some embodiments, this scan is triggered when a warehouse personnel, retailer, transporter, or distributor attempts to scan the physical asset during shipping, intake, or sale. The scan input serves as the initiation point for a traceability and authentication pipeline managed by a centralized system.

At step 1304, the system extracts asset identification information from the scan input, which may include at least one of a QR_hash or an NFC_hash. These hashes may be generated using cryptographic functions such as SHA-256 or other secure hashing algorithms applied to a unique combination of asset parameters including manufacturer ID, batch ID, timestamp of production, location ID, and category metadata. The extraction process may involve parsing the scanned data string to isolate these hash values, which will be used later for verification. example, if a QR code encodes a payload like “main_abc_123|product456|20250709”, the backend system may decode and compute a QR_hash accordingly. In some embodiments, additional asset data such as encoded digital signatures or embedded blockchain references may also be extracted for enhanced integrity checks.

At step 1306, the system retrieves organizational and location identifiers associated with the scanning device or the user operating the device. These identifiers may be pre-registered in the system and may correspond to a unique sub-organization ID, such as a retailer ID, distributor ID, franchise branch ID, or factory unit ID. The location identifiers may include GPS coordinates, zone IDs, or predefined warehouse/retail codes. In some embodiments, the scanning device may be linked to a specific sub-organization through a user login, MAC address, IP range, or IoT registration token. This contextual association allows the system to trace the provenance of the scan event and determine its legitimacy within the supply chain hierarchy.

At step 1308, the system determines whether the scanned location or the scanning organization is registered or authorized under a main organization. This determination may be made by querying a central repository of authorized sub-organization mappings managed by the main organization, such as a manufacturer or brand owner. For example, a main organization may have five registered retailers and three approved logistics partners; any scan initiated from a device mapped to these sub-entities will be marked as authorized. The system may utilize relational database joins, hash map comparisons, or role-based access checks to validate the registration status. Unauthorized scans-those initiated from unknown devices or rogue organizations-will be flagged for further verification in later stages.

At step 1310, the system fetches the original hash signatures and metadata associated with the scanned asset from a hash store database. The hash store may reside within an application server environment, and may include indexed records of QR_hash and NFC_hash entries, along with associated asset metadata such as production date, source factory, model number, batch ID, expiration details, and regulatory compliance tags. In some embodiments, the hash store may be implemented using a distributed ledger or blockchain system for immutable logging and audit trail access. Retrieval may occur using asset identifiers as search keys, enabling efficient access through RESTful APIs or direct SQL query mechanisms.

At step 1312, the system performs matching verification between the scanned hash values and the stored hash signatures retrieved from the hash store. The matching process may include hash comparison routines that verify both the presence and the exact match of the scanned hash against the stored canonical hash values. The verification may include additional checks, such as verifying digital certificates or signatures associated with the hashes. In some embodiments, fuzzy matching techniques may also be applied to detect near-duplicate or tampered hash entries that indicate potential forgery or unauthorized cloning attempts. A positive match leads to the next steps, while a mismatch may trigger alerts or flag the asset for further inspection.

At step 1314, the system initiates one or more authenticity checks for scanned assets based on whether the scanning occurred at authorized or unauthorized locations or organizations. These checks may include geofencing validation, timestamp validation, route trace matching, and historical scan behavior analysis. For example, an asset expected to travel from Warehouse A to Retail Store B through Checkpoint C may be marked suspicious if scanned at an unknown Port D. In some embodiments, the system cross-validates the scan history of an asset to identify whether it has previously passed through the intended organizational path. AI models may also analyze behavioral patterns of scans to detect anomalies based on deviation scores, frequency, or re-scan likelihood.

At step 1316, the system determines the results of the authenticity checks initiated in the previous step, identifying one or more conclusions such as genuine authenticity, suspected fraud, confirmed loss, or circulation of pirated assets. The system aggregates verification data, hash match outcomes, organizational registration status, and scan location metadata to infer whether the scanned asset belongs to the original supply chain or has been compromised. In some embodiments, a genuine asset that was lost and resurfaced outside the known organizational path may be marked with a warning status. Conversely, a newly scanned asset with an unknown or invalid hash may be declared pirated. The system can differentiate between theft, misrouting, duplicate scanning, and intentional piracy through contextual inferences derived from hash signature comparisons and organizational mapping.

At step 1318, the system generates one or more alerts to the main organization 1201 and/or to associated sub-organizations 1203 based on the results obtained from the authenticity checks performed in step 1316. These alerts may be automatically triggered by the controller 1221 and routed through the network interface 1227 of the application server 1202. Alerts may be categorized based on severity, such as informational (valid scan at authorized location), warning (valid asset detected at unauthorized location), and high-severity (pirated asset scan). In some embodiments, if a pirated asset 1206B is scanned in an unauthorized organization 1204, a real-time alert may be pushed to an operations console of the main organization 1201 via mobile application notifications, SMS, or system dashboards. These alerts may also include contextual metadata such as location of scan, timestamp, scanning entity ID, and asset hash.

At step 1320, the system logs the scan results, including the organizational identity of the scanning device and the geolocation of the scan event, into a traceability record stored within a centralized or distributed ledger. This traceability record may act as a tamper-proof audit trail accessible by designated roles in the main organization 1201. Logging may be done in real-time and appended to a timeline view, facilitating supply chain transparency. For example, if an asset tagged with the hash “QR_abc789” was scanned on Jul. 10, 2025, at a retailer in Mumbai (sub-org ID 410B), such data may be logged as a structured entry: [Timestamp, Asset Hash, Org ID, Location, Scan Result]. The traceability record enables backward tracing of any anomalies or unauthorized access.

At step 1322, a neural network engine 1222 is trained based on input variables including tag usage patterns, scan location histories, and timestamp data. The AI model receives these multidimensional data streams to learn legitimate behavior patterns such as scan frequency per org, route consistency, and inter-org transitions. For example, training may involve feeding the neural network with tens of thousands of scans indicating proper movement of products across authorized routes, helping the AI to detect statistically deviant patterns later. The training may be supervised or unsupervised, using known cases of fraud and clean scans as labeled datasets in supervised approaches.

At step 1324, the trained neural network 1222 detects possible asset misuse, duplication attempts, or unauthorized circulation based on the output probability scores of its predictive models. Misuse detection may include identifying re-scans of the same asset at different unauthorized points, duplicated hashes in distinct geographic zones, or unusually timed scan sequences. For example, if an asset is scanned in Delhi and again in Pune within five minutes, the AI model may flag it based on known logistical infeasibility. The neural network may also detect new, unknown fraud patterns by observing changes in hash cluster behavior, scan entropy, or frequency spikes.

At step 1326, the system assigns a fraud score or risk score to each scanned asset based on the analysis outcome from the neural network or other heuristic models. The fraud score may range from 0 (completely valid) to 1 (confirmed fraudulent), or be broken into bands such as Low, Medium, and High Risk. A fraud score may consider variables such as hash validity, organizational registration status, prior scan path, route deviations, and AI-detected anomalies. In some embodiments, a hash scanned at unauthorized orgs and flagged by the AI for location deviation may be assigned a fraud score of 0.89, triggering containment procedures.

At step 1328, the system may update the scanning organization's status in its registry or block the scanned asset from engaging in further transactions or circulation within the supply chain based on the fraud score. The controller 1221 may initiate workflows to freeze or quarantine the asset hash in its operational systems, thereby preventing future validation, registration, or ownership transfers. In another embodiment, a flagged organization may be put under audit review, with its future scan attempts flagged for supervisory oversight. This enables early-stage containment of fraud or piracy in supply chains.

At step 1330, the fraud detection system feeds back the results of its detection into the neural network 1222 to improve the AI engine's accuracy over time. This feedback loop 1217 may include both false positives (e.g., wrongly flagged assets later marked valid) and false negatives (e.g., assets found pirated but not originally detected). The AI engine may use this feedback for model re-tuning, parameter adjustments, and continuous learning. Over time, such feedback cycles train the system to become more precise in distinguishing between legitimate anomalies (like emergency diversions) and true cases of fraudulent behavior.

At step 1332, the system generates a verification report or dashboard visualization for use by system administrators, auditors, or compliance personnel. The report may display aggregated statistics, flagged assets, fraud score trends, geographic fraud mapping, and organization compliance summaries. In some embodiments, the dashboard may highlight the top 10 high-risk scan events in the last 24 hours, overlayed on a geographic map. The report can be used for weekly audits, supply chain transparency disclosures, and regulatory filings. Access to the dashboard may be role-based, with tailored views for compliance officers, logistics heads, and IT administrators.

In some embodiments, the system described herein provides a multi-layered asset tracking, validation, and organizational synchronization platform designed to facilitate real-time visibility, traceability, and control across a distributed network of physical and digital touchpoints. The system may be configured to automatically respond to various real-world use cases through programmable interfaces, data synchronization engines, and artificial intelligence-driven analysis. These use cases include, but are not limited to, the dynamic registration of facilities, validation of assets in transit, detection of asset route deviations, and administrative audit capabilities for examining validation and tracking histories.

In some exemplary use cases, a warehouse system may initiate the registration of a new facility-such as a new warehouse location, depot, or processing unit-within a broader Customer Relationship Management (CRM) platform. Upon creation of the new facility within the CRM, a trigger handler embedded in the CRM infrastructure may generate an organization payload object containing metadata such as a unique CRM object ID, the name of the facility, a reference to the parent organization, GPS-based location information, and associated organizational metadata (e.g., facility type, capacity, or function). This payload is assembled into a Data Synchronization Object (DSO), which also includes callout information comprising a destination URL, HTTP method, and API path for the application server. The DSO is placed in a queue for execution, and upon processing, the application server updates its own registry of authorized organizations and facilities. This process permits the new facility to immediately begin participating in asset scanning and validation events, eliminating the need for manual backend updates, and reducing operational delays during infrastructure expansion.

In other cases, an asset tagged with a multimodal tag (e.g., QR and NFC tags) is scanned mid-route at an intermediary checkpoint, such as a shipping terminal, logistics hub, or transport depot. The scan data captured by a handheld scanner or mobile device includes the hash code, asset ID, timestamp, scanner location, and verification URL. Upon transmitting the scan data to the application server, a controller evaluates the hash code against one or more reference hash values stored in a secure verification database. If the asset hash is valid, the system logs the scan event and may update a real-time delivery map associated with the route. The system may also compare the scan point with a previously defined route plan and update the asset's tracking log. This process permits validation of genuine assets even in transit, offering checkpoints of integrity throughout the supply chain journey.

In some embodiments, the system detects an event where an asset deviates from its planned route. For example, an asset expected to follow a sequence of registered checkpoints along a predefined route is instead scanned at a location outside the tolerance window. The route plan, stored in a route mapping module, includes authorized checkpoints and timing tolerances-such as expected arrival intervals and distances between nodes. If an asset is either not scanned at one or more of the expected checkpoints or scanned significantly outside the expected geolocation or time tolerance, the controller may determine a deviation event has occurred. This may trigger AI-based inference routines to assess the deviation for risk, possibly escalating the event for administrative action or issuing alerts to logistics managers, the asset custodian, or the parent organization. This route-based deviation detection helps to identify theft, unauthorized rerouting, or improper handling.

In some embodiments, an administrator accesses a validation interface or dashboard connected to the CRM or web portal that provides detailed insights into asset validation events, route histories, and integrity reports. The interface may include a route trace visualization showing the path traveled by the asset, timestamps of each checkpoint scan, identity of scanning organizations, hash validation outcomes, and deviation alerts. The administrator may also view real-time or historical validation results such as “authentic scan at registered facility,” “hash mismatch at unauthorized location,” or “deviation detected-missing scan at expected checkpoint.” Additionally, the system may provide filters to inspect only those assets that have been flagged for review, those that are in transit, or those that have completed their delivery lifecycle. These capabilities enhance transparency and allow for quick forensic audits in case of disputes or anomalies.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of tracking an asset using a neural network, the method comprising: by a referencing a customer relations management (CRM) application to create a new child organization in response to an organization create event;
generating, by the CRM application, an organization payload object using fields from an object, including a CRM ID of the object;
receiving into a neural network asset tracking data associated with the organization payload object;
analyzing the neural network asset tracking data associated with the organization payload object for potential anomalies or unauthorized activity;
placing the CRM ID of the object into an external ID of a payload;
packaging the payload, callout information, synchronization data, and an error handler into a Data Synchronization Object (DSO);
queueing the Data Synchronization Object for execution;
assembling the payload, the callout information, the Data Synchronization Object, and the error handler based on a trigger event type;
executing the Data Synchronization Object;
with the neural network, monitoring the execution of the Data Synchronization Object, and
flagging deviations or suspicious patterns in organization create events or asset assignment.

2. The method of claim 1, wherein the neural network is trained on historical organization create events, the neural network asset tracking data, and synchronization outcomes to detect fraudulent or unauthorized organization registrations.

3. The method of claim 1, wherein the execution of the Data Synchronization Object may be combined with others of a same event type and processed in a thread, and wherein the neural network analyzes batch execution data to identify anomalies or process failures.

4. The method of claim 1, wherein the organization create event is handled by a trigger handler, and the neural network evaluates a trigger event context for risk scoring.

5. The method of claim 1, further comprising:
noting that the CRM application uses strings for the CRM ID, and wherein the neural network processes CRM ID patterns to detect irregularities or potential spoofing.

6. The method of claim 1, further comprising:
if a callout is included, sending the payload to an asset tracking server endpoint for processing, and wherein the neural network monitors callout responses for error patterns or unauthorized access attempts.

7. The method of claim 1, wherein in a case of an organization create event, the method further comprises:
creating an organization in an asset tracking server, which generates a new asset tracking external ID, and wherein the neural network validates mapping between the CRM ID and the new asset tracking external ID for consistency and security.

8. The method of claim 1, wherein if an error exists, the method further comprises:
the error handler showing a banner message in the CRM application, and wherein the neural network analyzes error logs to identify systemic issues or targeted attacks.

9. The method of claim 1, wherein if no error exists, a response is packaged into a payload object, and the neural network updates its training data with a successful transaction for continuous learning.

10. The method of claim 1, further comprising:
receiving, by the neural network, asset scan data associated with the new child organization, and analyzing the asset scan data to detect unauthorized asset movement or loss.

11. The method of claim 1, wherein the neural network assigns a risk score to each new child organization based on input features including organization metadata, asset tracking history, and synchronization outcomes.

12. The method of claim 11, further comprising:
generating, by the neural network, an alert to an administrator if the risk score for the new child organization exceeds a predetermined threshold.

13. The method of claim 12, wherein the neural network is configured to detect patterns of repeated failed organization creation attempts and flag them as potential fraud.

14. The method of claim 1, further comprising:
logging, by the neural network, all organization creation events, synchronization outcomes, and risk scores in a traceability record.

15. The method of claim 1, wherein the neural network is periodically retrained using feedback from manual reviews of organization creation events and asset tracking anomalies.

16. The method of claim 1, further comprising:
using the neural network to analyze time intervals between the organization create event, the asset assignment, and a first asset scan to detect suspiciously rapid onboarding.

17. The method of claim 1, wherein the neural network processes geographic metadata associated with the new child organization to identify out-of-pattern registrations.

18. The method of claim 1, further comprising:
the neural network monitoring a frequency and a volume of Data Synchronization Object executions to detect denial-of-service or abuse attempts.

19. The method of claim 1, wherein the neural network generates a compliance report summarizing organization creation events, detected anomalies, and risk scores for audit purposes.

20. The method of claim 13, wherein a neural network output is used to automatically approve, hold, or reject new child organization registrations based on the computed risk score and the detected patterns.
